(19) United States
(12) Patent Application Publication
(10) Pub. No.: US 2024/0227234 A1
(43) Pub. Date: Jul. 11, 2024

(54) Polymerization Terminating Layer for Isocyanates Utilized During Manufacturing of Cellulose-Based Products

(71) Applicant: Guardian Chemicals Inc., Sturgeon County (CA)

(72) Inventors: Geza HORVATH SZABO, Edmonton (CA); Yoojin CHOI, Sturgeon County (CA)

(21) Appl. No.: 18/506,150

(22) Filed: Nov. 10, 2023

Related U.S. Application Data
(60) Provisional application No. 63/424,751, filed on Nov. 11, 2022.

(51) Int. Cl. B27N 3/08; B27N 3/00; C08L 97/02

(52) U.S. Cl. CPC B27N 3/083; C08L 97/02; B27N 3/002

(57) ABSTRACT

An external release agent for lignocellulosic composite panels or wood panels comprising a suspension of one or more synthetic or natural clays wherein the suspension medium can be either aqueous or nonaqueous and wherein wood strands, wood chips, wood fibers, or wood powder or their mixtures are utilized as raw materials for panel production.

### CROSS-REFERENCE TO RELATED APPLICATIONS

The present application claims priority from U.S. Provisional Application No. 63/424,751 filed on Nov. 11, 2022, the content of which is incorporated herein by reference in its entirety.

### TECHNICAL FIELD

The following generally relates to polymerization terminating layers for isocyanates utilized during manufacturing of cellulose-based products, and to releasing additives for wood panel manufacturing, particularly bentonite-based additives.

### BACKGROUND

During the manufacturing process of wood panels, the wood strands, wood chips, wood fibers, or wood powder are treated with waxes and resins to improve the physical and chemical characteristics of the panel. The wax primarily enhances its water resistance, while the resin, which is the binding agent, enhances its mechanical features. After such treatment, the resulting moisture-controlled wood particulates are fed into a press equipped with hot caul plates compressed to form a wood panel. Two types of presses are used in the industry: the “multi-opening press,” which has mild steel compressing surfaces, and the “continuous press,” which has stainless-steel surfaces. In the former case, the releasing agent is sprayed on the surface of the treated wood particulates of ambient temperature. In contrast, it is sprayed on the pre-heated metal surface in the latter case.

The plates typically operate within a range of 180 to 240 C. During compression of the panel, the temperature of the treated wood increases, part of its moisture content becomes steam, and the binding agent releases some volatile by-products while chemically reacting/polymerizing to bind the wood chips. After this compression period, the press opens, and the wood panel is removed from the press. When the adhesion is high between the metal press and the wood surfaces, the board cannot easily be removed from the press, causing production hiccups. It is believed that the unwanted wood-metal adhesion is the outcome of the reaction of the binding agent with the metal. Additives referred to as releasing agents, sprayed either on the metal or wood surfaces before compressing, have been shown to reduce or eliminate such adhesion.

It is desirable to develop improved releasing agents.

### SUMMARY

In one aspect, provided herein is an external release agent for lignocellulosic composite panels or wood panels comprising a suspension of one or more synthetic or natural clays wherein the suspension medium can be either aqueous or nonaqueous and wherein wood strands, wood chips, wood fibers, or wood powder or their mixtures are utilized as raw materials for panel production.

In an implementation, the bonding agent of the lignocellulosic composite panels contains an isocyanate derivative or a polymeric methylene diphenol diisocyanate (pMDI) resin or their combinations.

In another implementation, the suspension is aqueous.

In yet another implementation, the natural clay is talcum.

In yet another implementation, the synthetic clay is laponite containing a minimum of 80% wt alkali metal, ammonium, or hydrogen laponite or their combination and wherein the alkali metal, ammonium, or hydrogen term refers to the exchangeable cation or counter ion or interlayer cation.

In yet another implementation, the synthetic or natural clay is a 2:1 type of clay wherein two tetrahedral sheets sandwich one octahedral sheet to form a unit cell.

In yet another implementation, the natural clay belongs to the smectite clay class.

In yet another implementation, the clay dispersing agent is either alkali metal orthophosphate, alkali metal pyrophosphate, alkali metal trimetaphosphate, alkali metal triphosphate, alkali metal tetraphosphate, alkali metal hexametaphosphate, alkali metal polyphosphate, alkali metal carbonate, or a combination thereof, and wherein in these phosphates or carbonates zero, one, or more alkali metal ion is replaced by a hydrogen ion or ions.

In yet another implementation, the smectite comprises 60 wt % or more of alkali metal, ammonium, or hydrogen smectite or their combination and wherein the alkali metal, ammonium, or hydrogen term refer to the exchangeable cation or counter ion or interlayer cation

In yet another implementation, the smectite preferably comprises 80 wt % or more of alkali metal, ammonium, or hydrogen smectite or their combination and wherein the alkali metal, ammonium, or hydrogen term refer to the exchangeable cation or counter ion or interlayer cation.

In yet another implementation, the smectite more preferably comprises 90 wt % or more of alkali metal, ammonium, or hydrogen smectite or their combination and wherein the alkali metal, ammonium, or hydrogen term refer to the exchangeable cation or counter ion or interlayer cation

In yet another implementation, the clay dispersing agent is either alkali metal orthophosphate, alkali metal pyrophosphate, alkali metal trimetaphosphate, alkali metal triphosphate, alkali metal tetraphosphate, alkali metal hexametaphosphate, alkali metal polyphosphate, alkali metal carbonate, or their combination and wherein in these phosphates or carbonates zero, one, or more alkali metal ion is replaced by a hydrogen ion or ions.

In yet another implementation, the clay dispersing agent is disodium hydrogen phosphate and the clay-to-disodium-hydrogen-phosphate ratio is higher than 50:1 wt.

In yet another implementation, the clay-to-disodium-hydrogen-phosphate ratio is higher clay dispersing agent is preferably higher than 90:1 wt.

In yet another implementation, the clay-to-disodium-hydrogen-phosphate ratio is higher clay dispersing agent is more preferably higher than 100:1 wt.

In yet another implementation, the natural clay is montmorillonite, bentonite, saponite, attapulgite or a combination thereof.

In yet another implementation, the clay dispersing agent is either alkali metal orthophosphate, alkali metal pyrophosphate, alkali metal trimetaphosphate, alkali metal triphosphate, alkali metal tetraphosphate, alkali metal hexametaphosphate, alkali metal polyphosphate, alkali metal carbonate or their combination and wherein in these phosphates or carbonates zero, one, or more alkali metal ion is replaced by a hydrogen ion or ions.

In yet another implementation, the clay comprises 60% wt or more of alkali metal, ammonium, or hydrogen montmorillonite, bentonite, saponite, attapulgite or their combination, wherein the alkali metal, ammonium, or hydrogen term refer to the exchangeable cation or counter ion or interlayer cation.

In yet another implementation, the clay preferably comprises 80% wt or more of alkali metal, ammonium, or hydrogen montmorillonite, bentonite, saponite, attapulgite or their combination, wherein the alkali metal, ammonium, or hydrogen term refer to the exchangeable cation or counter ion or interlayer cation.

In yet another implementation, the clay more preferably comprises 90% wt or more of alkali metal, ammonium, or hydrogen montmorillonite, bentonite, saponite, attapulgite or their combination, wherein the alkali metal, ammonium, or hydrogen term refer to the exchangeable cation or counter ion or interlayer cation.

In yet another implementation, the clay dispersing agent is either alkali metal orthophosphate, alkali metal pyrophosphate, alkali metal trimetaphosphate, alkali metal triphosphate, alkali metal tetraphosphate, alkali metal hexametaphosphate, alkali metal polyphosphate, alkali metal carbonate, or their combination and wherein in these phosphates or carbonates zero, one, or more alkali metal ion is replaced by a hydrogen ion or ions.

In yet another implementation, the clay dispersing agent is disodium hydrogen phosphate, and the clay-to-disodium-hydrogen-phosphate ratio is 50:1 by weight or more.

In yet another implementation, the clay dispersing agent is disodium hydrogen phosphate, and the clay-to-disodium-hydrogen-phosphate ratio is preferably 90:1 by weight or more.

In yet another implementation, the clay dispersing agent is disodium hydrogen phosphate, and the clay-to-disodium-hydrogen-phosphate ratio is more preferably 100:1 by weight or more.

In yet another implementation, at least 85 wt % of the natural clay particles have a hydrodynamic diameter of less than 15 micrometers.

In yet another implementation, preferably, at least 95 wt % of the natural clay particles have a hydrodynamic diameter of less than 15 micrometers.

In yet another implementation, more preferably, at least 99 wt % of the natural clay particles have a hydrodynamic diameter of less than 15 micrometers.

In yet another implementation, even more preferably, at least 99.5 wt % of the natural clay particles have a hydrodynamic diameter of less than 15 micrometers.

In yet another implementation, non-clay (gaunge) minerals are present at a weight percent of less than 6%.

In yet another implementation, the non-clay (gaunge) minerals are preferably present at a weight percent of less than 1%.

In yet another implementation, the non-clay (gaunge) minerals are more preferably present at a weight percent of less than 0.1%.

In yet another implementation, the non-clay (gaunge) minerals are even more preferably present at a weight percent of less than 0.05%.

In yet another implementation, the non-clay (gaunge) minerals comprise one or more of calcite, feldspar, quartz, opal, and mica.

In yet another implementation, the release agent further comprises anionic and/or non-ionic surfactants.

In yet another implementation, at least one of the anionic surfactants is selected from the following groups: a) an ethoxylated or propoxylated phosphate ester or a salt thereof having a formula wherein, R, R1 and R2 are independently selected from the group consisting of H, and C6-alkyl chain having an average of 1-20 moles of ethoxylation or propoxylation with the proviso that at least one of R, R1 and R2 is H and the other one or two of R, R1 and R2 is a C6-C30 alkyl or alkenyl chain having an average of 1-20 moles of ethoxylation or propoxylation; b) a phosphate ester or a salt thereof having a formula wherein, R3, R4 and R5 are independently selected from the group consisting of H, and C6-C20 alkyl or alkenyl chain, with the proviso that at least one of R3, R4 and R5 is H and the other one or two of R3, R4 and R5 is a C6-C20 alkyl chain; c) a non-ethoxylated carboxylic acid or a salt thereof having a C6-C30 alky or alkenyl chain; d) an ethoxylated or propoxylated carboxylic acid or a salt thereof having an average of 1-40 moles of ethoxylation or propoxylation and a C6-C22 alkyl chain; and e) an organic anionic surfactant comprising sulfur.

In yet another implementation, the phosphate ester of group a) is a Poly(oxy-1,2-ethanediyl).alpha.-hydro-.omega.-hydroxy-monoC6-C12-alkyl ether.

In yet another implementation, the phosphate ester of group b) is a mixture of C8 and C10 alkyl phosphate esters.

In yet another implementation, the anionic surfactant comprising sulfur comprises at least one sulphonate functional group or an alkaline metal salt sulphonate and at least one C6-C24 carbon chain, wherein the at least one C6-C24 carbon chain is aliphatic or aromatic, linear, branched, saturated, unsaturated, ethoxylated, propoxylated, or combinations thereof.

In yet another implementation, the anionic surfactant is a petroleum sulphonate or derivative thereof, an alpha olefin sulphonate or derivative thereof, a sultaine derivative, a disulfonate, or a combination thereof.

In yet another implementation, the release agent composition comprises: one or more of the phosphate esters selected from a), and one or more of the phosphate esters selected from b); one or more of the phosphate esters selected from b) and one or more of the ethoxylated or propoxylated carboxylic acids or salts selected from (d); one or more of the phosphate esters selected from b) and one or more of the surfactants selected from (e); one or more of the phosphate esters selected from b), one or more of the ethoxylated or propoxylated carboxylic acid or a salt selected from (d), and one or more of the anionic surfactants selected from (e); or one or more of more of the phosphate esters selected from b) and one or more of the anionic surfactants selected from (e).

In yet another implementation, the ratio of the phosphate ester selected from a) to the phosphate ester selected from b) is from about 1:6 to about 6:1.

In yet another implementation, the ratio of the phosphate ester selected from a) to the ratio of the phosphate ester selected from b) is preferably from about 1:4 to about 4:1.

In yet another implementation, the ratio of the phosphate ester selected from a) to the phosphate ester selected from b) is more preferably from about 1:1 to about 3:1.

### BRIEF DESCRIPTION OF THE DRAWINGS

FIG. 1 is a schematic illustration of the wood-metal adhesion phenomena by terminating the resin polymerization on the metal surface.

FIG. 2 is a schematic illustration of the terminated polymerization on the high specific surface of the nanostructured Na-bentonite layer, wherein there is a high affinity between the sodium bentonite surface and the PMDI.

FIG. 3 is a schematic illustration of the coating layer's gaps caused by Ca-bentonite aggregates leading to PMDI termination points on the metal surface.

FIG. 4 is a schematic illustration of the coating layer's gaps caused by silica and mica contamination leading to PMDI termination points on the metal surface.

FIG. 5 is a schematic illustration of the metal-wood adhesion when some nanoparticle or clay (with low clay-to-PMDI affinity) is utilized as releasing agent or is embedded in the high-affinity Na-bentonite layer.

FIG. 6 is a schematic illustration of the three-layered method described herein. The purple-, blue- and grey-coloured arrows and block depict strands' alternating orientation (purple-first layer, grey-second layer, and blue-third layer). The outside box depicts a 7″×7″ SS plate.

FIG. 7 shows a full-matt demonstration. The leftmost image depicts the building of SS plate, Teflon sheet and the wood form builder. The filled grey area depicts the Teflon sheet, and the orange square depicts the wood form builder in the drawing. The yellow highlighted area depicts the 110 g of strands. In the rightmost image the brown wooden container is the Wood form builder, and the white block is the woodblock holder.

FIG. 8 is a graph of the MRDs of additives A, B, and A&B, presented for the case when A and B behave ideally from the perspective of release.

FIG. 9 is a graph of the MRDs of additives A, B, and A&B, showing a strong convex function indicative of a strongly synergistic mixture.

FIG. 10 is a graph of the MRDs of additives A, B, and A&B, showing a weak convex function indicative of a weakly synergistic mixture.

FIG. 11 is a graph of the MRDs of additives A, B, and A&B, showing a concave function indicative of an antagonistic mixture.

FIG. 12 illustrates the dependence of the Minimum Release Dose (MRD) of Bentonite-F on the Weight Fraction of Na2HPO4 in the Total Composition of the Additive at the MRD Condition. The wood moisture is reported in the Figure in % wt units.

FIG. 13 illustrates the sustainable release doses (SRDs) of Bnt-F as a function of wood moisture content at plate temperatures of 220 and 150 C of spraying.

### DETAILED DESCRIPTION

Described herein are chemical additives that may prevent, mitigate, or reduce adhesion between metal press surface and chemically treated wood strands, wood chips, wood fibres, wood powder, or wood panels during and after the high temperature and pressure compression step of the panel manufacturing process. More generally, provided herein are chemical additives for and methods for generating a terminating layer for isocyanates utilized during the manufacture of cellulose-based products. Such additives are often referred to herein as releasing agents. The utilization of such releasing agents may lead to a spontaneous, smooth, or easy (i.e., by applying some small force) detachment of the produced panels from the metal surface of the press either in the “continuous” or the “multi-opening” manufacturing process.

It was postulated that nanomaterials with extremely high specific surfaces could be used as releasing agents during the wood panel manufacturing process. Such materials may reduce or prevent contact between the binding agent (resin) in the wood chips and the metal surface of the hydraulic press, thereby facilitating the release of the panel from the metal plate. When the additives are present at the metal-wood boundary, the polymerization of the binding agent may be terminated either within the wood or on the surface of the nanomaterial, rather than on the metal plate surface. It is believed that the nanomaterial layers form a barrier between the wood fibres and the metal surface and thereby provide a barrier to prevent termination of polymerization of the polymeric binding agent, e.g., polymeric methylene diphenyl diisocyanate (pMDI), at or on the metal surface. Releasing agents used may have a low affinity for metal or wood surfaces, further facilitating detachment of the wood panel from the metal.

A not too strong attractive interaction among the deposited nanoparticles may also facilitate the detachment process. It has been found that clays or phyllosilicates, belonging to the natural nanomaterials class, may be effective releasing agents. Specifically, aqueous bentonite (CAS 1302-78-9, chemical name: magnesium aluminum silicate) clay suspensions containing nanoparticles were demonstrated to be effective wood panel releasing agents in the continuous or the multi-opening panel manufacturing process.

The needed minimum release dose (MRD) [in weight/area] of neat bentonite was lower than the dose of any chemical additives tested for the continuous process. And it was found that even the neat bentonite alone was an effective releasing agent; nevertheless, its efficiency can be improved by alkali metal phosphates. Furthermore, based on the bentonite-surfactant synergies observed in the multi-opening process, it is expected that anionic, zwitterionic and nonionic surfactants, including an alpha-olefin sulfonate, AEPE, and different chemical mixtures containing an alpha-olefin sulfonate, AEPE and non-ethoxylated organophosphate surfactants also enhance the releasing performance of bentonite in the continuous process as well. For the multi-opening process, it was beneficial to include the neat bentonite suspension as part of the chemical releasing agent formulation, as doing so reduced the required amount of other chemicals in the formulation. This decrease resulted from a novel synergism that was discovered. Experimental data supports that there may be synergistic interactions between bentonite clays and some chemical additives, including an alpha-olefin sulfonate, alkyl ethoxy phosphate esters (AEPEs), and different chemical mixtures containing an alpha-olefin sulfonate, AEPE, and a non-ethoxylated organophosphate surfactant. Although it is expected that one might be able to use some high surface dose of neat bentonite as a release agent in the multi-opening process, the high viscosity of concentrated bentonite suspensions limits the practicality of this avenue. It is because one can only achieve a high enough surface dose by spraying high concentration suspensions when has a restriction not to increase the moisture content of the wood by high volume aqueous spraying.

It is believed that the nanoparticle nature, or extremely high specific surface, of the additives is a necessary condition for the release. The dispersibility and surface chemistry of the clays appear to also play a role in the release, as it was found that hydroxyapatite clay nanoparticles could not perform as a releasing agent despite their high specific surface (C.f., Experiment 49 with hydroxyapatite nanoparticles in which no release was observed). Bentonites are absorbent swelling clays, and the swelling process contributes to their high dispersibility.

It was determined that high swelling capacity sodium bentonites have superior releasing performance as compared to “normal” or calcium bentonites of low swelling, which have limited or no releasing features. It was also found that the bentonite particles' surface charge and surface pH may also play a role in the releasing process because bentonite suspensions' releasing performances were shown to vary with the amount of phosphoric acid or sodium hydroxide additives present.

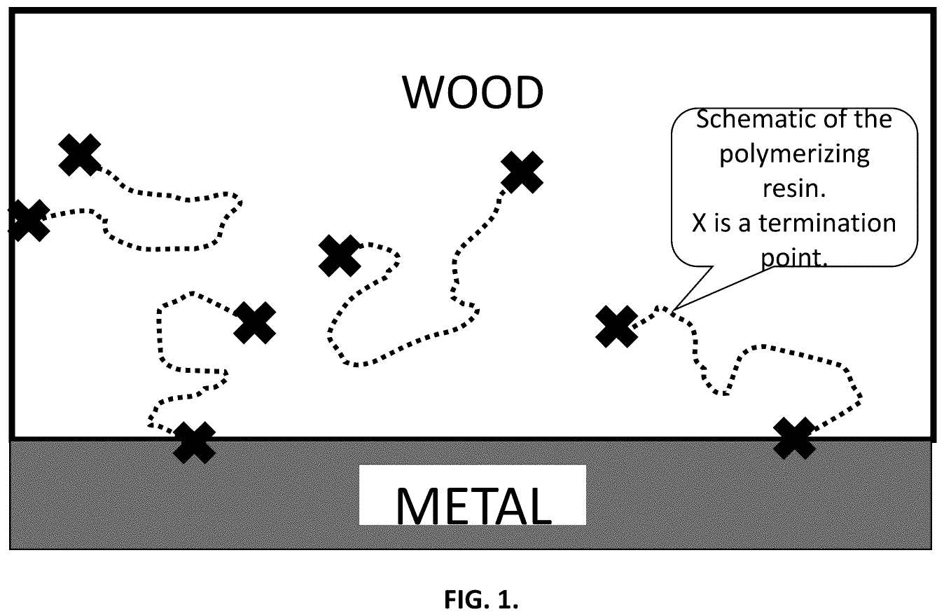

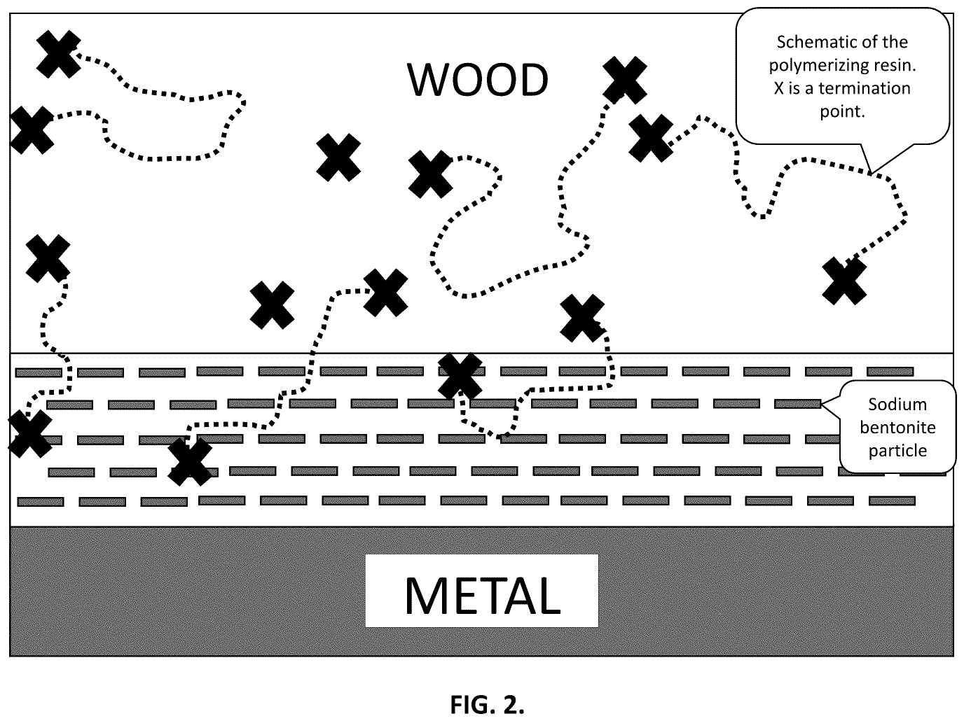

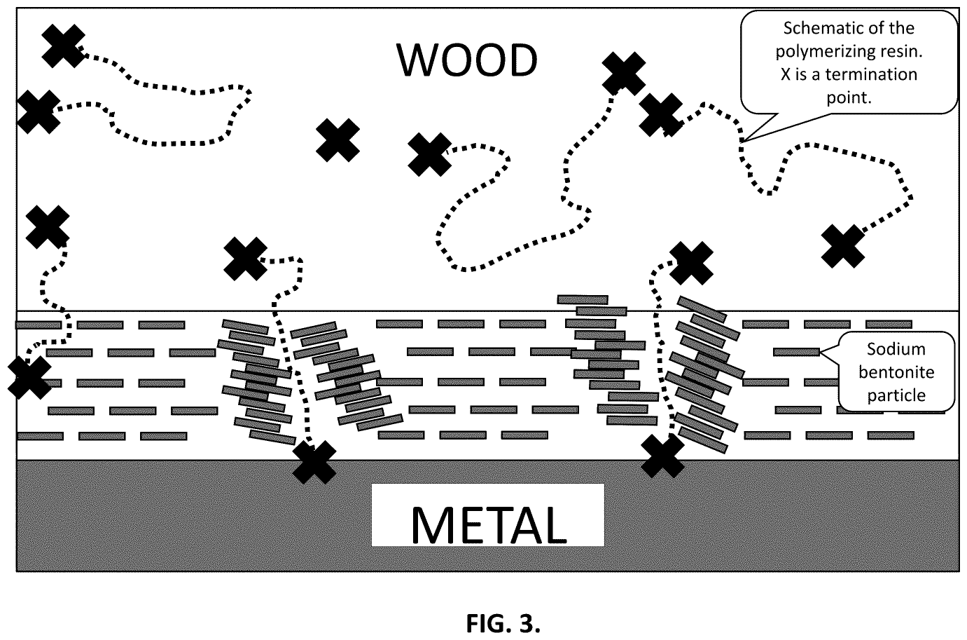

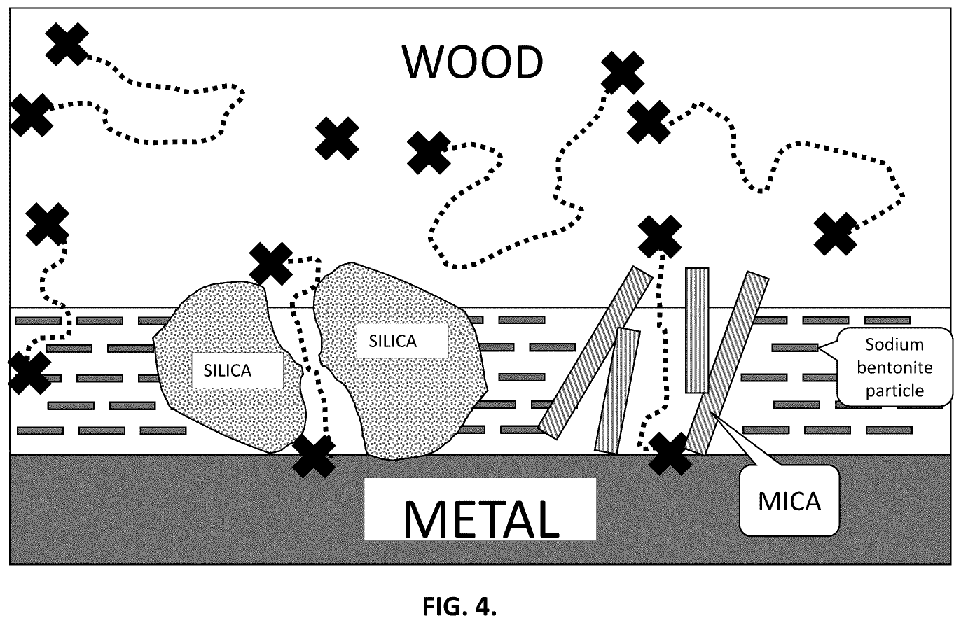

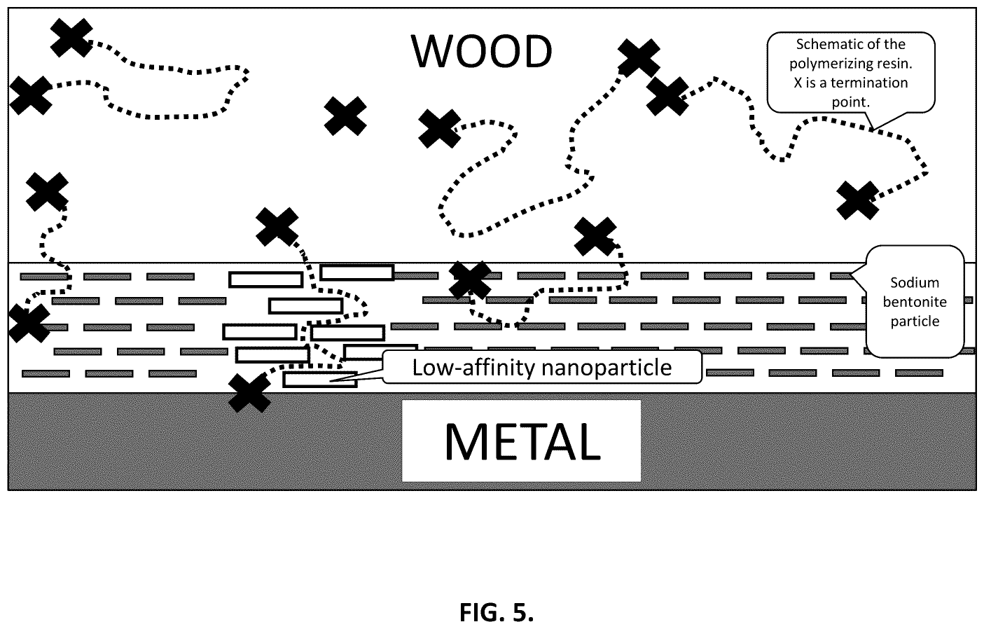

We also found that some natural contaminants (gangue minerals), including quartz, opal (C-T), mica, carbonates, calcite, feldspar, silica, mica, or poorly dispersed clay particles, can hinder the release. Therefore, without limiting our claims, we offer the following hypothesis for an explanation. In FIG. 1. the metal-wood adhesion is explained by the chemical reaction between the polymerizing pMDI and the metal surface. However, in FIG. 2, sodium bentonite particles' high-affinity and high specific surfaces capture the reacting pMDI chains before they could contact the metal. Hence, the adhesion mechanism described in FIG. 1. is eliminated. In FIG. 3. and FIG. 4., the gaps or imperfections within the coating layer are illustrated, which were introduced by some contaminants. The pMDI reaches the metal surface via these opened channels. In FIG. 5. some embedded nanoparticles of a high specific surface but a low particle-to-pMDI activity are presented (C.f., Experiment 49 with hydroxyapatite nanoparticles in which no release was observed), which could not prevent the pMDI-metal interaction. The contaminants also make the releasing process poorly reproducible. It is because the segregation of these contaminants in a suspension is a continuous process during which the contaminants accumulate in the container's bottom range. Hence, when the container's content is sprayed or sampled, the composition of the spray/sample depends on the settling time and sampling depth. As a result, the active release agent concentration will not be reproducible in the sample. Therefore, most of the test presented in this report was performed with “cleaned” sodium bentonites from which we removed the above-mentioned contaminants and clay aggregates by sedimentation. In addition we also tested a commercial bentonite sample (Bnt-F), with zero (undetectable) contamination level, that showed outstanding reproducibility and release performance. Because ammonium, hydrogen, lithium, or potassium bentonites, i.e., bentonite clay particles with ammonium, hydrogen, lithium, or potassium counter ions (alternative nomenclature: interlayer cations or exchangeable cations) have swelling characteristics like sodium bentonites, i.e., bentonite clay particles with sodium counterions, they are also expected to be effective releasing agents. However, they may also need to comply with corrosivity and stability requirements. Alternatively, we can also consider some synthetic clays, like the smectite hectorite clay (laponite), as a similarly successful releasing agent as bentonite, based on the similarity of their 2:1 layer structure (two tetrahedral sheets sandwich one octahedral sheet to form a unit cell), and the sodium, lithium, or potassium counter ion of laponite.

It was observed that aqueous releasing agent droplets bounce or trampoline (See: Graeber, G., Regulagadda, K., Hodel, P. et al. Leidenfrost droplet trampolining. Nat Commun 12, 1727 (2021)) when sprayed on hot metal press surfaces leading to a lowered and heterogeneous surface dose, thereby reducing the release performance. However, the inventors discovered that this bouncing phenomenon may be significantly mitigated when bentonite suspensions are sprayed, or bentonite is used as a co-additive in formulations.

Preventing corrosion of the metal press and the associated metal instrument is often challenging, since the corrosivity of releasing additives is exacerbated under the high operating temperatures. Therefore, it is generally desirable to use additives that are of low or negligible corrosivity. It was verified that the corrosion rate of sodium bentonites is similar to or not higher than the corrosion rate of water, meeting the industry requirement.

Above about 2-3 wt % concentration, aqueous sodium bentonite suspensions are non-Newtonian fluids with a significantly higher viscosity than water. Such high viscosities reduce sedimentation rates, leading to a lengthy clay cleaning process. Therefore, we screened viscosity candidates based on their effect on the viscosity of high concentration sodium bentonite suspensions. It was determined that sodium hexametaphosphate (SHMP) and disodium hydrogen phosphate are effective viscosity reducing candidates within the 0.1-2.0 wt % concentration range. Also, they can contain some sodium carbonate co-additive. We tested their effect on bentonite's release performance because these additives remain in the suspension after the cleaning step. The inventors found that SHMP and disodium hydrogen phosphate not significantly altered the performance of sodium bentonite suspensions at low concentrations. Hence, SHMP and disodium hydrogen phosphate may be used during bentonite manufacturing/cleaning. Moreover, these findings support the utilization of softened water for diluting bentonite stock suspensions because alkali metal phosphates and alkali carbonates are left behind after the industrial water softening process; hence, the presence of some residual phosphates and carbonates are permissible either in the diluting water or in the formulated bentonite suspensions. We also demonstrated an optimum bentonite release performance as a function of disodium hydrogen phosphate concentration.

Only the minimum sustainable release dose (MSRD) is independent of the preconditioning dose (PCD). The MSRD can only be determined by a series of trials and error experiments. The minimum release dose (MRD), which could be measured with significantly fewer efforts, depends on the PCD. Hence, during the synergy experiments discussed in this application, we considered to keep the total PCD constant for additives A, B, and the A&B mixture to make correct comparisons. Unfortunately, this is not always feasible. For instance, there could be cases when additive B has no MRD or its MRD is so high that it would demand increased volume spraying, which increases the wood's moisture content. This elevated moisture jeopardizes the results' comparability with the lower moisture content cases. Also, there are cases when there is a significant price difference between the additives. When additive B's price is negligible compared to additive A's price, the focus was the degree of MRD reduction of additive A due to the presence of additive B. Neither the MRD of additive B nor the convex-concave plots were measured for these two cases. Rather, conditioning was carried out with a pre-determined A-to-B ratio of the A&B mixture and measure the MRD of the mixture. Then the effect of additive B on the performance of additive A was judged by comparing the compositionally proportional MRD value of additive A in the mix with the MRD of additive A alone. For instance, additives A and B were used in a 1:1 ratio and 10 g/m² was the obtained MRD of the mixture, then the MRD of additive A is 5 g/m² under the condition of additive A-to-B ratio=1. In the next step, the MRD of additive A was measured in the absence of additive B. Suppose additive A's MRD in the mixture is lower than its MRD alone. This result suggests a beneficial interaction between the two additives. Of course, the PCD of additive A must be the same or similar in both experiments. For instance, when the total PCD is 20 g/m² for the mixture of the previous example, then the PCD must be 10 g/m² for the single additive A.

It was documented with many experiments that bentonite clay suspensions are surprisingly efficient as wood panel releasing agents in the continuous or the multi-opening panel manufacturing process. The MRD of neat bentonite was lower than the dose of any chemical additives tested for the continuous process. In the multi-opening process, bentonite suspensions were used as part of the chemical releasing agent formulation to reduce the amount of the needed chemicals. This reduction resulted from some synergism we discovered. There are synergistic interactions between bentonite clays and some chemical additives, including an alpha-olefin sulfonate, AEPE, and different chemical cocktails containing an alpha-olefin sulfonate AEPE and a non-ethoxylated organophosphate surfactant.

### Synergy Between Bentonite and Y2 Bentonite Addition

The synergy between bentonite and Y2 bentonite addition enhances the Y2 releasing agent's performance. We observed a three to eight folds performance improvement when replacing 20% of the surfactant mixture with bentonite. Compare 2.c.i.1. and 2.c.i.2. with 2.c.ii.1. This improvement range is an underestimation because the PCD in the Y2-alone experiment was higher than that of the mixed case. Hence, considering that “the lower the PCD, the higher the corresponding MRD” conclusion of the B-2 paragraph, we should conclude that the actual MRD reduction must be higher than three to eight folds. Y2 addition increases bentonite's releasing performance. When we compare 2.c.i.1. and 2.c.i.3. we can see that bentonite's MRD is improved by at least 18 folds considering “the lower the PCD, the higher the corresponding MRD” conclusion of the B-2 paragraph.

### Synergy Between Bentonite and Bioterge AS-40

Bentonite addition enhances the AS-40 releasing agent's performance. At a 0.18 Bnt-to-AS-40 ratio we observes a 40-fold performance improvement of AS-40, c.f., 2.c.i.5. and 2.c.iii.3. This improvement range is an underestimation because the PCD in the AS-40 alone experiment was higher than that of the mixed case. Hence, if we consider that “the lower the PCD, the higher the corresponding MRD” (see in the Conclusion B/B-2. The effect of PCD on the MRD paragraph), we should conclude that the actual MRD reduction must be higher than 40-fold.

It is also a business interest to formulate a stable and non-separating bentonite suspension after the cleaning. Because sodium bentonites develop static yield stress during undisturbed storage, preventing segregation, the formulation of a long shelf-life additive even in the absence of co-additives is promising. Nevertheless, polystyrene sulfonate and sodium carbonate were the best candidates for viscosity increase if needed. Sodium bentonites are also shear-thinning fluids, reducing the required pumping power of pipe transportation once their structure is broken by stirring.

Aqueous releasing agents are delivered as concentrates and diluted onsite with the available water that could contain a significant amount of calcium and magnesium ions. These bivalent ions could be detrimental to bentonite's performance. They could turn the original, highly dispersible sodium bentonite into a low dispersibility calcium or magnesium bentonite. Hence, we need to treat hard waters before use. It is beneficial to use the above-discussed sodium phosphates and sodium carbonates for water treatment because their residuals in the diluting water would not deteriorate the releasing performance of sodium bentonite.

Nanoparticle suspensions were tested as releasing agents. Natural clays of high specific surfaces, which swell spontaneously in water and polar solvents, are thought to be the preferred candidates for low-cost additives in line with our working hypothesis above. Specifically, phyllosilicates are targeted. More specifically, montmorillonites are targeted; even more specifically, bentonites; even yet more specifically, sodium or potassium bentonites.

### Sodium and Calcium Bentonites

The valency of bentonite's counter ion impacts their properties significantly. Divalent or trivalent counter ions reduce their dispersibility. The most dispersible bentonites have ammonium, hydrogen, lithium, potassium, or sodium counter ions. The sodium and calcium forms are frequently mined. Still, there is a mixed presence of these mono and divalent forms in the formations. Hence, the sodium to calcium counter ion ratio of native bentonites depends on the geographic location of the bentonite mine. When this ratio significantly differs from one, we distinguish sodium or calcium bentonites in addition to the “normal” or “unspecified” bentonite. The sodium bentonites have a considerably higher swelling capacity than the calcium ones; their suspension rheology is different. Sodium bentonite clay can swell osmotically during the hydration period, leading to independently suspended particles of high specific surfaces. Therefore, the aqueous suspensions of sodium bentonites have one of the highest specific surfaces among the native nanomaterials. The releasing property depends on, among other things, the bentonite's source; for instance, Bnt-A does not release at 20 g/m² dose, c.f., 1.a.i, while cleaned Bnt-E releases at lower than 0.001 g/m² dose, c.f., 1.f.ii.2.

### The Coarse and Fine Fractions of Sodium Bentonites

The specific surface, rheology, and stability of sodium bentonite clays depend on the particle size fraction of the bentonite particles. Also, some minerals, such as silica and mica, co-deposited with the clay in the geological formation, are present as separate particles, which we consider contaminants in this report. Because the sodium bentonites particles become independent nanoplates during the hydration and osmotic swelling period and have a thickness in the nanometer range and sizes in the micrometer range, their sedimentation rate is significantly lower than that of the contaminants, which are less dispersed even when hydrated. Therefore, in line with our working hypothesis, when we wet-fractionate a native sodium bentonite clay mineral, we obtain a more consistent sample with reduced contaminant level and increased performance. Consequently, we wet-fractionated (gravity or centrifugal) the sourced sodium bentonite clays in RO water. This wet process included the hydration and osmotic swelling steps supporting the separation of sodium bentonite particles from the contaminants. These contaminants were accumulated at the bottom of the container or the centrifuge tube because they have higher sedimentation rates than the bentonite nanoplates. One could gravity separate only the low concentration (1-2% wt) bentonites because these suspensions become non-Newtonian at higher concentrations, including the development of some thixotropic features and Bingham plastics characteristics. Hence, when we prepared low concentration bentonite suspensions with RO-water and gravity separated them from the contaminants, we ended up with some very low concentration cleaned bentonite suspensions. These suspensions were not practical for either preparing suspensions in a wide concentration range or testing the effects with co-additives. Therefore, we introduced two alternatives for obtaining higher concentration suspensions. We either (i) dried these suspensions at 100 C temperature to get bentonite flakes, which we grounded to lower than 850 micrometers (which is the same maximum size threshold as the original bentonite mineral had), before preparing a concentrated suspension. Or (ii) vacuum distilled them at 50 C to obtain some more concentrated stock suspensions of 3-6% wt concentration.

### Bentonite Contaminants

Crystalline silica particles are the most common contamination we are concerned about because inhaled crystalline silica is a carcinogen. Therefore, we wish to either reduce the crystalline silica content of the formulated product or lower its concentration in the air during wood panel manufacturing.

The crystalline silica and mica particles have lower specific surfaces than sodium bentonite particles and have different surface chemistry. Hence, we expect that they reduce the final product's performance (c.f., FIGS. 1-5 too). That is why their removal is a part of the manufacturing procedure.

Bentonite could also contain some other organic and inorganic contaminants. The impact of which on product performance should be investigated separately.

The additives tested as viscosity reducing and sedimentation/separation enhancing agents in bentonite suspensions were SHMP, Na₂CO₃, PS-5, AEPE, B-HCS, and NaH₂PO₄. Their effectiveness was visually compared by observing them in the same size Erlenmeyer flasks.

The sedimentation of mica particles was most effective in the SHMP containing suspensions. The NaH₂PO₄ containing samples sedimented less effectively than SHMP but more effectively than other additives. The Na₂CO₃ was able to separate heavier particles but also formed white precipitation. The AEPE containing suspension showed sedimentation only at high AEPE concentrations. The PS-5 and B-HCS containing suspension showed ineffective sedimentations.

Additionally, separation of clean water on top of the suspensions was observed. The additives that separate water include SHMP, Na₂CO₃, PS-5, and NaH₂PO₄. The water separation did not occur instantly, and the separation time varied. Also, some low concentration additives did not lead to water separation. The water separation is not desirable because the bentonite layer with the water removed becomes thicker, and the spontaneous water separation reduces the product's shelf life.

The viscosity reduction was also the most evident in suspensions containing SHMP, and NaH₂PO₄ was the second most effective viscosity reducing agent. In the case of Na₂CO₃, B-HCS and PS-5, the viscosity increased somewhat when tested with 12% Bnt. In all the last three cases, undesirable clump clumps formation was observable.

Overall, the 12% bentonite with 0.5% SHMP (J16-1, Bnt to SHMP ratio=24) could help the manufacturing process of Bnt as a releasing agent because it separated the mica particles the most effectively, while no water segregation occurred. Also, 12% Bnt-D+1% SHMP+1% Na₂CO₃ (J19) suspensions showed a similar result as J16-1.

We demonstrated that the releasing performance of smectite/bentonite-containing additives strongly depends on the water content of the bentonite/strands layer next to the metal surface of the pressing belt in the continuous wood panel pressing process.

One can utilize these findings' beneficial features by altering the plant's moisture delivery design and process as follows:
(i) the standard 7% wt strand moisture content can be increased to either to 10% wt or to higher than 10% wt, or to 15% wt, or even higher;
(ii) a water-spraying unit, which sprays the strands, can be implemented;
(iii) the time, while the sprayed additive could lose moisture, can be minimized by reducing the distance between the additive spraying point and the pressing point at a defined belt speed;
(iv) the temperature of the SS belt can be reduced at the spraying point and/or between the spraying and the pressing points.
(v) Some moisture retaining attitive (humectant) can be included in the formulation of the bentonite suspensions

We also invented that the release properties of the Bnt-F containing additive can be improved, i.e., the MRD can be decreased by adding either sodium carbonate or disodium-hydrogen-phosphate to the bentonite/smectite suspension.

In an entirely different approach, we discovered that aqueous, high pH NaOH solutions are release agents (see EXPERIMENT 73). We converted these laboratory findings to industrially applicable processes as follows. We spray sodium or potassium bicarbonate solution, i.e., NaHCO₃, and KHCO₃, respectively, as releasing agents on the SS metal belt instead of NaOH solution. The additives' solutions' pHs are close to neutral; therefore, they do not irritate. For instance, a 2 M/Liter KHCO₃ solutions pH is 7.84 at 25° C. temperature, while a 0.9 M/Liter NaHCO₃ solutions pH is 7.66 at 25° C. temperature. Under the high-temperature condition of the press, these bicarbonates thermally decompose and turn to the corresponding carbonates while releasing carbon dioxide. The pHs of these alkali carbonates are within the above-discussed releasing pH range of the high pH NaOH solutions. It is because they form a highly concentrated or saturated solution under the press conditions after they were deposited on the hot SS belt by spraying (during the continuous process) or being contacted with the hot mild steel plate when sprayed on the wood surface (during the multi-opening process). For instance, a 2 M/Liter K₂CO₃ solution's pH is 11.75 at 25° C. temperature, while a 2 M/Liter Na₂CO₃ solution's pH is 11.43 at 25° C. temperature. Consequently, they support the panel release. In addition, these bicarbonate solutions are also humectants at their saturated concentrations, which is an additional benefit for bentonite containing release agents, as we discussed above.

What is more, the released carbon dioxide (during the above-discussed thermal decomposition of alkali metal bicarbonates) has two additional benefits: It increases the fluid pressure in the press, leading to a decreased wood-fibre/metal contact pressure at a fixed total pressure of the press, which lowers the chance of fibre sticking to the metal; and the released carbon dioxide suppresses both the pMDI/water and the pMDI/iron-oxide reactions because both of these said reactions also release carbon dioxide. Hence, in the vicinity of the metal/wood interface, where the sodium or potassium carbonates are produced while releasing carbon dioxide, the pMDI has reduced chemical activity, lowering the chance of fibre sticking to the metal.

We expect the bicarbonates to maintain their beneficial effects on release when applied in other releasing formulations too. For instance, they are expected to be beneficial in the presence of surfactants, especially in alkali salts of aliphatic carboxylates, including ethoxylated carboxylates and alkali salts of aliphatic organophosphates including ethoxylated organophosphates.

Therefore, we claim the application of sodium, potassium, lithium, or ammonium bicarbonates solutions as releasing agents. These releasing agent solutions can also be used in formulations. These said formulations could contain either (i) the mixtures of the said bicarbonates, (ii) phyllosilicates, (iii) surfactants, (iv) alkali salts of aliphatic carboxylates including ethoxylated carboxylates, (v) alkali salts of aliphatic organophosphates including ethoxylated organophosphates, or some combination of cases i, ii, iii, iv, and v. The said formulations can also contain bentonites, montmorillonites, or phyllosilicates.

### Nomenclature and Notations

| Term | Explanation |
|---|---|
| Actives or solids | All additives in a formulation, excluding water and additives with equal |
| | or higher volatility than water. |
| AS-40 | Bioterge AS-40 surfactant |
| Bnt | Bentonite |
| Bnt-A | Southern bentonite (CAS 1302-78-9) from Fisher Scientific |
| Bnt-B | Sodium bentonite from Alfa Aesar |
| Bnt-C | Clay −1 from Bulk Apothecary |
| Bnt-D | Clear treat 1000 bentonite from Wyo-Ben, Inc. |
| Bnt-E | Clear treat 1040 bentonite from Wyo-Ben, Inc. |
| Bnt-F | Van Gel B bentonite from Vanderbilt Minerals |
| Cleaned Bentonite | A bentonite sample when its coarse fraction, including silica and mica |
| | particles, is removed |
| Centrifuge-separated | The first alternative of the Bentonite cleaning procedure. The coarse |
| bentonite (Bnt) | fractions of bentonite suspensions were separated by a centrifugal |
| | field, and the fine fraction was utilized in the tests. |
| Continuous process | The continuous belt press process uses the SS plate to manufacture |
| | wood panels. The additives are sprayed onto the SS plate, which is |
| | at a high temperature. |
| Dried bentonite layer | A light grey and dried layer forms when the water content in bentonite |
| | suspension evaporates either from spraying them on a hot plate or |
| | heating it to 220 C. |
| Force Gauge | Shearing force measuring instrument. |
| Full matt or 100% mat | 110-111 g wood fibre organized on a standardized 5″ × 5″ surface |
| | area. |
| Full release | This expression characterizes the OSB panel and metal plate |
| | adhesion. It describes the case when the OSB and metal detach |
| | spontaneously (i.e., when the weight of the panel is enough to |
| | separate itself from the metal plate) after the press test, and no wood |
| | chips are left behind on the surface of the metal. |
| Full stick | This expression characterizes the OSB panel and the metal plate |
| | adhesion. It describes the case when the shearing force needed for |
| | OSB-metal separation is higher than 740N. |
| Hot plate method | The liquid additive is sprayed on a metal plate of elevated |
| | temperature, allowing all solvents to evaporate instantly, leaving |
| | behind an even layer of additives. |
| HVLP Sprayer | High-Volume, Low-Pressure sprayer. |
| md | medium-sized piks that are bigger than peas but smaller than toonies. |
| Minimum release | The lowest concentration of the additive resulted in a full release. It is |
| concentration (MRC) | determined in a procedure in which the additive is repeatedly applied |
| [% wt] | (after the preconditioning step) on the metal/mat interface and press |
| | tested. The concentration of the additive is halved after each press |
| | test. |
| Minimum release dose | It is calculated from the MRC by considering the mass of “active or |
| (MRD) | solids” additives delivered on the surface by the liquid spray. |
| MPY | mils per year |
| MS | 6.5″ × 6.5″ mild steel, used for Multi-opening Press |
| Multi opening process | The press process where wood panels are manufactured using the |
| | MS plate. The additives are sprayed onto the wood panel and |
| | pressed at high temperature and pressure. |
| Unseparated bentonite | It is a bentonite sample when its coarse fraction is not removed. I.e., |
| | the bentonite powder provided by the supplier dispersed in RO water. |
| OSB panel | Oriented Strand Board |
| PC | Preconditioning |
| PCD | Preconditioning dose [g/m²] |
| Piks/piks | Wood strands stuck to the metal plate after pressing. Three types of |
| | piks are described in this document. |
| | sm = small piks about the size of peas |
| | md = medium-sized piks that are bigger than peas but smaller than |
| | toonies |
| | Lg = large-sized piks that are bigger than toonies. |
| Platen | The metal surface on the Carver press equipment where test plates |
| | with the multi-layered wood panel are placed. |
| pMDI | polymeric methylene diphenol diisocyanate (pMDI) resin used as an |
| | adhesive to make an OSB panel. |
| Polytron stirrer | Polytron 3100 stirrer/turbine |
| Pre-conditioning dose | The surface dose (see below) of an additive delivered on the metal |
| or pre-treatment dose | plate surface before the first release experiment was performed. Not |
| [active-g/m²] | to be confused with the treatment dose in a releasing experiment (see |
| | below). |
| | When the MRD is determined, we applied a no press cycle after |
| | coating the plate with the PCD. Instead of pressing, the same dose |
| | was applied again on the already dried pre-conditioned surface, and |
| | then the first press cycle was performed. |
| | When the SRD or MSRD is determined, we applied the first press |
| | cycle after coating the plate with the PCD. Then the dose was |
| | dropped to the expected SRD/MSRD, and the repeated press cycles |
| | were initiated to see their outcomes. |
| Pre-made form | 5″ × 5″ × 7/16″ pre-made OSB woodblock |
| Rotavapor | The rotary evaporator supplied by Buchi. The product code is |
| | Rotavapor R. |
| SHMP | Sodium hexametaphosphate |
| sm | Small piks about the size of peas |
| Surface dose [g/m²] | The areal concentration of actives or solids delivered on the metal |
| | plate surface or on the surface of wood fibres. |
| Sustainable Release | The concentration at which one can still obtain a full release after |
| Concentration (SRC) | repeating the release experiment with the same additive |
| [% wt] | concentration/dose ten times or more. The very first step of this entire |
| | procedure is the plate's pre-conditioning. |
| Sustainable Release | It is calculated from the SRC by considering the mass of “active or |
| Dose (SRD) [active- | solids” additives delivered on the surface by the liquid spray. |
| g/m²] | |
| SS | 7″ × 7″ Stainless Steel, used for Continuous Press |
| Stick/Stuck | This expression characterizes the OSB panel and metal plate |
| | adhesion. It describes the case when OSB-metal separation is not |
| | spontaneous, and the separating (shearing) force was either not |
| | measured or was lower than 740N. |
| Treatment dose | The amount of active additive used in a releasing experiment was |
| [active-g/m²] | sprayed either on the metal plate surface (for the continuous process) |
| | or the surface of the wood chips (for the multi-opening process) |
| | before performing a compression-release experiment. NB: Before |
| | any testing, the metal plate is pre-conditioned with the same additive |
| | used in testing. Then, when performing a series of compression- |
| | release tests, the highest treatment dose is applied first, either on the |
| | metal (for the continuous process) or on the wood (for the multi- |
| | opening process). |
| WF | Weight fraction. |
| Wood form builder | Before pressing, a container is used to shape and build a 5″ × 5″ wood |
| | matt. |
| Woodblock holder | Wooden holder used to press down the wood form in the wood form |
| | builder to take out the wood form builder without destroying the wood |
| | form before pressing. |

### Materials

### Bentonite

Bentonite is a clay that predominantly consists of smectite minerals, usually montmorillonite. One of the standard chemical formulas of Sodium bentonite is Al₂H₂Na₂O₁₃Si₄. Six different bentonite samples were tested, and their details are stated below.

Bnt-A: Southern Bentonite (CAS 1302-78-9), TIXOTON®. Fisher Scientific in Ottawa, Canada, supplied it. It is a sodium activated bentonite. The powder shows a Beige colour. It is used for laboratory experiments, water-well and mineral exploration and civil engineering purposes, including horizontal directional drilling and vertical drilling activities.

Bnt-B: Sodium bentonite (CAS 1302-78-9) Alfa Aesar, Massachusetts, USA, supplied it. The Lot number is 10215882. The bentonite powder's colour varies from cream to grey, and it is used for scientific research and development.

Bnt-C: “Normal” bentonite Clay, i.e., its sodium form, was not claimed. Bulk Apothecary, 115 Lena Drive Aurora, Ohio 44202 USA, supplied it. The composition is less than 2% of crystalline silica (CAS 14808-60-7), about 95% of bentonite without crystalline silica (CAS 1302-78-9), and 2% of silica (CAS 7631-86-9). It is a light tan colour to grey in powder form. About 80% of the powder passes through the #200 sieve, and about 97% of wet particle passes through the #200 sieve, indicating a small particle size.

Bnt-D and Bnt-E: Cleartreat 1000 (Bnt-D) and Cleartreat 1040 (Bnt-E). They were supplied by Wyo-Ben, Inc, Montana, USA. They both contain less than 6% of Crystalline silica (CAS 14808-60-7). The powder is light tan to grey. The pH of 5% bentonite suspension ranges from 8 to 10. The bentonite powders are used in water treatment. Bnt-D and Bnt-E have a cation exchange capacity (CEC) of 70-90 meq/100 g. They have an external surface area of 82 m²/gm, and their total surface area is 800 m²/gm. In the wet screening test, they both have a 3% wt residual on the #200 sieve. Bnt-D has a bulk density of 52±3 lbs/ft3, while Bnt-E has a bulk density of 62±3 lbs/ft3.

Bnt-F: VAN GEL B, The product of Vanderbilt Minerals, LLC, 33 Winfield Street Norwalk, CT 06855, USA. It contains 100% wt smectite (CAS 12199-37-0) clay. According to the manufacturers disclosure it is mostly montmorillonite (CAS 1318-93-0), which is the main smectite clay in bentonite (CAS 1302-78-9) and with some saponite (CAS 66732-77-2), another smectite clay. It has no detectable quartz (detection limit of 0.1%).

pMDI (Polymeric diphenylmethane diisocyanate)

pMDI is a brown liquid composed of polyaromatic isocyanates. The chemical formula of pMDI is (C₁₅H₁₀N₂O₂)ₙ. Three different pMDI were used to prepare the strands. 3 wt % added onto the waxed strands.

Rubinate FC 3390: This fast cure pMDI is supplied by Huntsman Polyurethanes in Ontario, Canada. It comprises 60% of Diphenylmethanediisocyante (CAS 9016-87-9) and 40% of 4,4′methylene diphenyl diisocyanate (CAS 101-68-8).

PM 200: This standard cure pMDI is supplied by Wanhua in Shandong, China. It is composed of 99% Polymeric diphenylmethane diisocyanate (CAS 9016-87-9*).

Luprinate M20 Isocyanate: This standard cure pMDI is supplied by BASF Canada Inc. in Ontario, Canada. It contains about 50-75% of p-MDI (CAS 9016-87-9), 25-50% of Diphenylmethane-4,4′-diisocyanate (MDI) (CAS 101-68-8), 3-7% of Methylene diphenyl diisocyanate (CAS 26447-40-5), 1-3% of 1,3-Diazetidine-2,4-dione, 1,3-Diazetidine-2,4-dione (CAS 17589-24-1), and 1-3% of isocyanic acid (CAS 57636-09-6).

### Proprietary Products

Y1: The pseudo component of Y1 deionized water, Bioterge AS-40, AEPE, KOH-45, and Ethox 1358.

Y2: The pseudo component of Y2 is deionized water, Bioterge AS-40, AEPE, 11.0% KOH-45, and Ethox 2989.

Y3 is used as a water-based degreaser. This product is composed of Water, Sodium Hydroxide, Sodium Gluconate, Triethanolamine, and Azelis Surf LO. This product is diluted with water, and it is used to clean the metal plates and remove any wood fibres stuck onto the metal plate.

Y4 is used as an acid cleaner, corrosion, and scale remover. The composition is water, Phosphoric acid, glycol ether, Antarox L61, and corrosion inhibitor. Y4 is diluted with water, and it is used to remove any organic residues on the metal plate.

Y5 is used as a powdered detergent. It is composed of PYLA Detergentblue Dye, Azelis Surf LO, Rolfor 91, Sodium Tripolyphosphate, Anhydrous Sodium Metasilicate, and Soda Ash Dense. This work is used to scrub the metal and remove any additives on the metal plate.

Y6 is a heavy-duty powdered detergent. It is composed of water, PYLA Detergenblue Dye, Rolfor 91-6, Sodium Tripolyphosphate, Sodium Sulphate, Soda Ash Dense, Anhydrous Sodium Metasilicate, and Calsoft F90. This powder is diluted with water to make it 30% active. The solution is then used to clean corrosion coupons.

### Additional Materials

Ethox 1358 is an aliphatic phosphate ester (99% active by supplier catalog), having H+cation, provided by Ethox Chemicals, LLC. in South Carolina, USA. It is a viscous liquid that shows water white to light yellow colour.

Ethox 2989: This additive, an organophosphate (CAS 68186-45-8, 99% active by supplier catalog, having H+cation) provided by Ethox Chemicals, LL C. in South Carolina, USA. It is a viscous liquid that shows water white to light yellow colour. It is mono and di-esters of phosphate made from C8 and C10 linear alcohols.

Cola®Teric ZF-50 (CT-ZF): This additive, Octyl Iminodipropionate (CAS 94441-92-6), is provided by Colonial Chemicals, Inc in Tennessee, USA. The pH of the 10% solution is 8.7. It is commonly used in industrial detergent cleaners.

Sodium hexametaphosphate (SHMP): This additive, a white solid composed of Na₆(PO₃)₆ CAS 101245-56-8. It is provided by Hubei XingFa Chemical Group in Hubei Province, China. SHMP is commonly used as a binding agent, corrosion inhibitor, anti-scaling agent or stabilizer.

Polystyrene sulfonate (PS-5): This additive is provided by TOSOH USA Inc., in Ohio, USA. It comprises 20% polystyrene sulfonic acid (CAS 25704-18-1) and 80% water (CAS 7732-18-5). Its pH is 8.6.

AEPE: AEPE is a surfactant provided by Sialco Materials Ltd., in British Columbia, Canada. According to the SDS, it is composed of 60-100% of Poly(oxy-1,2-ethanediyl), alpha-hydro-omega-hydroxy-, mono-C8-C10-alkyl ethers, phosphates (CAS 68130-47-2) and 1-5% of phosphoric acid (CAS 7664-38-2). However the former is actually phosphate mono esters of C11 ethoxylated alcohol (undecyl alcohol ethoxylate).

Sodium dihydrogen phosphate (NaH₂PO₄) is provided by BDH Inc., in Ontario, Canada (CAS 7558-80-7).

Bioterge AS-40 is a surfactant provided by Stepan Company in Illinois, USA. According to its SDS and COA, the product is composed of 50-60% Water (7732-18-5), 38-40% Sodium (C14-16) alpha olefin sulfonate (CAS 68439-57-6), 1.25% max. Alkene (C>10) (CAS 64743-02-8), 2% max. Sodium sulphate (CAS 7757-82-6), and 1% max. sodium chloride.

Azelis Surf LO: This additive is provided by Azelis Canada Inc., in Quebec, Canada. According to its SDS, the product is composed of 30% Amines, C10-16 alkyl dimethyl, N-oxides (CAS 70592-80-2), 70% of distilled water (CAS 7732-18-5), and <1% of hydrogen peroxide solution (CAS 7722-84-1).

Antarox L-61 is provided by Solvay USA Inc., in New Jersey, USA. According to its SDS, the product is composed of >99.5% Ethoxylated Polyoxypropylene (CAS 9003-11-6) and <0.5% of water (CAS 7732-18-5). It is a clear to slightly hazy liquid. The pH of a 2.5% solution is 5.0-7.5.

Rolfor 91 is provided by Azelis Canada Inc., in Quebec, Canada. The supplier did not provide its composition. The pH is 5-7. It is a colourless liquid.

Water: Reverse Osmosis water, RO-water, was used to prepare all the samples unless stated otherwise.

1018 carbon steel coupon: The Caproco Internal Corrosion Monitoring Specialists in Alberta, Canada, supplied the coupons. The size of the coupons is 3 in×0.75 in×0.125 in with two mounting holes. The exposed surface area is 4.65 in².

B-HCS is Burco HCS-50 NF surfactant supplied by Burlington Chemical Company in North Carolina, USA. B-HCS contains 50% modified Alkylether Hydroxypropyl Sultaine.

KOH-45 is a 45% wt caustic potash provided by Univar.

### Examples

### Methods

The order of work in one release test is (1) Bentonite Cleaning Procedure, (2) Bentonite Concentration Measurement Procedure, (3) Strand Preparation Procedure, (4) Metal Plate Cleaning Procedure, (5) Building of Wood Panel Procedure, (6) Additive Spraying Procedure, and (7) Manual Press Procedure.

### Bentonite Cleaning Procedure

As mentioned, bentonite is a mixture of clay minerals, and it contains crystalline silica, a known cancer-causing substance. Therefore, the bentonite suspension is cleaned using the five methods mentioned below. The cleaning procedure is not applicable for non-bentonite-containing additives.

### 1—Centrifuge

The model of centrifuge used is the “H N centrifuge” by the International Equipment Company. The setting of the centrifuge is set for 2715 rpm for 10 minutes. Then, only the supernatant is collected, and the pellet is disposed of. This method allowed for making the cleanest bentonite sample, but the concentration of mixture achieved was too small, and the maximum volume it could provide was only 300 mL (50 mL centrifugal bottle×6) which decreased productivity significantly.

### 2—Fine Fraction

With 2% Suspension made, the suspension was left to sediment for a minimum of three days (72 hours). About 80% of the top-layered suspensions were suctioned to a clean flask using high-pressure suction. The suctioned suspension is then ready to be used in experiments. This method was easy and could easily make large volumes of suspension; however, the suspension concentration was too low.

### 3—Redispersion

First, about 2% suspension was made, and the suspension was left to sediment for a minimum of three days (72 hours). Effective sedimentation is confirmed by observing sedimentation of mica particles (darker than bentonite) at the bottom of the flask. About 80% of top-layered suspensions were suctioned to a clean flask using high-vacuum suction. The suctioned bentonite is then poured into a temperature-resistant container and left in the oven at a temperature of 104° C. until it dries (24-48 hours). The dried bentonite sample is grounded to fine particles using a large mortar and pestle. The dried particles are then passed through the #200 sieve to confirm the size, similar to Cleartreat 1000 and 1040. The dried particles are redispersed in RO water and used in experiments. This method took a lot of force and time with grinding the samples, and press results show that dried samples perform less effectively (i.e., higher MRC found than other methods). We suspect that heating of bentonite sample alters its properties, hindering the releasing performance.

### 4—Concentrate Via Rotavapor

First, 2% bentonite suspension was made, and they were left to sediment for a minimum of three days (72 hours). About 80% of top-layered suspensions were suctioned to a clean flask using high-vacuum suction. The suspensions were distilled using rotavapor, concentrating the suspension by evaporating water. This method requires a long time to make high volume; however, suspensions with high concentrations were made.

### 5—No Cleaning

In this method, cleaning was not done. The bentonite powder was dispersed in RO water and mixed overnight.

### Bentonite Concentration Measurement Procedure

Once the bentonite was cleaned, the concentration was measured by the steps described below.

First, the oven was heated to a temperature of 104° C. Once the stable temperature was achieved, the weight of the aluminum weight tray was measured at 0.01 g resolution. Then, 10 g of bentonite suspension was weighted onto the aluminum weight tray, and the weight was recorded. The tray with bentonite suspension was placed in the pre-heated oven for 4 hours. After 4 hours, the tray with dried bentonite suspension is weighted. The concentration can be found by using the following formula.

$$\% concentration of bentonite = 10 \; 0 \% \times \frac{Wt . Dried bentonite powder}{Wt . pre - dried bentonite aqueous suspension}$$

### Where:

Wt. Dried bentonite powder=Wt. (Aluminum tray+dried bentonite)−Wt. Aluminum tray.
Wt. Pre-dried bentonite aqueous suspension=Wt. (Aluminum tray+pre-dried bentonite)−Wt. Aluminum tray.

### Wood Strands Preparation Procedure

### 1—Wood Fibre Screening:

The fibres were placed onto the #200 sieve. Then the sieve was shaken via side-to-side movement that moved the smaller fibres and wood dust down to the tray. Once the weight of the retained strands was measured to be 300 g, they were placed in the rotating tumbler.

### 2—Wood Moisture Control:

Every drum of strands we received had different moisture level. Therefore, every 2-3 weeks, the moisture level of the strands was measured to replicate the actual application at the mill and increase the reproducibility of release testing. After measuring the moisture level, the level was corrected to the target moisture by spraying RO water onto the strands.

To measure the moisture level of strands, the industry-standard Moisture Teller was mimicked:
1) The mass of a wide baker was measured with a precision of 0.01 g.
2) About 10 g of wood strands were measured and placed in the baker.
3) It was dried in the pre-heated oven at 104° C. temperature for 20 minutes. After 20 minutes, the baker was taken out of the oven and covered tightly with aluminum foil. Once the baker got cooled down to room temperature, its weight was measured without removing the foil.
4) The foil was removed, and its weight was measured separately.

The weight fraction of the moisture in the strands was calculated using the formula below.

$$Weight fraction of water = \frac{B W - BWA + A}{B W - B}$$

### Where:

B: weight of the empty baker (g)
BW: weight of the baker and wood together before heat treatment (g)
BWA: weight of the baker and wood and aluminum foil together after heat treatment (g)
A: weight of the aluminum foil (g)

Once the ‘Weight fraction of water is calculated, an additional amount of water that needs to be added is calculated using the formula below. Additionally, the moisture is added the day before the press experiment and stored in a tightly sealed container.

$$Weight of water to be added = \frac{{A}_{x} {W}_{w o} - {W}_{w o} {A}_{x / wo}}{1 - {A}_{x}}$$

Where:
W_{wo}=weight of wood strands as it is (g)
A_{x/wo}=mass fraction of water in wood
Aₓ=mass fraction of total water content in strands we want=0.1

It was realized that not all the added water is absorbed onto the strands. Therefore, we introduced a correction multiplier of 1.2 that we determined experimentally. Hence, the above-calculated ‘Weight of water to be added’ should be multiplied by 1.2, and this is the final amount of water we should add to the strands in the tumbler using Aztek A470 Airbrush.

### 3—Waxing and Resination:

In the OSB mill, different strand sizes are blended in a rotating drum with resins and wax. Strands were added into a tumbler and rotated to follow the actual application. The speed of the tumbler was usually set for about 2 to ensure homogenous mixing of strands. While rotating, the EW-585 wax was first sprayed using Aztek A470 Airbrush. The amount of wax added is 0.8%×the total weight of strands. After the waxing, the strands were resinated with pMDI using a Husky HVLP (High Volume Low Pressure) sprayer. The amount of pMDI added is 3.0%×the total weight of strands. Waxing and Resination are done on the morning of the experiment. The moisture controlled and wax/pMDI treated strands are then stored in a sealed container to ensure consistency.

### Metal Plate Cleaning Procedure

### 1—Regular Cleaning

First, dirty plates were placed in a Y3 bath and left to soak overnight. Then, they were washed with warm water while scrubbing all the loose materials left on the plates. The plate was scrubbed vigorously with a green scrub pad using Y5 powder. The Y5 powders were washed away with hot water. Once the surfaces appeared clean, the plates were briefly dipped in Y4 four times to remove any organic residues and brighten the metal. Then the plates were rinsed again in hot water and scrubbed gently with Y5 again to neutralize any residual acid. Immediately wipe both sides with a paper towel.

### 2—Polishing

The plates were polished using Random Orbit Sander to ensure clean surfaces whenever new additives were introduced and tested. First, diagonal lines were drawn on the plate with a permanent marker. The plates were polished with 60 grit sanding paper. When most of the markers were invisible, the 100 grit was used. Lastly, 220 grit sanding paper was used to brighten the plate. The plates were considered properly polished once the lines drawn with a permanent marker were invisible. The polished plates were flushed with Acetone and dried.

### Building Wood Panels

### 1—Three-Layered Method.

The panels were built on a 5″×5″× 7/16″ pre-made form by alternating the orientation of the strands three times (FIG. 1), making a 5″×5″ three-layer on top of the pre-made form. These panels were placed on a 7″×7″ SS plate. A force gauge was used to measure the force when the clean release was not observed. This method was not representative of the actual applications at the mill; hence new wood panel building methods were introduced.

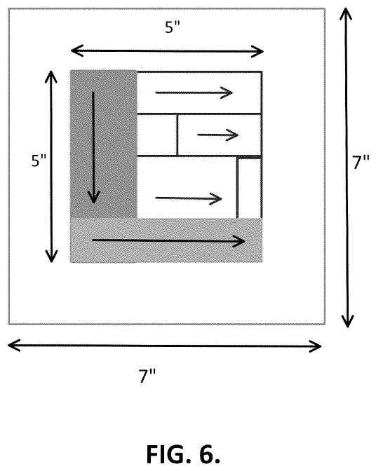

FIG. 6. The three-layered method demonstration. The purple-, blue- and grey-coloured arrows and block depict strands' alternating orientation (purple—first layer, grey—second layer, and blue—third layer). The outside box depicts a 7″×7″ SS plate.

### 2—Thick-Matt/Full-Matt Method.

This method was used to mimic the actual application in the wood processing plant:
1) A 6.5″×6.5″ Teflon sheet was placed on the SS plate.
2) A 5″×5″×4″ wood form builder was placed on the Teflon sheet. 110 g of waxed and resinated strands were laid out in the wood form builder as even as possible.
3) The woodblock holder pushes down on the formed fibres while lifting the wood form builder away.
4) The stable thick-mat wood form should be made on a Teflon sheet.

The shearing force is not measured using this method because uneven side surface leads to breaking the wood panel. This method was used in most experiments but decreased productivity as the time required to prepare strands increased significantly.

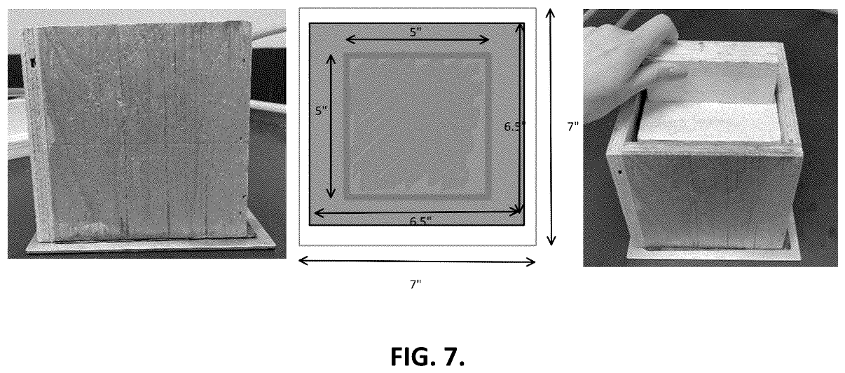

FIG. 7. The full-matt demonstration. ‘A’ depicts the building of SS plate, Teflon sheet and the wood form builder. The filled grey area depicts the Teflon sheet, and the orange square depicts the wood form builder in the drawing. The yellow highlighted area depicts the 110 g of strands. In ‘B,’ the brown wooden container is the Wood form builder, and the white block is the woodblock holder.

### 3—75% Wood Panel.

We used 80 g (75% of 110 g) of strands to increase productivity while observing similar release result as the full matt method. The 80 g matt was built the same way as the full matt, except the mass of the strands placed in the wood form builder was decreased to 80 g.

### Additive Spraying Procedure

Depending on the application, three different spraying methods were used.

### 1—Hot Plate Method.

First, the SS plate is heated in the oven at a temperature of 220° C. for 15 minutes. Once the plate was at the desired temperature, the additives were sprayed using a Husky HVLP sprayer connected to nitrogen gas. It was ensured that the additives sprayed onto the hot plate were instantly dried, forming an even layer. In this method, the plate was reheated in the oven for five minutes before every spray. The hot plate method mimics the continuous mill in the industry closest as the SS plate is always hot.

### 2—Cold Plate Method (A).

This is the initial cold plate method used to spray low flashpoint additives. First, the additives were sprayed on the MS plate. The MS plate was then heated to the temperature of 130° C. on a hot plate for 15 minutes under the fume hood. Once all the additives are dried and formed a layer, it is reheated on the press at the temperature of 220° C. for three minutes before pressing.

### 3—Cold Plate Method (B).

This method was utilized when additives were bouncing out of the SS plate when sprayed onto the hot plate. First, the additives were sprayed on a cold SS plate and heated to a temperature of 220° C. in the oven for five minutes. All the additives were thoroughly dried during this five-minute window. Once the additives were wholly dried, they were pressed. After pressing, the SS plate was cooled down to room temperature by placing it in the freezer for five minutes. Then, the additives were sprayed onto the cooled SS plate, and the heating/pressing cycle was reinitiated.

### 4—Multi-Opening Press Method.

This method is primarily used when testing for the multi-opening press. Using a bottle sprayer or Husky HVLP sprayer, the additives were sprayed onto the wood form directly. The additive-sprayed wood form was left for a minute before placing the test MS plate on the wood form. The bottle sprayer was used when using the full matt method, whereas the Husky HVLP sprayer used the three-layered method. A New MS plate is used in every test.

### Manual Pressing Procedure

Using moisture controlled (10%), waxed (0.8%), and pMDI (3%) treated strands, a wood form was prepared. Depending on the spraying method, the additives were sprayed onto an SS plate or wood form. Then, the test plate was placed on the press for three minutes with a temperature of 220° C. The three minutes on press apply regardless of what spraying method was used. Then, the test plate is placed center-wise on top of the wood form. This sandwich-like setup was carefully moved into the heated press. The press was then cranked to the pressure of 500.9 psi.

Two different pressing cycles are used depending on the pMDI used. The cycle time was suggested by the mill. The first method was used for standard cure resin, including Luprinate M20 and PM 200. Once it reached 500.9 psi, a two-minute timer was started, and the pressure was held for 15 seconds. When the timer goes off, the timer starts counting upward while beeping. When the timer is 24 seconds over, the pressure is slowly released to zero pressure by 31 seconds. Once the timer is 38 seconds over, the timer is turned off, and the press is fully opened to remove the sandwich-like setup. The top plate is removed, and release is noted. The second method was used for fast-cure resin, including Rubinate FC 3390. Once the pressure reached 500.9 psi, a two-minute timer was started, and the pressure was held for 15 seconds. When the timer goes off, the timer starts counting upward while beeping. When the timer is at 14 seconds over, the pressure is slowly released to zero pressure by 21 seconds over. Once the timer is at 28 seconds over, the timer is turned off, and the press is fully opened to remove the sandwich-like setup. The top plate is removed, and release is noted.

### Release Testing Procedure

There are two release test methods.

### 1—Reference Test:

The objective of the reference test is to observe MRC and MRD.

First, preconditioning is applied. The preconditioning rate varies depending on the additives, and this information is discussed in every experiment. After applying pre-conditioning, the plate is reconditioned before applying the first press dosage. (i.e., (i) heat up to 220° C. for five minutes if using the hot plate method, (ii) heated to 220° C., dried, and cooled down to room temperature if using the cold plate method, or (iii) timer is set for a minute if additives are sprayed onto the wood panel). The first dosage is applied, and the plate is placed on the platen for three minutes. Then, press following the Manualpressing procedure mentioned above. After pressing, the plate is prepared for the next spray (i.e., (i) for the hot plate method, the plate is heated in the oven with a temperature of 220° C. for 5 minutes, (ii) for the Cold plate method, the plate is cooled down to the room temperature by placing in the freezer for 5 minutes, (iii) for multi-opening method, the new plate is placed on platen). The next additive is then sprayed onto the prepared plate after the said heating, cooling, or replacing step. For every pressing, the concentration of the additives used in the consecutive pressing is halved by diluting it with RO water. These diluted additives were stirred for 90 seconds before spraying. The experiment was completed when two consecutive stickings were observed.

### 2—Sustainability Test:

The objective of the sustainability test is to find the SRC and SRD by observing ten consecutive releases at a selected concentration. The sustainable concentration is chosen based on the MRD/MRC value—the SRC is usually chosen at about three to four times higher concentration than the MRC [% wt] observed in the reference test. If the sustainable test is repeated with different concentrations and doses, one could determine the MSRC and MSRD.

First, the same amount of preconditioning as the reference test is applied. The plate is reheated in the oven at a temperature of 220° C., and then the first dosage is applied. Then, the first press is made. The subsequent concentration of additives sprayed onto the plate is the SRC, and at this concentration, 10 presses are made. If the 10 presses are successfully released, the test can be repeated at lower concentrations. If the releases are not consecutive, then increase the SRC.

### Additional Note:

In the experiment, the test plates were heat-treated for an hour.

### Abridged and Hierarchized Outcomes of the Observations

1. Continuous process with SS plate
   a. Cold plate and three layers mat
      i. Unseparated Bnt-A bentonite additive
         1. In Exp-1, where no preconditioning was applied, a clean release was observed at 5.90E+00 g/m² dose and the MRD>2.95E+00 g/m².
         2. In Exp-2, where no preconditioning was applied, a release was not observed at 5.90E+00 g/m² dose. In addition, the release was not observed up to 1.50E+01 g/m² dose.
         3. In Exp-3, where no preconditioning was applied, a release was not observed at 5.90E+00 g/m², 1.22E+01 g/m², 2.01E+01 g/m² doses.
   b. Hot plate and full mat
      i. Unseparated Bnt-B sodium-bentonite additive.
         1. In Exp-07 and Exp-08, the Bnt-B was used with PCDs of 1.16E+01 g/m² and 1.26E+01 g/m², obtaining 6.46E−02 g/m² and 2.15E−03 g/m² MRD respectively.
         2. This section was left empty intentionally.
         3. In Exp-13, we attempted to find a sustainable release dose of Bnt-B. We found that its MSRD is higher than 8.61E−03 g/m² when the PCD is 1.26E+01 g/m².
      ii. Unseparated Bnt-C “normal” bentonite additive.
         1. In Exp-12, we found that the MRD of Bnt-C is higher than 4.20E+00 g/m².
      iii. Centrifuge-separated Bnt-D sodium-bentonite additive.
         1. In Exp-20, we found that its MRD≤3.34E−02 g/m² at 1.48E+01 g/m² PCD
         2. In Exp-15, its MRD=8.61 E−03 g/m² at 1.47E+01 g/m² PCD.
         3. In Exp-23 and Exp-24, it was found 5.24E−01 g/m²≥SRD>2.60E−01 g/m² at a PCD of 2.78E+00 g/m².
         4. In Exp-26, when no preconditioning was applied, no release was observed at 1.93E−1 g/m² Bnt dose with 0.20 Bnt-to-SHMP ratio or at 5.15E−1 g/m² Bnt dose with 0.80 Bnt-to-SHMP ratio.
         5. In Exp-27, under the Bnt-to-SHMP ratio=0.733 condition, the Bnt's SRD=1.17E−1 g/m² at a PCD of bentonite: 4.9E−1 g/m².
         6. In Exp-28, under the Bnt-to-PS-5 ratio=2.84 condition, the bentonite's SRD=5.24E−01 g/m², at no preconditioning.
         7. In Exp-21, the MRD of the total solid (including the pseudo component: 23.3% of Ethox 2989, 23.4 Cola Teric Surfactant, and 13.7% KOH) was 1.05E+00 g/m². No synergy was observed with the pseudo component.
         8. In Exp-22, under the Bnt-to-PS-5 ratio=0.003 condition, the bentonite's MSRD>5.33E−01 g/m².
         9. In Exp-30, under the Bnt-to-Y2 ratio=1.0 condition, a release was observed at 1.74E+0 g/m² Bnt dose at no preconditioning.
      iv. Gravity-separated Bnt-D sodium-bentonite additive.
         1. In Exp-18 and Exp-19, we found that 2.10E+00 >MSRD>5.20E−01 g/m² at a PCD of 1.47E+01 g/m².
      v. Unseparated Bnt-D sodium-bentonite additive.
         1. In Exp-25, we found that the MSRD>5.24E−01 g/m² at a PCD of 2.78E+00 g/m².
         2. In Exp-26, when no preconditioning was applied, the bentonite's MRD=7.67E−2 g/m² at 0.07 Bnt-to-SHMP ratio, and no release was observed at 2.56E−1 g/m² Bnt dose with 0.29 Bnt-to-SHMP ratio.
      vi. Gravity separated Bnt-E sodium-bentonite additive
         1. In Exp-33, where the dried bentonite was redispersed, we found the MRD<3.77E−02 g/m² when no preconditioning was applied.
         2. In Exp-34, where the separated bentonite was not dried and had a pH=9.28, we found that the MRD=9.69E−03 g/m² at 2.42 g/m² preconditioning.
         3. In Exp-44, where the separated bentonite was not dried, we found the MRD=3.02E−01 g/m² when no preconditioning was applied.
      vii. Gravity separated Bnt-E sodium-bentonite additive concentrated with vacuum distillation
         1. In Exp-38, Exp-39, and Exp-40 the bentonite suspensions were titrated, to pH=7.18, pH=8.5, and pH=9.5 respectively by using NaOH and H3PO4 solutions. Their release tests were performed at the same 2.43E+00 g/m² PCD leading to the following results respectively: 1.52E−01=MRD, 2.43E+00=MRD, and 2.43E+00<MRD.
         2. In Exp-35, the bentonite suspension was mixed with AEPE (with a pH of 9.09, titrated with NaOH). Under the Bnt-to-AEPE ratio=1 condition, the bentonite's MRD=9.7E−3 g/m² when the Bnt PCD is 1.22 g/m². Alternatively, under the Bnt-to-AEPE ratio=1 condition the AEPE's MRD=9.7E−3 g/m², when the AEPE PCD is 1.22 g/m².
      viii. Sodium hydroxide alone
         1. In Exp-14, the release was observed at pH 12.44 and 11.58, but the plate stuck at pH=11.
      ix. This section was left empty intentionally.
      x. This point was left empty intentionally.
      xi. Pseudo component: 23.3% of Ethox 2989, 23.4 Cola Teric Surfactant, and 13.7% KOH
         1. In Exp-21, the MRD of this composite additive is 1.05 g/m² when its PCD is 14.7 g/m².
      xii. Hydroxyapatite and PS-5 mixture
         1. In Exp-49, under the hydroxyapatite-to-PS-5 ratio=5.26 condition, the Hydroxyapatite's MRD>3.98 g/m² when no preconditioning was applied.
   c. Hot plate and 75% mat
      i. Gravity separated Bnt-E sodium-bentonite additive
         1. In Exp-43, the MRD=3.02E−01 g/m² at no preconditioning.
      ii. Gravity separated Bnt-E sodium-bentonite additive concentrated with vacuum distillation
         1. In Exp-56, the bentonite's MRD=2.57E−03 g/m² at 2.75 g/m² PCD.
         2. In Exp-57, bentonite suspension was mixed with SHMP at a 5.98 Bnt-to-SHMP ratio. The mixed additive's MRD=2.69E−03 g/m²; the bentonite's MRD is 2.31E−03 g/m². While the mixed additive's PCD is 2.75 g/m², and the Bnt's PCD is 2.36 g/m².
      iii. AEPE alone
         1. In Exp-36, the AEPE's MRD>2.42 g/m2 when 2.42 g/m2 PCD is applied.
   d. Hot plate and 25% mat
      i. Gravity separated Bnt-E sodium-bentonite additive
         1. In Exp-42, the MRD=7.55E−02 g/m² at no preconditioning.
   e. Hot plate and three-layers-mat
      i. Gravity-separated Bnt-D sodium-bentonite additive.
         1. Based on Exp-17, in which 1.47E+01 g/m² and 1.48E+01 g/m² PCDs were applied, it is expected that MRD>1.05E+00 g/m².
         a. In Exp-16, we found the MRD=2.60E−01 g/m² when 1.47E+01 g/m² PCD was applied.
         b. In Exp-18, we found that MSRD>2.10E+00 g/m² when 1.47E+01 g/m² PCD was applied.
   f. Cold plate
      i. Full mat
   g.
      1. Y2 alone
         a. In Exp-32, the Y2's MRD=3.77E−02 g/m² when no preconditioning is applied.
      ii. 75% mat
         1. AEPE alone
         a. In Exp-41, the AEPE's MRD=4.20E+00 g/m² at pH=9.38 and at a PCD of 4.20E+00 g/m².
         2. Bnt-E alone
         a. In Exp-60, the Bnt-E's MRD=5.92E−04 g/m² when its PCD=2.44 g/m2. The bentonite was gravity separated and concentrated with vacuum distillation.
         3. Bnt-E and Bioterge AS-40
         a. In Exp-58, under the Bnt-E-to-AS-40 ratio=1 condition, the AS-40's MRD=6.35E−02 g/m2 when its PCD=1.07 g/m2, and the Bnt-E's MRD=6.35E−02 g/m2 when its PCD=1.07 g/m2.
         4. Bnt-E and Y2
         a. In Exp-59, under the Bnt-E-to-Y2 ratio=1 condition, the Y2's MRD=9.50E−03 g/m2 when its PCD=1.22 g/m2, and the Bnt-E's MRD=9.50E−03 g/m2 when its PCD=1.22 g/m2.
         5. Y2 alone
         a. In Exp-60, MRD of Y2's MDR=9.54E−03 g/m² when its PCD=2.48 g/m2.
2. Multi opening process
   a. Three-layer mat
      i. In Exp-04, the unseparated Bnt(a) was mixed with the Y2 pseudo component. The Bnt-to-Y2 ratio=0.5. The release was observed at 4.20E−01 g/m² total solid dose.
   b. Full mat
      i. In Exp-29, the centrifuge separated Bnt-E's MRD>1.11 g/m², under the condition of Bnt-to-SHMP ratio=6.77.
      ii. In Exp-29, the centrifuge separated Bnt-E's MRD≥1.68E−1 g/m².
      iii. In Exp-30, the centrifuge separated Bnt-D's MRD>1.06 g/m² under the condition of Bnt-to-Y2 ratio 1 and at no preconditioning.
      iv. In Exp-31, the centrifuge separated Bnt-D's MRD≥7.4 g/m² under Bnt-to-Y2 ratio 1 and at no preconditioning.
      v. In Exp-31, the Y2's MRDs≤1.36E+1, at no preconditioning
   c. 75% mat
      i. Gravity separated Bnt-E concentrated with the rotavapor
         1. In Exp-45, under the condition of Bnt-to-Y2 ratio=0.273, the bentonite's MRD=1.598E−01 g/m², when its PCD is 3.119 g/m²; while the Y2's MRD=5.903E−01 g/m², when its PCD is 9.523 g/m². And at the total active PCD of 1.21E+01.
         2. In Exp-48, under the condition of Bnt-to-Y2 ratio=0.273, the bentonite's MRD=3.493E−01 g/m², when its PCD is 2.663 g/m²; while the Y2's MRD=1.291 g/m², when its PCD is 9.838 g/m². The total active PCD is 1.25E+01.
         3. In Exp-55, the Bentonite's MRD>2.92 g/m² at a 3.02 g/m² preconditioning
         4. In Exp-50, under the condition of Bnt-to-AS-40 ratio 0.27, the bentonite's MRD>2.35E+00 g/m2
         5. In Exp-54, under the condition of Bnt-to-AS-40 ratio 0.18, the AS-40's MRD=4.53E−01 g/m² when the PCD of AS-40 is 1.80E+01*0.85=1.53E+01 g/m².
      ii. Y2 alone
         1. In Exp-46 the Y2's MRD=4.93E+00 g/m² at a PCD of 1.01E+01 g/m².
         2. In Exp-47 the Y2's MRD=1.50E+00 g/m² at a PCD of 1.32E+01 g/m².
      iii. Bioterge AS-40 alone
         1. In Exp-51 the AS-40's MRD>1.07E+01 g/m2 when its PCD is 1.07E+01 g/m².
         2. In Exp-53 the AS-40's MRD>9.49 g/m2 when its PCD is 1.01E+01 g/m².
         3. In Exp-52 the AS-40's MRD=1.90E+01 g/m2 when its PCD is 3.85E+01 g/m2.
      iv. Y1 pseudo component alone
         1. In Exp-05, the Y1 pseudo component's MRD=2.80E−01 g/m² when no preconditioning was applied and the additive was sprayed on the MS plate.

### Conclusions A: Sample Preparation, Testing, and Evaluating Methodologies

### A-1. The Influence of Mat Thickness on the Performance Rating

Our “three-layer mat” protocol resulted in a starkly different outcome than the “full-mat” approach used by some commercial testing facilities and the industry: full stick versus full release. For instance, no release was observed when some nanomaterials' MRD, determined on the full-mat, was applied on the three-layer mat. And even a three-times higher dose could not release the three-layer mat. This difference could be explained by the steam pressure's contribution to the hot press's total pressure. Steam is generated because of the wood moisture.

Chemical reactions also produce some CO₂. The mat pressure and the steam/CO₂ pressures counterbalance the press pressure. Therefore, the mat-steel contact pressure/tension is lower at higher moisture/steam content leading to an easier separation at higher steam content. In addition, the pressure of the steam and hot gases entrapped in the mat are trying to escape. The blown-out steam makes the mat-steel separation easier when we open the press, resulting in a better releasing additive rating. Overall, it is easier to release a thicker mat because of its higher steam/CO₂ contribution to the total pressure. One also should consider that we inserted an 11 mm thick OSB panel below the three-layer during pressing. There is no added moisture in this supporting panel and no CO₂ production. This added layer operates as a steam/CO₂ sink, reducing the three-layer mat's already low steam/CO₂ counter-pressure, which leads to unrealistic matt-metal contact pressures.

### A-2. The Influence of Mat Size on the Performance Rating

The steam issue discussed in the A-1 paragraph could also explain the performance differences between our press and either a larger testing press or the full-size plant's press. The mat's edge is the only escape path for the steam when the press is closed. We should realize that the mat's surface-to-edge ratio is proportional to the lateral size of the mat, and the higher this ratio is, the more steam is entrapped, and the better the release rating is. Hence, we could expect the highest performance rating in the plant process, followed by the rating measured in the smaller size testing presses, as long as the mat thicknesses are the same in these processes. Indeed, this prediction is confirmed by the fact that the performance rating of some nanoadditive was about four folds better at the larger InnoTech's testing press than in our laboratory.

### A-3. The Moisture Content of the Wood Chips

Because of the role of steam detailed in the previous two paragraphs, we standardized the wood's moisture content.

### A-4. Water Spraying on the Mat

It follows from all the above that the water spraying on the three-layer mat before compressing, which is introduced in some plat processes, could enhance the apparent release performance of an additive.

### A-5. Minimum Release Dose (MRD), Minimum Sustainable Release Dose (MSRD), and Sustainable Release Dose (SRD)

We determine the MRD by repeatedly halving the additive concentrations (after the preconditioning step) until the mat sticks to the steel. Then, we report the latest release dose as the MRD. This MRD is usually lower than any of the SRDs, i.e. the concentration at which full release can still be observed after any number of repeating. In practice, we used ten repeats for the SRD determination. Among the different SRDs, the lowest one is the MSRD

### A-6. Cold-Plate Versus Hot-Plate Spraying for Testing the Continuous Process

Aqueous droplets sprayed on a hot metal surface would bounce because the developing steam layer keeps the liquid separated from the metal. This phenomenon has two consequences for additive testing. First, not all the delivered liquid stays on the metal surface, which leads to a surface dose reduction. Second, the non-volatile additive is not distributed evenly on the surface because it is gradually concentrated within the evaporating water drops. These drops slowly lose their volatile content, and finally, they deposit their non-volatile load in some distinct spots.

When we test additives for the continuous process, we can either spray the aqueous additive on the hot metal plate to simulate the plant process or spay the additive on a lower temperature plate, where the liquid could spread on the metal instead of bouncing and evaporate it slowly by increasing the plate temperature to see the effect of additive separately from the above-described bouncing phenomenon. We used both alternatives because the temperature of the SS belt at the point where the spray hits its surface could be different in different manufacturing arrangements, which could lead to either bouncing or spreading. Hence, the same additive could perform differently in different plants.

### A-7. Identifying Synergism and Pointing Out Business Benefits

We look for synergetic interactions among components when the MRD or the MSRD is used for characterizing the additive's performance. We consider a two-component mixture for simplicity, but the conclusions can be extended to multicomponent cases.

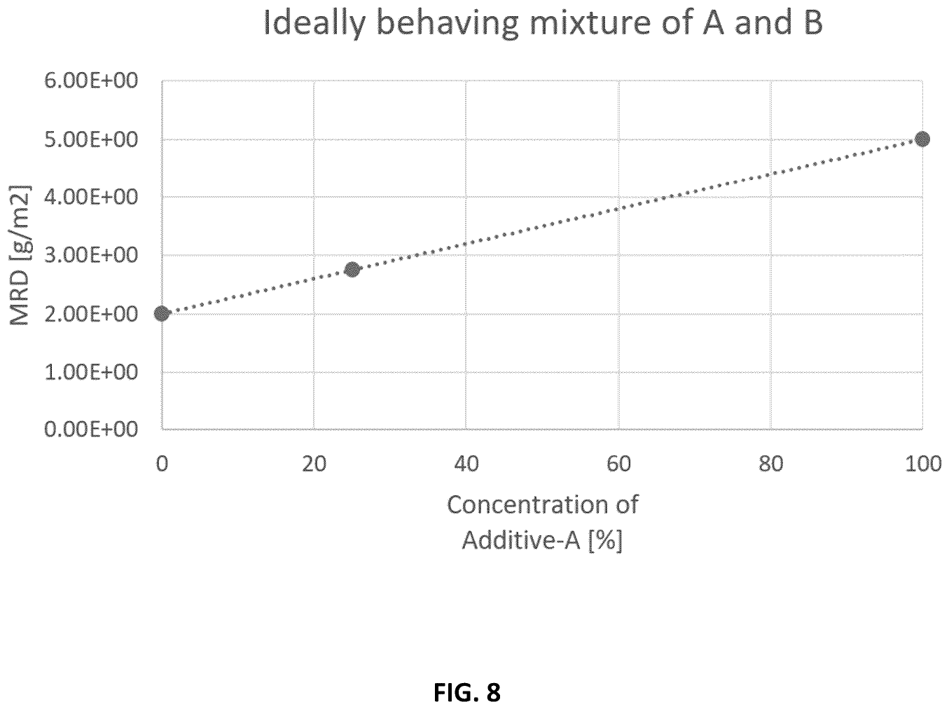

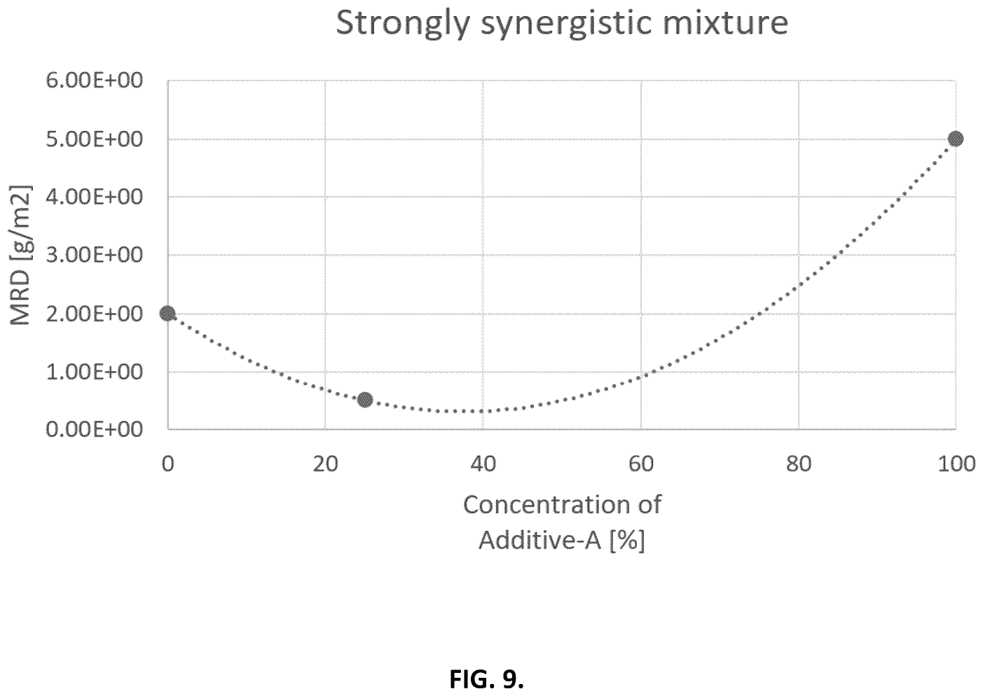

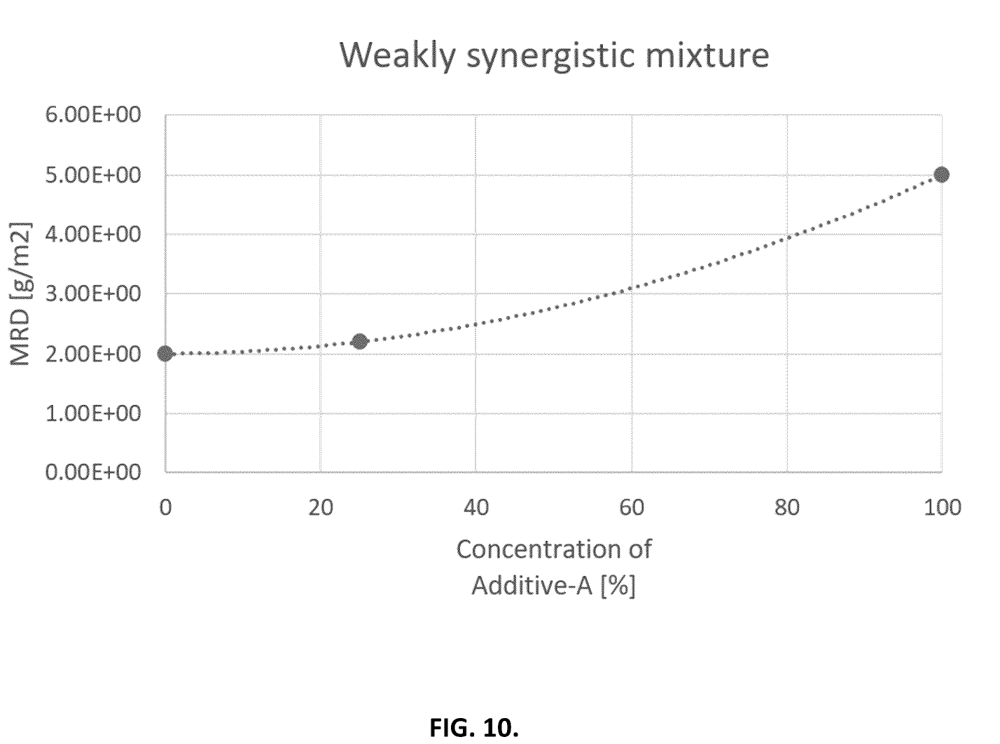

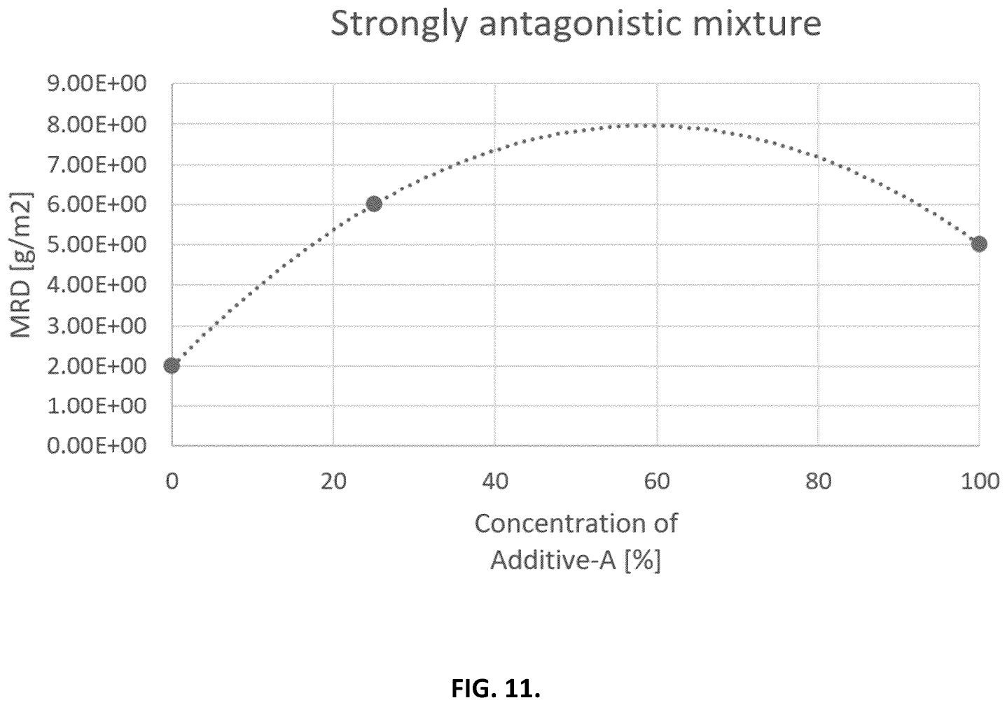

In, FIG. 8., the MRDs of additive A, B, and A&B are presented for the case when A and B behave ideally from the perspective of release. When the concentration of additive A is zero, the corresponding ordinate value represents the MRD of Additive B. In this case, the MRDs of A and B mixtures are situated on a straight line connecting the MRD of 100% A and the MRD of 100% B components. In FIG. 9 and FIG. 10, a strongly and weakly convex function represent the MRDs of the mixtures, respectively. At the same time, it is a concave function in FIG. 11. Because a lower MRD is beneficial, the convex function describes a synergistic, and the concave describes an antagonistic interaction.

Furthermore, the additive cost is also considered for business purposes. By multiplying the MRD functions with the cost vs. composition function, one could get the cost. Therefore, even a weak synergism might have a business benefit when the cost is accounted for.

Only the MSRD is independent of the PCD, which can only be determined by a series of trials and error experiments. Unfortunately, the MRD, which we could measure with significantly fewer efforts, depends on the PCD. Hence, during the above-described synergy experiments, the total PCD should be kept constant for additives A, B, and the A&B mixture to make correct comparisons. Unfortunately, this is not always feasible. For instance, there could be cases when additive B has no MRD or its MRD is so high that it would demand increased volume spraying, which increases the wood's moisture content. This elevated moisture jeopardizes the results' comparability with the lower moisture content cases. Also, there are cases when there is a significant price difference between the additives. When additive B's price is negligible compared to additive A's price, we are only interested in the degree of MRD reduction of additive A due to the presence of additive B. We do not measure the MRD of additive B and use the convex-concave plots for these two cases. Instead, we precondition with a pre-determined A-to-B ratio of the A&B mixture and measure the MRD of the said mixture. Then we judge the effect of additive B on the performance of additive A by comparing the compositionally proportional MRD value of additive A in the mix with the MRD of additive A alone. For instance, when we use additives A and B in a 1:1 ratio and obtain 10 g/m² for the MRD of the mixture, then the MRD of additive A is 5 g/m² under the condition of additive A-to-B ratio=1. In the next step, we measure the MRD of additive A in the absence of additive B. Suppose additive A's MRD in the mixture is lower than its MRD alone. In that case, there is a beneficial interaction between the two additives. Of course, the PCD of additive A must be the same or similar in both experiments. For instance, when the total PCD is 20 g/m² for the mixture of the previous example, then the PCD must be 10 g/m² for the single additive A. Conclusions B: Continuous process testing results

### B-1. The Effect of the Mat Thickness

One could compare the efficiency of a releasing additive at different mat thicknesses by comparing the results of 1.b.vi.3., 1.c.i.1., and 1.d.i.1. The performance of the additive was almost identical at 100% (110 g) and 75% (80 g) mat thickness, indicating that the release performance does not depend strongly on the thickness in this range. In comparison, it was significantly different at 25% mat. Hence, we performed most of our tests with the 75% mat after the preliminary experiments.

By comparing 1.e.i.1.a. with 1.b.iv.1. one could conclude that MRD is lower with full mat than with three-layer mat, which agrees with the arguments presented in Conclusion A-1. In addition, the three-layer mat results cannot be correctly compared with the rest of the tests because an OSB panel supported the layers from below in our experiments. This added panel is not part of the resinated wood layer. It operates as a steam and CO₂ sink (see more details in Conclusion A-2). Hence, the three-layer mat results cannot be compared with the outcomes of the test performed with other mat thicknesses.

### B-2. The Effect of PCD on the MRD

The lower the PCD, the higher the corresponding MRD because the MRD value is related to the additive's surface dose. And this latter is the combined outcome of the preconditioning and subsequent spraying steps; see 1.b.i.1. This relationship even includes the boundary case of zero preconditioning; compare 1.b.vi.2. with 1.b.vi.3.

### B-3. The Effect of pH in the Absence of Bentonite

When we used an aqueous NaOH solution alone, we observed release when its pH=11.58 or its pH>11.58, see 1.b.viii.1. Which is in line with a discourse in the open literature (Influence of Acids and Bases on Preparation of Urethane Polymers, Ind. Eng. Chem. 1959, 51, 8, 929-934), stating that at elevated pH, “ . . . branching reaction occurs much more readily, and higher viscosity or even prepolymer gelation occurs.” Hence, we are seeking formulations as releasing agents in the alkaline range.

### B-4. The Performance of Nano Additives

We used a high specific surface hydroxyapatite nanomaterial to investigate the influence of surface chemistry on the release. We could not observe release at a dose as high as 3.98 g/m² when PS-5 was used as a stabilizing agent, c.f., 1.b.xii.1. Hence, the surface chemistry of the nanomaterial is also responsible for release in addition to the high specific surface.

### B-5. The Performance of Sodium Bentonite and Calcium Bentonite

In agreement with our working hypothesis, sodium bentonites are expected to perform better than calcium bentonites because of their higher dispersibility and specific surface. Observations in 1.a.i.1 support this expectation where either no release was observed with the Bnt-A or the MRD was extremely high. The said observation is also supported by comparing “normal” bentonite, 1.b.ii.1., with the different sodium bentonites described in points 1.b.i., 1.b.iii., 1.b.iv., 1.b.v., and 1.b.vi. The sodium forms have significantly better performance, i.e., lower MRDs. Therefore, we performed most of the tests with sodium bentonites.

### B-6. Performances of Unseparated, Gravity Separated, or Centrifuge Separated Bentonites

By comparing 1.b.iii.4 and 1.b.v.1. we could deduce that the impurity removal increases the performance (decreases the MRD) of bentonites when we simultaneously consider the conclusion of the B-2 paragraph.

### B-7. The Influence of the Degree of Bentonite Separation on its Releasing Performance

Although the PCDs were different, one still could conclude that the higher separation efficiency (i.e., centrifugal separation, 1.b.iii.3.) leads to better releasing performance (i.e., lower MRD) than a lower separation efficiency (i.e., gravity separation, 1.b.iv.1), when the arguments on the effect of the PCD on the MRD (see conclusion B-2) is also considered.

B-8. The Effect of H₃PO₄ Acid and NaOH Base on the Bentonite's Releasing Performance

At the same PCD=2.4E+00 g/m², the unadulterated (not titrated) bentonite suspension had a significantly better performance (MRD=9.69E−03 g/m²; c.f., 1.b.vi.2) than the titrated bentonites of either higher or lower pH than the original one, c.f., 1.b.vii.1.

### B-9. The Effect of SHMP on Bentonite's Releasing Performance

It is a business interest to develop high concentration bentonite formulations and remove bentonite contaminants from these suspensions by sedimentation-however, the high viscosities of these suspensions hider the efficiency of the sedimentation separation. Therefore, we screened for viscosity-altering additives and disclosed the outcomes in Appendix C. We identified SHMP as one of the excellent viscosity-reducing additives. Therefore, we inspected its effect on release properties when we utilize SHMP in the suspension manufacturing process.

The releasing performance of unseparated bentonite decreases when the Bnt-to-SHMP ratio is increased from 0.07 to 0.29, c.f., 1.b.v.2. However, we have some reservations about this conclusion because of the low reproducibility of experiments with unseparated bentonites.

The centrifuge-separated sodium bentonite shows sustainable release at 1.17E−1 g/m² Bnt dose when the Bnt-to-SHMP ratio=0.733 and 4.9E−1 g/m² preconditioning is applied (see 1.b.iii.5.). However, the Bnt could not release at a higher Bnt dose when the Bnt-to-SHMP ratio was lower, i.e., 0.2, and there was no preconditioning, see 1.b.iii.4. Hence, both the preconditioning and Bnt-to-SHMP ratio influence the outcome.

SHMP addition alters negligibly the bentonite's (which was first centrifuge-separated and then vacuum concentrated) MRD when the Bnt-to SHMP ratio is high. C.f., 1.c.ii.1. and 1.c.ii.2.

B-10. The Effect of NaH₂PO₄ on Bentonite's Releasing Performance in the Continuous Process

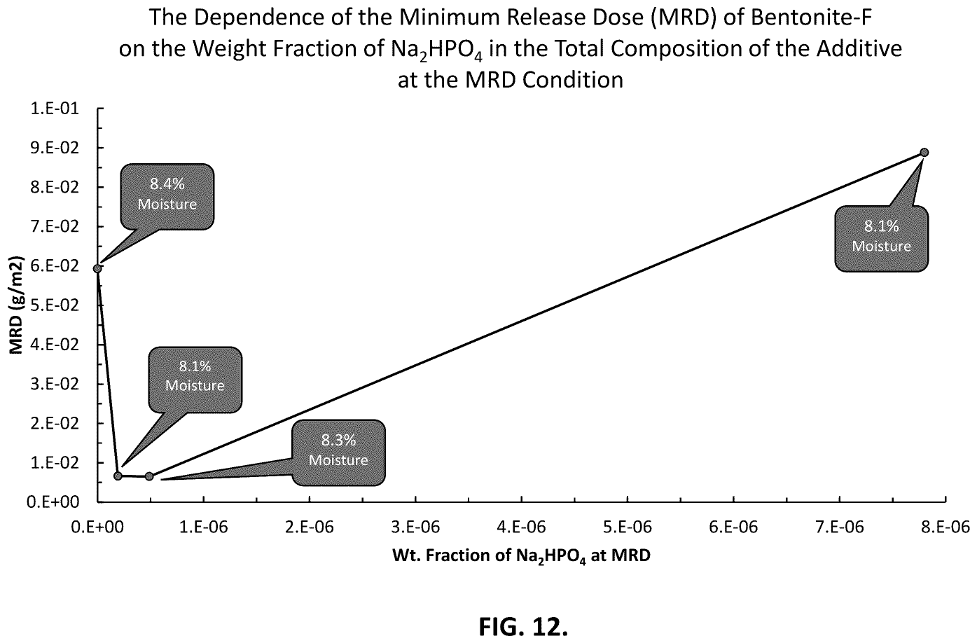

We tested the MRDs at different Bnt-to-NaH₂PO₄ wt. ratios to find the optimum composition (e.g., Experiment 74), and concluded that the optimum is about at the 100:1 ratio. We used RO water for diluting. Therefore, one should prepare bentonite releasing suspension at this ratio. See FIG. 12 in which we also report the moisture content of the wood B-11.

### The Effect of AEPE on the Bentonite's Releasing Performance

Comparing 1.b.vii.2 with 1.b.vi.2. we conclude that AEPE has no measurable effect on the releasing property of bentonite. The significantly higher bentonite's performance might mask the AEPE's possibly small effect.

### B-12. The Effect of Bentonite on the Releasing Performance of AEPE

Comparing 1.f.ii.1.a. with 1.b.vii.2 we can realise a minimum of 400 folds reduced AEPE's MRD at the Bnt-to-AEPE ratio=1 condition. The 400-fold is an underestimation because the PCD was higher in the AEPE-alone experiment than that of the mixed case. Hence, if we consider that “the lower the PCD, the higher the corresponding MRD (c. f., B-2),” we must conclude that the actual MRD reduction must be higher than 400 folds.

### B-13. The Effect of Bentonite on the Releasing Performance of Y2

Comparing 1.f.ii.4.a. with 1.f.ii.5.a. we can conclude that in the presence of bentonite co-additive, the Y2's MRD remains the same even though its PCD was decreased by 50% as compared to the blank. Hence, bentonite and Y2 have a synergistic interaction in the continuous process (c. f., B-2).

### B-14. The Effect of Bentonite on the Releasing Performance of Bioterge AS-40

Bentonite addition enhances the AS-40 releasing agent's performance. At a 0.18 Bnt-to-AS-40 ratio we observes a forty folds performance improvement of AS-40, c.f., 2.c.i.5. and 2.c.iii.3..

### B-15. This Section was Left Empty Intentionally.

### B-16. The Bouncing Droplet Phenomenon on Hot Plates.

We observed that surfactant-containing aqueous droplets bounce on the hot metal surface; see Exp-30, Exp-32, Exp-36, and Exp-41 in Appendix A. This phenomenon can be explained as follows. The hot metal plate induces vapour release from the droplets. These vapours escape at a high rate and create an elevated pressure zone between the metal and the droplet surfaces. This pressure counterbalances the droplet's weight, which moves erratically over the hot metal surface like an air-cushioned boat on the water's surface. When an additive is sprayed on the hot SS belt during the continuous process in the wood panel factory, this phenomenon leads to two industrially relevant issues as follows. (i) Part of the sprayed additive could not coat the metal surface because the droplets run away from the belt, especially when the surface is not horizontal, which is the case in most industrial belt-spraying systems. Hence, there is an additive loss which reduces the overall performance. (ii) The droplets that stay on the surface gradually lose their water content and become concentrated. Once the water content diminishes, these concentrated additive drops settle in distinct spots on the metal surface. Hence, the meatal is not coated homogeneously, leading to performance loss.

We could not observe the above-described phenomenon when we sprayed bentonite suspensions on an SS plate of 220 C. Hence bentonite additives are superior to surfactant solutions from this perspective.

When bentonite is used as a co-additive in surfactant formulations, there are cases when bouncing is still observable, see Exp-30, Exp-58, and Exp-59. But there are cases when bentonite suppresses the bouncing of surfactant-loaded droplets; see Exp-35 and Exp-21.

At similar PCRs, the bentonite's MRD was four times higher when the additive was spayed on a “hot plate” than its MRD on a “cold plate,” c.f., 1.c.ii.1. and 1.f.ii.2. This higher value indicates that some other process hinders additive efficiency at the “hot plate” method besides the bouncing. It is probably associated with the more homogeneous and more organized settling of the bentonite plate particles on the metal surface during the cold placement, which includes gradual evaporation of the water and leads to a better separation of the metal from the wood.

B-17 The effect of wood moisture on the sustainable release dose of Bnt-F at a constant 100:1 Bnt/NaH₂PO₄ wt ratio.

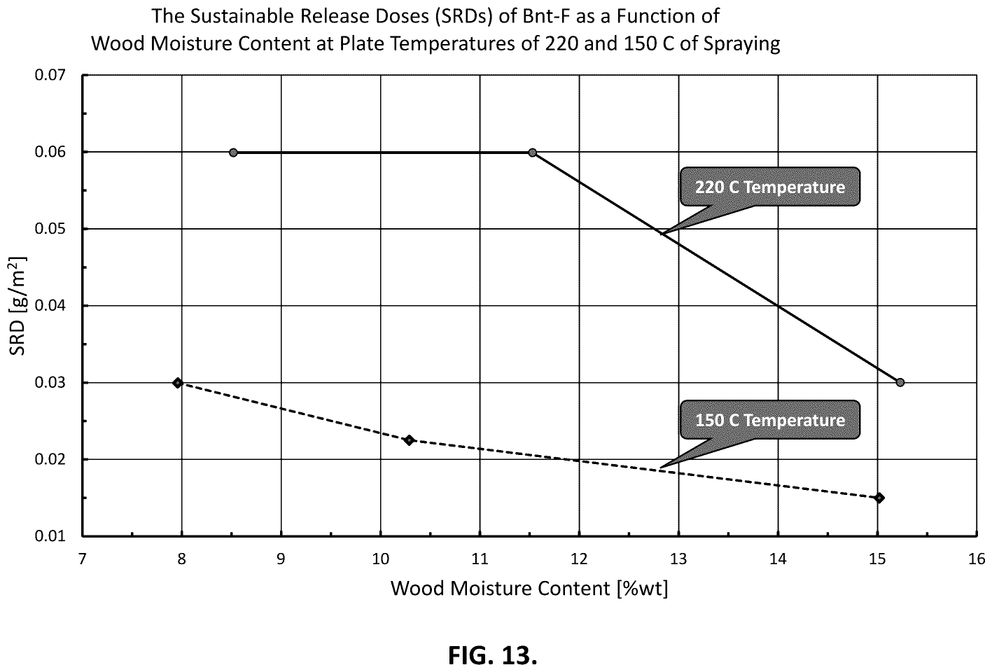

We utilized the MRDs to compare the effects of different conditions and compositions on the formulations' release performance. However, it is the SRD, and ultimately the MSRD, that gives us an industrially relevant pieces of information. In theory, the SRD and the MSRD are independent of the PCD; however, we cannot repeat in practice the release experiments at an infinite number at a given SRD to eliminate, for instance, the effect of a too-highly selected PCD. Therefore, we need to start with a low enough PCD to reduce the number of releasing tests. Hence, for the Bnt-F sample at its optimum Bnt-to-NaH2PO4 ratio, where an extremely low MSRD is expected, we introduced a more aggressive PCD protocol as follows. We used the same dose for PCD as the intended SRD, and we accepted the outcome of a series of release tests as valid PCD when we could see releases at least ten consecutive times. The SRDs serve as upper limits for the MSRD. The latter is the SRD with the lowest concentration. Hence, obtaining the MSRD is a laborious process. In FIG. 13, we present the SRD of Bnt-F at 100:1 Bnt-to-NaH2PO4 ratio as a function of wood moisture when the release agent is sprayed on the hot thick SS plate at 150 C and 220 C temperatures. In line with some earlier observations, the release performance improves (i.e., the SRD decreases) at higher moisture. Also, the lower the spray temperature, the better the performance because the Bnt becomes less dehydrated at lower temperatures. Hence, we have the following option to improve the bentonite-containing additives' performance in the continuous process: (i) adding some humectants to bentonite formulations, (ii) repositioning the spray bar to a lower temperature region of the SS belt, (iii) reducing the drying time of the bentonite coating on the belt before it contacts the wood chips., (iv) increasing the moisture content of the wood (especially suitable for multi-layer panels), which comes into contact with the bentonite layer.

B-18 Generalized Conclusion of Experiments with Bentonite

We documented with many experiments that bentonite clay suspensions are incredibly efficient as wood panel releasing agents in the continuous or the multi-opening panel manufacturing process. The needed minimum release dose (MRD) [weight/area] of neat bentonite was lower than the dose of any chemical additives tested for the continuous process. In the multi-opening process, bentonite suspensions were used as part of the chemical releasing agent formulation to reduce the amount of the needed chemicals. This reduction resulted from some synergism we discovered. There are synergistic interactions between bentonite clays and some chemical additives, including an alpha-olefin sulfonate, AEPE, and different chemical cocktails containing an alpha-olefin sulfonate AEPE and a non-ethoxylated organophosphate surfactant.

### Conclusion-C: Multi-Opening Process Testing Results

### C-1. Aqueous Bentonite Suspensions in the Absence of Other Additives

No release was observed within the investigated limited concentration range. The maximum suspension concentration we could investigate is limited by the capability of the sprayer that could not spray high viscosity liquids. (c.f., 2.b.ii. for the full mat and 2.c.i.3. for the 75% mat).

### C-2. The Synergy Between Bentonite and Y2

Bentonite addition enhances the Y2 releasing agent's performance. We observed a three to eight folds performance improvement when replacing 20% of the surfactant mixture with bentonite. Compare 2.c.i.1. and 2.c.i.2. with 2.c.ii.1. This improvement range is an underestimation because the PCD in the Y2-alone experiment was higher than that of the mixed case. Hence, considering that “the lower the PCD, the higher the corresponding MRD” conclusion of the B-2 paragraph, we should conclude that the actual MRD reduction must be higher than three to eight folds.

Y2 addition increases bentonite's releasing performance. When we compare 2.c.i.1. and 2.c.i.3. we can see that bentonite's MRD is improved by at least 18 folds considering “the lower the PCD, the higher the corresponding MRD” conclusion of the B-2 paragraph.

### C-3. The Synergy Between Bentonite and Bioterge AS-40

Bentonite addition enhances the AS-40 releasing agent's performance. At a 0.18 Bnt-to-AS-40 ratio we observes a forty folds performance improvement of AS-40, c.f., 2.c.i.5. and 2.c.iii.3. This improvement range is an underestimation because the PCD in the AS-40 alone experiment was higher than that of the mixed case. Hence, if we consider that “the lower the PCD, the higher the corresponding MRD” conclusion of the B-2 paragraph, we should conclude that the actual MRD reduction must be higher than 40 folds.

### APPENDIX

### Appendix A. Detailed Observations on Release Properties

### Experiment 01. P79 (Additive: 6.6% Aqueous Bnt-A Suspension) 2021 Apr. 22

This experiment aims to run a preliminary test of the unseparated bentonite suspension as a releasing agent for the multi-opening press.

First, the Bnt-A sample was prepared without removal of the heavier fraction (i.e., no cleaning procedure). Hence, the concentration was simply measured by calculating the weight of Bnt-A powder added to RO water. The aspen strands were not moisture controlled (moisture range: 5-10%), and it was treated with Rubinate FC 3390 pMDI. The treated aspen wood strands were used to build the ‘three-layered form.’ The MS plates used in the test were cleaned via the ‘regular cleaning method,’ The additive was sprayed onto a clean and cold MS plate, following the ‘cold plate method (A).’ A New MS plate was used in every test; hence, no preconditioning was done. The ‘Manual Pressing Procedure’ was followed, and the release property of bentonite was examined.

When the additive was sprayed onto the MS plate and heated to 110° C. temperatures, all the water evaporated, and the dried bentonite layer and light brown spots were formed on the MS plate. The clean release was not observed when 2.95 g/m² of additives were sprayed onto the MS plate. The shearing release force was measured to be 526.9 N using a force gauge. The MS plate had more than five sm piks attached, and some of the dried bentonite layers were transferred onto the wood panel. Another clean release was observed when 5.90 g/m² of additives were sprayed onto the MS plate. There were no piks observed, and some of the dried bentonite layers were also transferred onto the wood panel.

TABLE 1
Experiment 01 Release Result.

| | | | | Shearing | |
|---|---|---|---|---|---|
| | | Wt. | Application | Release | |
| Press | % Total Active | Additive | dose | Force | |
| # | Concentration | (g) | (g/m²) | (N) | Piks |
| 1 | 6.58E+00 | 1.5 | 2.95E+00 | 526.9 | >5 sm |
| 2 | 6.58E+00 | 3.0 | 5.90E+00 | 0 | N/A |

In conclusion, this experiment showed that Bnt-A does have some release properties when a high dosage is applied. Also, it is found that the cold plate method is not appropriate to test this additive. The dried bentonite layer and brown spots were formed on the MS plate upon drying. After pressing, some of the dried bentonite layers were transferred onto the wood panel.

### Experiment 02. P79 (Additive: 5% Aqueous Bnt-A Suspension) 2021 Apr. 26

This experiment aims to confirm that bentonite suspension shows releasing properties in the multi-opening press and replicates the test done in Exp-01.

First, the Bnt (A) sample was prepared without the removal of the heavier fraction (i.e., no cleaning). Hence, the concentration was simply measured by calculating the weight of Bnt(A) powder added to RO water. The aspen strands were not moisture controlled (moisture range: 5-10%), and it was treated with Rubinate FC 3390 pMDI. The treated aspen wood strands were used to build the ‘three-layered form.’ The MS plates used in the test were cleaned via the ‘regular cleaning method,’ and the additive was sprayed using three different spray methods. On press 1, the cold plate method (A) was used. After spraying the additive on the MS plate, 1.5 g of water was spread onto the wood form before pressing. On Press 2, 3, and 4, the additives were sprayed onto the wood form without additional water spray, following the multi-opening press method. On press 5, 6, and 7, the cold plate method (A) was used to replicate the Exp-01 result. During the spray period, pre-treatment was not applied. The ‘Manual Pressing Procedure’ was followed, and the release property of bentonite was examined.

The result shows no clean release even when higher than 15.0 g/m² were applied. Also, when the same application rate of 5.90 g/m² as Exp-01 was applied, it did not show release, which is controversial to the Exp-01 result. Out of the three spray methods used, the multi-opening press method (press 2,3,4) showed the highest releasing force and medium to large size strands were stuck to the plate, which could mean that bentonite might not release when tested for the multi-opening press.

TABLE 2
Experiment 02 Release Result.

| | | Wt. | Application | Release | |
|---|---|---|---|---|---|
| Press | % Total Active | Additive | dose | Force | |
| # | Concentration | (g) | (g/m²) | (N) | Note |
| 1 | 5.00E+00 | 4.2 | 6.28E+00 | 170.1 | N/A |
| 2 | 5.00E+00 | 8 | 1.20E+01 | 720.3 | 3 md, 1 sm |
| 3 | 5.00E+00 | 10 | 1.50E+01 | >740 | 3 lg, 1 md |
| 4 | 5.00E+00 | 6 | 8.97E+00 | >740 | Many |
| | | | | | strands stuck |
| 5 | 5.00E+00 | 5 | 7.47E+00 | 293.1 | N/A |
| 6 | 6.58E+00 | 3 | 5.90E+00 | 232.1 | N/A |
| 7 | 6.58E+00 | 3 | 5.90E+00 | 331.6 | N/A |

In conclusion, the Exp-01 result could not be replicated. Also, it provided an insight into the release performance of bentonite in the multi-opening press.

### Experiment 03. P79 (Additive: 6.6% Aqueous Bnt-A Suspension) 2021 Apr. 28

The objective of this experiment is to replicate the Exp-01 result and confirm the release properties of Bnt-A suspension for the multi-opening press.

First, the Bnt-A sample was prepared without gravity separation or removal of the heavier fraction. Hence, the concentration was measured by calculating the weight of Bnt-A powder added to RO water. The aspen strands were not moisture controlled (moisture range: 5-10%), and it was treated with Rubinate FC 3390 pMDI. The treated aspen wood strands were used to build the ‘three-layered form.’ The MS plates used in the test were cleaned via the ‘regular cleaning method,’ The additive was sprayed onto a clean and cold MS plate, following the ‘cold plate method (A).’ A New MS plate was used in every test; hence, no preconditioning was done. The ‘Manual Pressing Procedure’ was followed, and the release property of bentonite was examined.

There was no clean release observed, and the shearing forces measured using the force gauge were high as all exceeded 700 N. There were no piks and strands attached to the MS plate. (Table 3)

TABLE 3
Experiment 03 Release Result.

| | | Wt. | Application | Release | |
|---|---|---|---|---|---|
| Press | % Total Active | Additive | dose | Force | |
| # | Concentration | (g) | (g/m²) | (N) | Note |
| 1 | 6.58E+00 | 3 | 5.90E+00 | 715.4 | N/A |
| 2 | 6.58E+00 | 6.2 | 1.22E+01 | >740 | N/A |
| 3 | 6.58E+00 | 10.2 | 2.01E+01 | 734.7 | N/A |

In conclusion, all three experiments (EXP 01, 02, and 03) suggested that the releasing property of sodium bentonite might be time-dependent since the release properties progressively got worse and required higher force to remove the wood panel from the MS plate over time.

### Experiment 04. P83 (Additive: 5% Bnt-A with 10% Y1 Suspension) 2021 Apr. 30

The objective of this experiment is to see the release performance of Bnt-A suspended in Y1 for the multi-opening press.

First, the Bnt-A sample was prepared without removing the heavier fraction (i.e., no cleaning procedure). Hence, the concentration was simply measured by calculating the weight of Bnt-A powder added to RO water. The stock solution of additive was further diluted with RO water to achieve the concentration noted below. The aspen strands were not moisture controlled (moisture range: 5-10%), and it was treated with Luprinate M20 pMDI. The treated aspen wood strands were used to build the ‘three-layered form.’ The MS plates used in the test were cleaned via the ‘regular cleaning method,’ The additive was sprayed onto a clean and cold MS plate, following the ‘cold plate method (A).’ A New MS plate was used in every test; hence, no preconditioning was done. The ‘Manual Pressing Procedure’ was followed, and the release property of bentonite was examined.

The result shows that the release can be observed when more than 4.20E−01 g/m² is applied. There were some piks observed when lower application doses of 5.28E−02 g/m² and 2.15E−01 g/m² were applied, and releases were not observed. The releases might be observed due to Y1, as Y1 showed releases previously.

TABLE 4
Experiment 04 Release Result.

| | | | | Wt. | Application | Release | |
|---|---|---|---|---|---|---|---|
| Press | | | % Total Active | Additve | dose | Force | |
| # | % Y1 | % Bnt-A | Concentration | (g) | (g/m²) | (N) | piks |
| 1 | 7.80E−02 | 3.90E−02 | 1.17E−01 | 1.5 | 5.38E−02 | Stuck | >10 sm |
| 2 | 3.16E−01 | 1.58E−01 | 4.74E−01 | 1.5 | 2.15E−01 | 95.2 | 1 sm |
| 3 | 6.30E−01 | 3.15E−01 | 9.45E−01 | 1.5 | 4.20E−01 | 0 | N/A |
| 4 | 1.25E+00 | 6.25E−01 | 1.88E+00 | 1.5 | 8.40E−01 | 0 | N/A |

The Bnt-A to Y1 ratio is 0.5. The ratio of Bnt-A to total additive is 0.33, and the ratio of Y1 to total additive is 0.67. In conclusion, the release was observed when greater than 4.20E−01 g/m² of total additive was applied onto the MS plate.

### Experiment 05. Y1 (Additive: 10% Y1 Solution) 2021 May 4

This experiment aims to measure the MRD of Y1 to compare the release performance with bentonite suspensions for the multi-opening press.

First, the Y1 sample was prepared by diluting with RO water from its stock solution, which was 35% active. The aspen strands were not moisture controlled (moisture range: 5-10%), and it was treated with Luprinate M20 pMDI. The treated aspen wood strands were used to build the ‘three-layered form.’ The MS plates used in the test were cleaned via the ‘regular cleaning method,’ and the additive was sprayed onto a clean and cold MS plate, following the ‘cold plate method (A).’ A New MS plate was used in every test; hence, no preconditioning was done. Following the ‘Manual Pressing Procedure,’ the reference test for the multi-opening press was done.

As Y1 already had been tested for release before, it was assumed to show a clean release from 10% to 1.25%. Therefore, the test started by applying 1.5 g of 0.625%. Preconditioning was not applied.

The MRD of Y1 is measured to be 2.80E−01 g/m². The shearing forces were measured when 0lower concentrations of additives were applied. Also, piks were observed when 7.00E−02 g/m² were sprayed. (Table 5) Different pMDI was used (Luprinate M20) in this experiment, but the releasing properties did not change significantly when Rubinate FC 3390 pMDI was used.

TABLE 5
Experiment 05 Release Result.

| | | Wt. | | Release | |
|---|---|---|---|---|---|
| Press | % Total Active | Additive | Application | Force | |
| # | Concentration | (g) | dose (g/m²) | (N) | piks |
| 1 | 6.25E−01 | 1.5 | 2.80E−01 | 0 | N/A |
| 2 | 3.12E−01 | 1.5 | 1.40E−01 | 57.1 | N/A |
| 3 | 1.56E−01 | 1.5 | 7.00E−02 | 171.9 | 1lg, |
| | | | | | 1md, >5 sm |
| 4 | 7.80E−02 | 1.5 | 3.55E−02 | stuck | many |

In conclusion, the MRD of Y1 is 2.80E−01 g/m².

### Experiment 06. This Section was Left Empty Intentionally. 2021 Jul. 29

### Experiment 07. P90 (Additive: 4% Aqueous Bnt-B Suspension) 2021 Aug. 16

The objective of the experiment is to see MRD of Bnt-B as release agents used for the continuous press.

First, the Bnt-B used in this experiment was prepared without removal of heavier fraction (i.e., no cleaning), and the concentration was measured by calculating the weight of Bnt-B powder added in RO water. The pH of the additive is 10.26. The moisture level of aspen strands was measured to be 10%, and it was treated with PM 200 pMDI. The treated aspen wood strands were used to build the full mat. The SS plate used in the test was polished, and the additive was sprayed onto a hot SS plate, following the ‘hot plate method.’ One SS plate was used for the test, and 1.16E+01 g/m² was applied onto the SS plate for pre-conditioning. The reference test for the continuous press was done by following the ‘Manual Pressing Procedure.’

The result showed that Bnt-B has a releasing property even at 6.46E−02 g/m². There were no strands attached to the SS plate. The dried bentonite layer was formed on the SS plate upon spraying, and it was transferred to the wood panel after being pressed. As the number of presses increased and lower concentration was applied, the dried bentonite layer started to fade, and a less dried bentonite layer was transferred to the wood panel.

TABLE 7
Experiment 07 Release Result.

| Press | % Total Active | Wt. Additive | Application | Release |
|---|---|---|---|---|
| # | Concentration | (g) | dose (g/m²) | Result |
| PC | 4.00E+00 | 9 | 1.16E+01 | N/A |
| 1 | 4.00E+00 | 3 | 3.86E+00 | 0 |
| 2 | 2.00E+00 | 3 | 1.93E+00 | 0 |
| 3 | 1.00E+00 | 3 | 9.69E−01 | 0 |
| 4 | 5.00E−01 | 3 | 4.84E−01 | 0 |
| 5 | 2.50E−01 | 3 | 2.37E−01 | 0 |
| 6 | 1.30E−01 | 3 | 1.18E−01 | 0 |
| 7 | 6.50E−02 | 3 | 6.46E−02 | 0 |
| 8 | 3.20E−02 | 3 | 3.23E−02 | Stuck |
| 9 | 3.20E−02 | 3 | 3.23E−02 | Stuck |
| 10 | 3.20E−02 | 3 | 3.23E−02 | Stuck |

In conclusion, Bnt-B shows releasing property when tested for Continuous process at MRD of 6.46E−02 g/m². The dried bentonite layer was formed on the SS plate, and some were transferred onto the wood panel.

### Experiment 08. P95B (Additive: 5% Aqueous Bnt-B Suspension) 2021 Aug. 18

This experiment aims to find the MRD of bentonite as release agents used for Continuous press.

First, the Bnt-B used in this experiment was prepared without removing heavier fractions (i.e., no cleaning). The powdered Bnt-B was slowly added to the RO water and stirred at 10,000 rpm. The homogeneous mixing was ensured by adding it slowly, moving the mechanical stirrer up and down, and increasing the speed to 15,000 rpm for a minute after adding all the powder. Hence, the concentration was simply measured by calculating the weight of Bnt-B powder added to RO water. The pH of the additive is 10.26. The moisture level of aspen strands was not controlled (range 7-10%), and it was treated with PM 200 pMDI. The treated aspen wood strands were used to build the full mat. The SS plate used in the test was polished, and the additive was sprayed onto a hot SS plate, following the ‘hot plate method.’ One SS plate was used for the test, and 1.26E+01 g/m² was applied onto the SS plate for pre-conditioning. The reference test for the continuous press was done by following the ‘Manual Pressing Procedure.’

The result shows that the MRD of bentonite(B) is 2.15E−03 g/m². When the sticking was observed at 1.40E−01 g/m² and 4.31 E−03 g/m², the release was tested two more times to ensure that it was still releasing. (Table 8) However, applying the additive three times at such application could have resulted in the build-up of additives on the SS plate, leading to more releases. The dried bentonite layer was formed after pre-conditioning, and some of the dried bentonite layers were transferred to the wood panel. Compared to the EXP 07, the release is observed at lower concentrations, possibly due to using higher PCD.

TABLE 8
Experiment 08 Release Result.

| Press | % Total Active | Wt. Additive | Application | Release |
|---|---|---|---|---|
| # | Concentration | (g) | dose (g/m²) | Result |
| PC | 5.00E+00 | 9 | 1.26E+01 | N/A |
| 1 | 5.00E+00 | 3 | 4.20E+00 | 0 |
| 2 | 2.50E+00 | 3 | 2.10E+00 | 0 |
| 3 | 1.25E+00 | 3 | 1.05E+00 | 0 |
| 4 | 6.50E−01 | 3 | 5.70E−01 | 0 |
| 5 | 3.38E−01 | 3 | 2.91E−01 | 0 |
| 6 | 1.69E−01 | 3 | 1.40E−01 | stuck |
| 7 | 1.69E−01 | 3 | 1.40E−01 | 0 |
| 8 | 1.69E−01 | 3 | 1.40E−01 | 0 |
| 9 | 8.40E−02 | 3 | 6.67E−02 | 0 |
| 10 | 4.20E−02 | 3 | 3.34E−02 | 0 |
| 11 | 2.10E−02 | 3 | 1.72E−02 | 0 |
| 12 | 1.00E−02 | 3 | 8.61E−03 | 0 |
| 13 | 5.00E−03 | 3 | 4.31E−03 | stuck |
| 14 | 5.00E−03 | 3 | 4.31E−03 | 0 |
| 15 | 5.00E−03 | 3 | 4.31E−03 | 0 |
| 16 | 2.50E−03 | 3 | 2.15E−03 | 0 |
| 17 | 1.20E−03 | 3 | 1.08E−03 | Stuck |
| 18 | 1.20E−03 | 3 | 1.08E−03 | Stuck |

In conclusion, the MRD of Bnt-B observed in this experiment is 2.15E−03 g/m² for the continuous process. The MRD observed here could have been influenced by the three times additives were applied on press 6-8 and press 13-15.

### Experiment 11. This Section was Left Empty Intentionally.

### Experiment 12. P96B (Additive: 5% Aqueous Bnt-C Suspension) 2021 Sep. 3

The objective of this experiment is to find the MRD of Bnt-C for the Continuous process.

The Bnt-C was prepared by dispersing the bentonite powder in RO-water without any separation/cleaning procedures. The aspen strands were not moisture controlled (7-10%). They were treated with PM200 pMDI. The SS plate was cleaned by polishing and acetone treatment. In this test, full-mat panels were built. The additive was sprayed onto the hot plates following the hot plate method using the HVLP sprayer. Pre-conditioning was done at 1.26E+01 g/m². The reference test for the continuous press was done by following the ‘Manual Pressing Procedure.’

The result shows that Bnt-C does not release at 1.68E+01 g/m² (i.e., 1.26E+01 g/m²+4.20E+00 g/m²), suspected to be due to low sodium-bentonite content, possible contamination, or high mica contents. The light grey dried bentonite layer was formed when the additive was sprayed on the SS plate, and about 60% of it was transferred to the wood panel.

TABLE 12
Experiment 12 Release Result.

| Press | % Total Active | Wt. Additive | Application | Release |
|---|---|---|---|---|
| # | Concentration | (g) | dose (g/m²) | Result |
| PC | 5.00E+00 | 9 | 1.26E+01 | N/A |
| 1 | 5.00E+00 | 3 | 4.20E+00 | Stuck |
| 2 | 2.50E+00 | 3 | 2.11E+00 | stuck |
| 3 | 2.50E+00 | 3 | 2.10E+00 | stuck |

In conclusion, the Bnt-C does not release at 1.68E+01 g/m².

### Experiment 13. P95B (Additive: 5% Aqueous Bentontie(B) 2021 Sep. 9 Suspension)

The objective of this experiment is to find the SRD of Bnt-B based on the Exp-07 for the Continuous process.

The Bnt-B was prepared with no separation/cleaning done. The powdered Bnt-B was slowly added to the RO water stirred at 10,000 rpm. A homogeneous mixing was ensured by adding it slowly, moving the mechanical stirrer up and down, and increasing the speed to 15,000 rpm for a minute after adding all the powder. The aspen strands were not moisture controlled (range 7-10%), and they were treated with PM200 pMDI. The SS plate was cleaned by polishing and acetone treatment. A New SS plate was used for each sustainable concentration. In this test, full-mat panels were built. Following the hot plate method, the additive was sprayed onto the hot plates using the HVLP sprayer. Pre-conditioning was done at 1.26E+01 g/m². By following the ‘Manual Pressing Procedure,’ the sustainability test for the continuous press was done. The sustainable AD tested are 4.31 E−03 g/m² and 8.61E−03 g/m², which were decided based on Exp 07.

The result shows that at the AD of 4.31 E−03 g/m² and 8.61E−03 g/m², sustainable releases are not achieved. In the reference test (Exp 07), the MRC was found to be 0.0025%, indicating that increasing one to two concentration levels is not enough to observe sustainable releases. After applying preconditioning spray to the SS plate, a light grey dried bentonite layer was formed. And the dried bentonite layer was transferred onto the wood panel after pressing.

TABLE 13
Experiment 13 Release Result.

| Press | % Total Active | Wt. Additive | Application | Release |
|---|---|---|---|---|
| # | Concentration | (g) | dose (g/m²) | Result |
| PC | 5.00E+00 | 9 | 1.26E+01 | N/A |
| 1 | 5.00E+00 | 3 | 4.20E+00 | 0 |
| 2 | 5.00E−03 | 3 | 4.31E−03 | Stuck |
| PC | 5.00E+00 | 9 | 1.26E+01 | N/A |
| 1 | 5.00E+00 | 3 | 4.20E+00 | 0 |
| 2 | 1.00E−02 | 3 | 8.61E−03 | 0 |
| 3 | 1.00E−02 | 3 | 8.61E−03 | Stuck |
| 4 | 1.00E−02 | 3 | 8.61E−03 | 0 |
| 5 | 1.00E−02 | 3 | 8.61E−03 | Stuck |
| 6 | 1.00E−02 | 3 | 8.61E−03 | stuck |

In conclusion, the SRD of the additive was not determined in this experiment. To observe the SRD, they must be tested at AD greater than 8.61 E−03 g/m².

Experiment 14. pH-Dependent Release Test (Additive: Sodium 2021 Sep. 20 Hydroxide)

The objective of this experiment is to see whether pH influences release performance.

For this experiment, NaOH was used because NaOH does not have release properties, while it is easy to increase the pH in the range of interest. The pH tested were 10, 11, 11.5, 12.5. The aspen strands were not moisture controlled (range 7-10%), and they were treated with PM200 pMDI. The SS plate was cleaned by polishing and acetone treatment. A New SS plate was used for each pH. In this test, full-mat panels were built. The additive was sprayed onto the hot plates following the hot plate method using the HVLP sprayer. Pre-conditioning was not applied. The pH dependency was tested by following the ‘Manual Pressing Procedure.’

The result shows that release can be observed at a high enough pH. NaOH had no releasing property; However, the release was observed when pH was higher than 11.5. A clean and waxy layer was formed on both the plate and wood panel when the release was observed. However, at pH less than 11, the release was not observed, and several piks were stuck on the SS plate.

TABLE 14
Experiment 14 Release Result.

| pH | [NaOH](M) | Wt. Additive [g] (g) | observation |
|---|---|---|---|
| 12.44 | 4.10E−02 | 3 | Release |
| 11.58 | 1.60E−02 | 3 | Release |
| 11 | 2.90E−03 | 3 | Stuck |
| 10 | 3.30E−04 | 3 | Stuck |

In conclusion, when the pH of an additive is larger than 11.5, it might show release even though it doesn't have the release properties.

### Experiment 15. Y120 (Additive: 2.65% Aqueous Bnt-D Suspension) 2021 Sep. 23

The objective of this experiment is to measure the MRD of Bnt-D for a continuous process.

Centrifuge-separated Bnt-D was used. First, a 7% stock solution was made by dispersing the bentonite powder in RO water at 15000 rpm. Then, the 7% stock suspension was diluted to 5% with RO water. The 5% suspension was then centrifuged at 2,715 rpm for 10 minutes. The centrifuged suspension was 2.65% with a pH of 8.69. The aspen strands were not moisture controlled (range 7-10%), and they were treated with PM200 pMDI. The SS plate was cleaned by polishing and acetone treatment. A New SS plate was used for each sustainable concentration. In this test, full-mat panels were built. The additive was sprayed onto the hot plates following the hot plate method using the HVLP sprayer. Pre-conditioning was done at 1.48E+01 g/m². The reference test for the continuous press was done by following the ‘Manual Pressing Procedure.’

The result shows that the MRD of bnt-D is 3.34E−02 g/m². Sticking was observed at 1.05E+00 g/m², but the plate was removed easily by tapping on the table. This could have been due to human errors. Applying preconditioning formed an even dried bentonite layer, and most of the layer was transferred to the wood panel. On the 9th press, there was no dried bentonite layer transferred onto the wood panel, making a clean wood panel. The experiment ended at 9th presses due to a shortage of wood strands prepared.

TABLE 15
Experiment 15 Release Result.

| Press | % Total Active | Wt. Additive | Application | Release |
|---|---|---|---|---|
| # | Concentration | (g) | dose (g/m²) | Result |
| PC | 2.65E+00 | 20 | 1.48E+01 | N/A |
| 1 | 2.65E+00 | 3 | 2.22E+00 | 0 |
| 2 | 2.65E+00 | 3 | 2.22E+00 | 0 |
| 3 | 1.25E+00 | 3 | 1.05E+00 | stuck |
| 4 | 1.25E+00 | 3 | 1.05E+00 | 0 |
| 5 | 6.25E−01 | 3 | 5.24E−01 | 0 |
| 6 | 3.12E−01 | 3 | 2.60E−01 | 0 |
| 7 | 1.56E−01 | 3 | 1.35E−01 | 0 |
| 8 | 7.80E−02 | 3 | 6.67E−02 | 0 |
| 9 | 3.90E−02 | 3 | 3.34E−02 | 0 |

In conclusion, the MRD of Bnt-D is 3.34E−02 g/m² or lower.

### Experiment 16. Y120 (Additive: 2.5% Aqueous Bnt-D Suspension) 2021 Sep. 27

The objective of this experiment is to see the effect of the three-layered panel compared to the full matt to increase productivity by decreasing the strand preparation time.

Centrifuge-separated Bnt-D was used. First, a 7% stock solution was made by dispersing the bentonite powder in RO water at 15000 rpm. Then, the 7% stock suspension was diluted to 5% with RO water. The 5% suspension was then centrifuged at 2,715 rpm for 10 minutes. The centrifuged suspension was 2.65% with a pH of 8.69. The aspen strands were not moisture controlled (range 7-10%), and they were treated with PM200 pMDI. The SS plate was cleaned by polishing and acetone treatment. A New SS plate was used for each sustainable concentration. In this test, full-mat panels were built. The additive was sprayed onto the hot plates following the hot plate method using the HVLP sprayer. Pre-conditioning was done at 1.47E+01 g/m². The reference test for the continuous press was done by following the ‘Manual Pressing Procedure.’

The result shows that the MRD of bnt-D on a three-layered panel is 2.60E−01 g/m². Although the first two presses showed the transfer of the dried bentonite layer onto the wood panel, the rest of the panels came out clean. This is because the first two presses removed most of the dried bentonite layer from the SS plate.

TABLE 16
Experiment 16 Release Result.

| Press | % Total Active | Wt. Additive | Application | Release |
|---|---|---|---|---|
| # | Concentration | (g) | dose (g/m²) | Result |
| PC | 2.50E+00 | 21 | 1.47E+01 | 0 |
| 1 | 2.50E+00 | 3 | 2.10E+00 | 0 |
| 2 | 2.50E+00 | 3 | 2.10E+00 | 0 |
| 3 | 1.25E+00 | 3 | 1.05E+00 | 0 |
| 4 | 6.25E−01 | 3 | 5.20E−01 | 0 |
| 5 | 3.12E−01 | 3 | 2.60E−01 | 0 |
| 6 | 1.56E−01 | 3 | 1.35E−01 | stuck |

In conclusion, the MRD of Bnt-D is 2.60E−01 g/m² when a three-layer is used. The MRD is higher than full matt (MRD 3.34E−02 g/m²), but the panel and SS plate are cleaner than the full matt case.

### Experiment 17. Y127 (Additive: 2.5% Aqueous Bnt-D Suspension) 2021 Sep. 29

The objective of this experiment is to observe the SRD of Bnt-D using the three-layered pane building method.

First, a 7% stock solution was made by dispersing the bentonite powder in RO water at 15000 rpm. Then, the 7% stock suspension was diluted to 5% with RO water. The 5% suspension was then centrifuged at 2,715 rpm for 10 minutes. The centrifuged suspension was 2.65% with a pH of 8.69. The aspen strands were not moisture controlled (range 7-10%), and they were treated with PM200 pMDI. The SS plate was cleaned by polishing and acetone treatment. A New SS plate was used for each sustainable concentration. In this test, three-layered panels were built. The additive was sprayed onto the hot plate using the HVLP sprayer. Pre-conditioning was done at 1.47E+01 g/m². By following the ‘Manual Pressing Procedure,’ the sustainability test for the continuous press was done. The 5.20E−01 g/m² and 1.05E+00 g/m² were tested as SRD.

The result shows that sustainability releases are not achieved when SRD of 5.20E−01 g/m² and 1.05E+00 g/m² were applied. Although the clean releases were not observed, the wood panels that didn't show spontaneous releases were easily removed by lightly tapping them on the table. The dried bentonite layer was transferred from the SS plate to the wood panel, and the transfer of the dried bentonite layer decreased as the number of presses increased.

TABLE 17
Experiment 17 Release Result.

| Press | % Total Active | Wt. Additive | Application | Release |
|---|---|---|---|---|
| # | Concentration | (g) | dose (g/m²) | Result |
| PC | 2.50E+00 | 21 | 1.47E+01 | N/A |
| 1 | 2.50E+00 | 3 | 2.10E+00 | stuck |
| 2 | 6.75E−01 | 3 | 5.20E−01 | 0 |
| 3 | 6.75E−01 | 3 | 5.20E−01 | stuck |
| 4 | 6.75E−01 | 3 | 5.20E−01 | stuck |
| PC | 2.50E+00 | 21 | 1.48E+01 | N/A |
| 1 | 2.50E+00 | 3 | 2.10E+00 | 0 |
| 2 | 1.25E+00 | 3 | 1.05E+00 | Stuck |
| 3 | 1.25E+00 | 3 | 1.05E+00 | Stuck |

In conclusion, the sustainability releases were not observed at 5.20E−01 g/m² and 1.05E+00 g/m² using the three-layered wood panel method. Hence it is expected that MSRD>1.05E+00 g/m².

### Experiment 18. Y129 (Additive: 2.5% Aqueous Bnt-D Suspension) 2021 Oct. 1

The objective of this experiment is to observe and compare the SRD of Bnt-D using both the three-layered panel method and the full-mat panel method at the same SRD.

The bnt-D was prepared by first taking the fine fraction of the bentonite sample (P98B), then it was diluted to 2.5% bentonite using RO water. The aspen strands were not moisture controlled (range 7-10%), and they were treated with PM200 pMDI. The SS plate was cleaned by polishing and acetone treatment. A New SS plate was used for each wood panel method. In this test, both three-layered panels and full-mat were built. The additive was sprayed onto the hot plate using the HVLP sprayer. Pre-conditioning was done at 1.47E+01 g/m². By following the ‘Manual Pressing Procedure,’ the sustainability test for the continuous press was done. For SRD, 2.10E+00 g/m² was applied for both panel methods.

The result shows that there are significant result differences between the three-layered method and the full-mat method in observing releases at the same application dose of 2.10E+00 g/m². There were no releases in the three-layered method, whereas five consecutive releases were observed using the full-mat wood form. The colour of the dried bentonite layer also darkened as the number of presses increased due to mica content in the sample. This is supported by observing the sedimentation of darker particles in the HVLP sprayer bottle.

TABLE 18
Experiment 18 Release Result.

| | | | Wt. | Application | |
|---|---|---|---|---|---|
| Press | Wood panel | % Total Active | Additive | dose | Release |
| # | method | Concentration | (g) | (g/m²) | Result |
| PC | Three- | 2.50E+00 | 21 | 1.47E+01 | N/A |
| 1 | layered | 2.50E+00 | 3 | 2.10E+00 | 0 |
| 2 | method | 2.50E+00 | 3 | 2.10E+00 | Stuck |
| 3 | | 2.50E+00 | 3 | 2.10E+00 | Stuck |
| PC | full-mat | 2.50E+00 | 21 | 1.47E+01 | N/A |
| 1 | method | 2.50E+00 | 3 | 2.10E+00 | 0 |
| 2 | | 2.50E+00 | 3 | 2.10E+00 | 0 |
| 3 | | 2.50E+00 | 3 | 2.10E+00 | 0 |
| 4 | | 2.50E+00 | 3 | 2.10E+00 | 0 |
| 5 | | 2.50E+00 | 3 | 2.10E+00 | 0 |

In conclusion, the full-mat method is essential when observing sustainability releases. Also cleaning procedure of bentonite needs to be considered as mica could hinder the releases and lower the quality of panels made.

### Experiment 19. Y133 (Additive: 2.5% Aqueous Bnt-D Suspension) 2021 Oct. 5

The objective of this experiment is to observe the MSRD of Bnt-D using the full-mat panel method for Continuous press.

The bnt-D was prepared by first taking the fine fraction of the bentonite sample (P98B), then it was diluted to 2.5% bentonite using RO water. The aspen strands were not moisture controlled (range 7-10%), and they were treated with PM200 pMDI. The SS plate was cleaned by polishing and acetone treatment. In this test, full-mat panels were built. The additive was sprayed onto the hot plate using the HVLP sprayer. Pre-conditioning was done at 1.47E+01 g/m². By following the ‘Manual Pressing Procedure,’ the sustainability test for the continuous press was done. For SRD, 5.20E−01 g/m² was applied for both panel methods.

At 5.20E−01 g/m², sustainable releases were not observed, as sticking was observed on the 6th and 8th presses. Overall, the consecutive releases were observed up to the 5th press continuously. Additionally, the sustainable concentration was chosen based on the reference test, Y120; however, it should be noted that Y120 was prepared by centrifugation cleaning procedure, whereas Y133 was prepared by taking a fine fraction cleaning procedure.

TABLE 19
Experiment 19 Release Result.

| Press | % Total Active | Wt. Additive | Application | Release |
|---|---|---|---|---|
| # | Concentration | (g) | dose (g/m²) | Result |
| PC | 2.50E+00 | 21 | 1.47E+01 | N/A |
| 1 | 2.50E+00 | 3 | 2.10E+00 | 0 |
| 2 | 6.25E−01 | 3 | 5.20E−01 | 0 |
| 3 | 6.25E−01 | 3 | 5.20E−01 | 0 |
| 4 | 6.25E−01 | 3 | 5.20E−01 | 0 |
| 5 | 6.25E−01 | 3 | 5.20E−01 | 0 |
| 6 | 6.25E−01 | 3 | 5.20E−01 | Stuck |
| 7 | 6.25E−01 | 3 | 5.20E−01 | 0 |
| 8 | 6.25E−01 | 3 | 5.20E−01 | Stuck |

In conclusion, sustainable releases were not observed at 5.20E−01 g/m².

### Experiment 20. Y148 (Additive: 1.25% Aqueous Bnt-D Suspension) 2021 Oct. 21

The objective of this experiment is to observe the MRD of Bnt-D for the continuous press.

The Bnt-D was prepared by taking the fine fraction of the bentonite sample (P98B) and then centrifuging it at 2,715 rpm for 10 minutes. The centrifuged sample was diluted to 1.25% with RO water. The centrifugation was done to remove the darkening of the dried bentonite layer observed in Exp. 19. The aspen strands were prepared by increasing the moisture level to 10% and treating it with PM200 pMDI. The SS plate was cleaned by using the ‘regular cleaning method.’ In this test, full-mat panels were built. The additive was sprayed onto the hot plates following the hot plate method using the HVLP sprayer. Pre-conditioning was done at 1.47E+01 g/m². The reference test for the continuous press was done by following the ‘Manual Pressing Procedure.’

The result shows that the MRD of the additive is 8.61E−03 g/m². The dried bentonite layer was formed on the SS plate after spraying, and they were transferred from the SS plate to the wood panel after pressing. There were no piks observed, but on the 5th press, brown streaks were observed on the SS plate, which is suspected to be from wood strands because the location of brown streaks aligns with the location of darker strands on the panel.

TABLE 20
Experiment 20 Release Result.

| Press | % Total Active | Wt. Additive | Application | Release |
|---|---|---|---|---|
| # | Concentration | (g) | dose (g/m²) | Result |
| PC | 1.25E+00 | 42 | 1.47E+01 | N/A |
| 1 | 1.25E+00 | 6 | 2.10E+00 | 0 |
| 2 | 1.25E+00 | 6 | 2.10E+00 | 0 |
| 3 | 1.25E+00 | 3 | 1.05E+00 | 0 |
| 4 | 6.25E−01 | 3 | 5.24E−01 | stuck |
| 5 | 6.25E−01 | 3 | 5.24E−01 | 0 |
| 6 | 3.12E−01 | 3 | 2.63E−01 | 0 |
| 7 | 1.56E−01 | 3 | 1.31E−01 | 0 |
| 8 | 7.80E−02 | 3 | 6.57E−02 | 0 |
| 9 | 3.90E−02 | 3 | 3.23E−02 | 0 |
| 10 | 1.90E−02 | 3 | 1.61E−02 | 0 |
| 11 | 1.00E−02 | 3 | 8.61E−03 | 0 |
| 12 | 5.00E−03 | 3 | 4.31E−03 | Stuck |
| 13 | 3.00E−03 | 3 | 4.31E−03 | Stuck |

In conclusion, the MRD of the additive is 8.61 E−03 g/m² when the full-mat method is used.

### Experiment 21. Y151 (Additive: 0.625% Aqueous Bnt-D+0.625% 2021 Oct. 25 Ethox 2989 Suspension)

The objective of this experiment is to observe synergy between Bnt-B with Ethox 2989 for the continuous press.

The Bnt-D was prepared by taking the fine fraction of the bentonite sample (P981B) and centrifuging it at 2,715 rpm for 10 minutes. The centrifuged sample was diluted to 1.25% with RO water. The Ethox 2989 sample was prepared by mixing RO water, Ethox 2989, Cola Teric Surfactant, and KOH. The concentration of Ethox 2989 in this stock solution was 23.3%, and its pH was 8.6. Then, this solution was diluted to 1.26% Ethox 2989. The additive was prepared by mixing 1.25% bentonite(D) with 1.26% Ethox 2989 solution to 50:50 wt %. Therefore, the total concentration is 1.255% without considering KOH and Cola Teric Surfactant. The preconditioning was done at 42 g of 1.25% to apply about the same rate as when 2.5% of 21 g is applied. The aspen strands were prepared by increasing the moisture level to 10% and treating it with PM200 pMDI. The SS plate was cleaned by using the ‘regular cleaning method.’ In this test, full-mat panels were built. Following the hot plate method, the additive was sprayed onto the hot plates using the HVLP sprayer. Pre-conditioning was done at 1.47E+01 g/m². The reference test for the continuous press was done by following the ‘Manual Pressing Procedure.’

The result shows that the MRD of the additive is 1.05E+00 g/m². After the preconditioning spray, white dots were observed on the SS plate, and less of a dried bentonite layer was observed, possibly due to half-concentrated bentonite present in the suspension. The formation of white dots suggests that the even layer was not formed on the SS plate. The wood panels came out clean. When the additive was diluted for the following concentration, KOH solution was used to keep the pH around 8.5-9.5.

TABLE 21
Experiment 21 Release Result.

| | | | | Wt. | Application | | |
|---|---|---|---|---|---|---|---|
| Press | % Ethox | | % Total Active | Additive | dose | Release | |
| # | 2989 | % Bnt -D | Concentration | (g) | (g/m²) | Result | piks |
| PC | 6.25E−01 | 6.25E−01 | 1.25E+00 | 42 | 1.47E+01 | N/A | N/A |
| 1 | 6.25E−01 | 6.25E−01 | 1.25E+00 | 6 | 2.10E+00 | stuck | 1 md |
| 2 | 6.25E−01 | 6.25E−01 | 1.25E+00 | 6 | 2.10E+00 | 0 | N/A |
| 3 | 6.25E−01 | 6.25E−01 | 1.25E+00 | 3 | 1.05E+00 | 0 | N/A |
| 4 | 3.13E−01 | 3.13E−01 | 6.25E−01 | 3 | 5.24E−01 | stuck | N/A |
| 5 | 3.13E−01 | 3.13E−01 | 6.25E−01 | 3 | 5.24E−01 | Stuck | N/A |

In conclusion, the synergy of Bnt-D with Ethox 2989 solution is not observed, which is suspected to be due to the inability to spray Ethox 2989 evenly on the SS plate.

### Experiment 22. Y154 (Additive: 0.63% Aqueous Bnt-D+0.005% PS—2021 Oct. 27 S)

The objective of this experiment is to observe synergy between Bnt-D with PS-5 using the full-mat panel method for the continuous press.

The bentonite-D was prepared by taking the fine fraction of the bentonite sample (P98B) and centrifuging it at 2,715 rpm for 10 minutes. The centrifuged sample was diluted to 1.25% with RO water. 0.01% PS-5 was made by dilution with RO water. The additive was made by mixing Bnt-D with PS-5 in 50:50 wt %. Therefore, the total initial active concentration is 0.635%. The aspen strands were prepared by increasing the moisture level to 10% and treating it with PM200 pMDI. The SS plate was cleaned by using the ‘regular cleaning method.’ In this test, full-mat panels were built. The additive was sprayed onto the hot plates following the hot plate method using the HVLP sprayer. Pre-conditioning was done at 1.47E+01 g/m². By following the ‘Manual Pressing Procedure,’ the sustainability test for the continuous press was done.

The experiment couldn't be run for 10 presses due to a shortage of additives. Looking at the result, a sustainable release could have been achieved. There was sticking observed on the 4^{th} press for unknown reasons. The dried bentonite layer was found on the SS plate after the preconditioning spray, and the layer was transferred to the wood panel after pressing.

TABLE 22
Experiment 22 Release Result.

| Press | % Total Active | Wt. Additive | Application | Release |
|---|---|---|---|---|
| # | Concentration | (g) | dose (g/m²) | Result |
| PC | 6.35E−01 | 83 | 1.47E+01 | N/A |
| 1 | 6.35E−01 | 11 | 1.95E+00 | 0 |
| 2 | 6.35E−01 | 3 | 5.33E−01 | 0 |
| 3 | 6.35E−01 | 3 | 5.33E−01 | 0 |
| 4 | 6.35E−01 | 3 | 5.33E−01 | stuck |
| 5 | 6.35E−01 | 3 | 5.33E−01 | 0 |
| 6 | 6.35E−01 | 3 | 5.33E−01 | 0 |
| 7 | 6.35E−01 | 3 | 5.33E−01 | 0 |
| 8 | 6.35E−01 | 3 | 5.33E−01 | 0 |

The Bnt-to-PS-5 ratio is 0.63/0.005=0.00312. The PS-5 to total solid ratio is 0.005/0.635=0.0079. The Bnt-to-total solid ratio is 0.9921. The SRD of PS-5 is 5.33E−01 g/m²*0.00312=0.0017 g/m² when the PCD of PS-5 is 1.47E+01*0.00312=0.046 g/m². In conclusion, the additive shows sustainable releases, but it's not clear when it would have stopped showing sustainable releases as. Additionally, the reference test was not done to compare SRD and MRD.

### Experiment 23. Y160 (Additive: 0.827% Aqueous Bnt-D) 2021 Oct. 29

The objective of this experiment is to observe the SRD of the Bnt-D. The preconditioning rate was reduced to decrease the dried bentonite layer formation on the SS plate.

The bnt-D was prepared by centrifuging the fine fraction of bnt-D at 2,715 rpm for 10 minutes. The pH of the centrifuged sample was 8.7. The aspen strands were prepared by increasing the moisture level to 10% and treating it with PM200 pMDI. The SS plate was cleaned by using the ‘regular cleaning method.’ In this test, full-mat panels were built. The additive was sprayed onto the hot plates following the hot plate method using the HVLP sprayer. Pre-conditioning was done at 2.78E+00 g/m², which is lower than the sustainability done in the past (Exp 18-22). By following the ‘Manual Pressing Procedure,’ the sustainability test for the continuous press was done. By considering Exp 18, the tested release concentration was 0.625%

This experiment shows that sustainable releases could be achieved at 5.24E−01 g/m² even after decreasing the pre-condition dose. The dried bentonite layer was transferred to the wood panel in every press, but much small amount was transferred compared to previous experiments. No piks were observed, and the SS plate was relatively clean.

TABLE 23
Experiment 23 Release Result.

| Press | % Total Active | Wt. Additive | Application | Release |
|---|---|---|---|---|
| # | Concentration | (g) | dose (g/m²) | Result |
| PC | 8.27E−01 | 12 | 2.78E+00 | N/A |
| 1 | 8.27E−01 | 3 | 6.94E−01 | 0 |
| 2 | 6.25E−01 | 3 | 5.24E−01 | 0 |
| 3 | 6.25E−01 | 3 | 5.24E−01 | 0 |
| 4 | 6.25E−01 | 3 | 5.24E−01 | 0 |
| 5 | 6.25E−01 | 3 | 5.24E−01 | 0 |
| 6 | 6.25E−01 | 3 | 5.24E−01 | 0 |
| 7 | 6.25E−01 | 3 | 5.24E−01 | 0 |
| 8 | 6.25E−01 | 3 | 5.24E−01 | 0 |
| 9 | 6.25E−01 | 3 | 5.24E−01 | 0 |
| 10 | 6.25E−01 | 3 | 5.24E−01 | 0 |

In conclusion, the release is sustainable at 5.24E−01 g/m² when 2.78E+00 g/m² was sprayed as a pre-treatment. The dried bentonite layer continued to be observed in the SS plate, but it was significantly less than when about 1.47E+01 g/m² was applied as pretreatment.

### Experiment 24. Y162 (Additive: 0.827% Aqueous Bnt-D) 2021 Nov. 2

The objective of this experiment is to observe the SRD of Bnt-D sustainable dosage applied.

The bnt-D was prepared by centrifuging the fine fraction of bnt-D at 2,715 rpm for 10 minutes. The pH of the centrifuged sample was 8.7. The aspen strands were prepared by increasing the moisture level to 10% and treating it with PM200 pMDI. The SS plate was cleaned by using the ‘regular cleaning method.’ In this test, full-mat panels were built. Following the hot plate method, the additive was sprayed onto the hot plates using the HVLP sprayer. Pre-conditioning was done at 2.78E+00 g/m², which is lower than the sustainability done in the past (Exp 18-22). By following the ‘Manual Pressing Procedure,’ the sustainability test for the continuous press was done. The sustainable release concentration was chosen to be 2.60E−01 g/m² based on successful sustainable releases observed in Exp-23.

In this experiment, the sustainable releases were not observed at 2.60E−01 g/m². Instead, this experiment provided insight into an endpoint where we might no longer observe a release. All the wood panels came out clean, but a faded dried bentonite layer was observed on the SS plate.

TABLE 24
Experiment 24 Release Result.

| Press | % Total Active | Wt. Additive | Application | Release |
|---|---|---|---|---|
| # | Concentration | (g) | dose (g/m²) | Result |
| PC | 8.27E−01 | 12 | 2.78E+00 | N/A |
| 1 | 8.27E−01 | 3 | 6.94E−01 | 0 |
| 2 | 3.12E−01 | 3 | 2.60E−01 | 0 |
| 3 | 3.12E−01 | 3 | 2.60E−01 | 0 |
| 4 | 3.12E−01 | 3 | 2.60E−01 | stuck |
| 5 | 3.12E−01 | 3 | 2.60E−01 | 0 |
| 6 | 3.12E−01 | 3 | 2.60E−01 | stuck |
| 7 | 3.12E−01 | 3 | 2.60E−01 | 0 |
| 8 | 3.12E−01 | 3 | 2.60E−01 | stuck |

In conclusion, at 2.60E−01 g/m², the sustainable releases are not observed.

### Experiment 25. Y166 (Additive: Unseparated 0.827% Aqueous 2021 Nov. 2 Bnt-D)

This experiment aims to test the effect of mica particles on the release performance of Bnt-D for the continuous sustainability test. The release result is compared to Exp-23, which showed sustainable releases at 5.24E−01 g/m².

The bnt-D was not separated, meaning no cleaning procedure was followed. The bnt-D suspension was made by adding bnt-D powder directly into the water, and it was stirred using a mechanical stirrer for 30 minutes. The concentration of the additive was 0.827%. The aspen strands were prepared by increasing the moisture level to 10% and treating it with PM200 pMDI. The SS plate was cleaned by using the ‘regular cleaning method.’ In this test, full-mat panels were built. The additive was sprayed onto the hot plates following the hot plate method using the HVLP sprayer. Pre-conditioning was done at 2.78E+00 g/m², which is lower than the sustainability done in the past (Exp 18-22). By following the ‘Manual Pressing Procedure,’ the sustainability test for the continuous press was done. The sustainable release concentration was chosen to be 5.24E−01 g/m² based on successful sustainable releases observed in Exp-23.

In this experiment, unseparated bentonite was tested to see the effect of mica particles. Compared to Exp-23, no sustainable releases were observed at the same application dose, supporting the importance of separating and purifying the bentonite suspension before the release experiments. The wood panel showed no dried bentonite layer transferred from the SS plate, but the SS plate had more dried bentonite layer left behind. The darkening of the dried bentonite layer was not observed in this experiment, possibly due to the low application dose sprayed.

TABLE 25
Experiment 25 Release Result.

| | % Total Active | Wt. Additive | Application | Release |
|---|---|---|---|---|
| Press # | Concentration | (g) | dose (g/m²) | Result |
| PC | 8.27E−01 | 12 | 2.78E+00 | N/A |
| 1 | 8.27E−01 | 3 | 6.94E−01 | 0 |
| 2 | 6.25E−01 | 3 | 5.24E−01 | stuck |
| 3 | 6.25E−01 | 3 | 5.24E−01 | 0 |
| 4 | 6.25E−01 | 3 | 5.24E−01 | Stuck |
| 5 | 6.25E−01 | 3 | 5.24E−01 | 0 |
| 6 | 6.25E−01 | 3 | 5.24E−01 | stuck |

In conclusion, mica particles might hinder bentonite particles' release performance, which suggests the importance of cleaning bentonite suspensions.

### Experiment 26. Y169 (Additive: 0.827% Aqueous Bnt-D+SHMP) 2021 Nov. 8

The objective of this experiment is to test the SRD of Bnt-D when mixed with various concentrations of SHMP. SHMP is added to decrease the viscosity of the bentonite, help sedimentation of larger particles, and increase the wettability of bentonite particles.

There were two types of bentonites used. The first Bnt-D was prepared without cleaning procedures, whereas the second Bnt-D was prepared via centrifugation.

First, 10.23% of unseparated bentonite suspensions were made with RO water. Then, the suspensions were diluted to 0.8% bentonite with 200 mM SHMP or 50 mM SHMP. Resulted composition was SHMP: 11.28%+Bnt: 0.8% for the 200 mM dilution and SHMP: 2.82%+Bnt: 0.8% for the 50 mM dilution.

Second Bnt-D was prepared with cleaning via centrifuging at 2,715 rpm for 10 minutes. The concentration of bentonite is 1.25%, and they were diluted to 0.827% using 200 mM SHMP or 50 mM SHMP solution. The preconditioning was not done because this experiment was a preliminary test on how bentonite(D) and SHMP perform together as a releasing agent. Resulted composition with the 50 mM dilution was SHMP 1.04%+Bnt 0.83% (Bnt-to-SHMP ratio: 0.8). Resulted composition with the 200 mM dilution was SHMP 4.14%+Bnt 0.83% (Bnt-to-SHMP ratio: 0.2).

TABLE 26
Experiment 26 Release Result.

| | | | | Wt. | Application | | |
|---|---|---|---|---|---|---|---|
| Press | Plate | | % Total Active | Additive | dose | Release | |
| # | # | Additive | Concentration | (g) | (g/m²) | Result | piks |
| 1 | 1 | Unseparated | 8.27E−01 | 5 | 1.16E+00 | stuck | N/A |
| 2 | 2 | Bnt-D + 200 mM | 8.27E−01 | 5 | 1.16E+00 | 0 | N/A |
| 3 | | SHMP | 3.12E−01 | 3 | 2.60E−01 | stuck | 3 piks |
| 4 | | Composition: | 3.12E−01 | 3 | 2.60E−01 | Stuck | N/A |
| | | SHMP 11.3% | | | | | |
| | | Bnt-D: 0.8% | | | | | |
| | | Bnt-to-SHMP | | | | | |
| | | ratio: 0.07 | | | | | |
| 5 | 3 | Unseparated | 8.27E−01 | 5 | 1.16E+00 | Hard | 5 piks |
| | | Bnt-D + 50 mM | | | | Stuck | |
| | | SHMP | | | | | |
| | | Composition: | | | | | |
| | | SHMP 2.82% | | | | | |
| | | Bnt-D: 0.83% | | | | | |
| | | Bnt-to-SHMP | | | | | |
| | | ratio: 0.29 | | | | | |
| 6 | 4 | Centrifuged | 8.27E−01 | 5 | 1.16E+00 | Hard | 4 piks |
| | | Bnt-D + 200 mM | | | | stuck | |
| | | SHMP | | | | | |
| | | Composition: | | | | | |
| | | SHMP 4.14% | | | | | |
| | | Bnt-D: 0.83% | | | | | |
| | | Bnt-to-SHMP | | | | | |
| | | ratio: 0.20 | | | | | |
| 7 | 5 | Centrifuged | 8.27E−01 | 5 | 1.16E+00 | stuck | N/A |
| | | Bnt-D + 50 mM | | | | | |
| | | SHMP | | | | | |
| | | Composition: | | | | | |
| | | SHMP 1.04% | | | | | |
| | | Bnt-D: 0.83% | | | | | |
| | | Bnt-to-SHMP | | | | | |
| | | ratio: 0.80 | | | | | |

The aspen strands were prepared by increasing the moisture level to 10% and treating it with PM200 pMDI. The SS plate was cleaned by using the ‘regular cleaning method.’ In this test, full-mat panels were built. The additive was sprayed onto the hot plates following the hot plate method using the HVLP sprayer. The preliminary test for the continuous press was done by following the ‘Manual Pressing Procedure.’

The result shows that SHMP does not improve the releasing performance of Bnt-D. There was one release observed at 2^{nd} press, but the consecutive releases were not observed. After spraying, white dots formed on the plate rather than a dried bentonite layer. Piks were observed quite frequently in this experiment. On the 5^{th} presses, the white dots were no longer observed on the SS plate, possibly due to the low concentration of SHMP. The hard stuck was observed on the 5^{th} and 6^{th} press, meaning that the panel was removed from the SS plate using a hammer.

NB: the recorded SHMP concentrations are meant in the diluting RO water.

The SRD of the additives was not obtained since there were no sustainable releases observed. The result shows that the total additive's application dose (AD) might need to be greater than 1.16E+00 g/m². The AD of individual composition is below.
1. Unseparated Bnt-D+200 mM SHMP:
   AD of Bnt-D is 7.67E−02 g/m², and the concentration of Bnt-D at this dose is 0.83%. AD of SHMP is 1.08E+00 g/m², and the concentration of SHMP at this dose is 11.3%
2. Unseparated Bnt-D+50 mM SHMP:
   AD of Bnt-D is 2.56E−01 g/m², and the concentration of Bnt-D at this dose is 0.83%. AD of SHMP is 9.04E−01 g/m², and the concentration of SHMP at this dose is 2.83%.
3. Centrifuged Bnt-D+200 mM SHMP:
   AD of Bnt-D is 1.93E−01 g/m², and the concentration of Bnt-D at this dose is 0.83%. AD of SHMP is 9.67E−01 g/m², and the concentration of SHMP at this dose is 4.14%.
4. Centrifuged Bnt-D+50 mM SHMP:
   AD of Bnt-D is 5.15E−01 g/m², and the concentration of Bnt-D at this dose is 0.83%. AD of SHMP is 6.45E−01 g/m², and the concentration of SHMP at this dose is 1.04%

Therefore, the AD of SHMP for unseparated Bnt-D should be greater than 1.08E+00 g/m² and the AD of SHMP for centrifuged Bnt-D should be greater than 9.67E−01 g/m²

In conclusion, SHMP hinders the releasing performance of Bnt-D regardless of cleaned or unseparated bentonite, although adding SHMP helped with lowering the viscosity of bentonite suspensions. The non-release might be due to SHMP becoming sticky when applied too much. Nevertheless, it is advisable to also consider the case when the original suspension contains some SHMP, so the segregation of the coarse fraction is supported, but the diluting medium is water, which could be arranged in the industry. So as a follow-up, we should target a high bentonite concentration (about 10%) and a realistically low SHMP (about 0.5-1%) stock suspension to start with. We tested Bentonite with low concentrations of inorganic phosphates in Exp-27

### Experiment 27. Y177 (Additive: 0.827% Bnt-D+10 mM SHMP) 2021 Nov. 10

The objective of this experiment is to observe the SRD of Bnt-D with 10 mM SHMP for the continuous press.

The bentonite(D) is separated by centrifuging at 2,715 rpm for 10 minutes. The concentration of centrifuged bentonite was 1.25%, and it was diluted to 0.827% using a 10 mM SHMP solution. This resulted in Bnt: 0.827%+SHMP: 0.207%. Then, the total 0.83% bentonite with SHMP suspension was further diluted to 0.33% using 10 mM SHMP.

This led to the following composition:

The SHMP concentration: 0.4502%. The Bnt concertation: 0.33%. The Bnt-to-SHMP ratio: 0.733. Bnt-to-total solid ratio: 0.33/(0.33+0.4502)=0.423. SHMP to total solid ratio: 0.4502/(0.33+0.4502)=0.577. The PCD of bentonite 3.83E−3 g/m² (i.e., 0.0033*1.16). The PCD of the total additive was 1.16E+00 g/m² and the sustainable release dose was chosen to test at 2.77E−01 g/m².

The aspen strands were prepared by increasing the moisture level to 10% and treating it with PM200 pMDI. The SS plate was cleaned by using the ‘regular cleaning method.’ In this test, full-mat panels were built. Following the hot plate method, the additive was sprayed onto the hot plates using the HVLP sprayer. By following the ‘Manual Pressing Procedure,’ the sustainability test for the continuous press was done. The PCD was 1.16E+00 g/m², and chosen application dose was 3.30E−01 g/m².

At 3.30E−01 g/m², the sustainable releases were observed with a lower preconditioning dosage of 1.16E+00 g/m². Previously, the sustainable release was not observed when bentonite was used alone (refer to Exp-24) with a higher preconditioning rate. Also, stickiness was observed when 200 mM and 50 mM of SHMP were added to the Bnt-D. (Exp 26) However, sustainable releases were observed in this experiment, suggesting that SHMP assists in the releasing performance of Bnt-D when used in a lower concentration of 10 mM. C.f., with Experiment 25, where significant preconditioning was used. Nevertheless, we need to repeat the synergy experiment under the same condition. Additionally, brown spots were observed on the SS plate, which is suspected of lignin interacting with phosphates.

TABLE 27
Experiment 27 Release Result.

| | % Total Active | Wt. Additive | Application | Release |
|---|---|---|---|---|
| Press # | Concentration | (g) | dose (g/m²) | Result |
| 1 | 8.30E−01 | 5 | 1.16E+00 | 0 |
| 2 | 3.30E−01 | 3 | 2.77E−01 | 0 |
| 3 | 3.30E−01 | 3 | 2.77E−01 | 0 |
| 4 | 3.30E−01 | 3 | 2.77E−01 | 0 |
| 5 | 3.30E−01 | 3 | 2.77E−01 | 0 |
| 6 | 3.30E−01 | 3 | 2.77E−01 | 0 |
| 7 | 3.30E−01 | 3 | 2.77E−01 | 0 |
| 8 | 3.30E−01 | 3 | 2.77E−01 | 0 |
| 9 | 3.30E−01 | 3 | 2.77E−01 | 0 |
| 10 | 3.30E−01 | 3 | 2.77E−01 | 0 |

In conclusion, SRD was observed at 2.77E−01 g/m². (Bnt: 2.77E−1*0.423=1.17E−1 g/m²). PCD 1.16E+00 g/m² (Bnt: 1.16*0.423=0.49 g/m²); Bnt-to-SHMP ratio: 0.733) At SRD, the SRD of Bnt is 1.17E−1 g/m² and the SRD of SHMP is 1.60E−1 g/m². The concentration of SHMP at SRD is 0.1790%.

SHMP lowered the viscosity of bentonite, and the wood panels made were all clean and improved the release performance at low concentrations.

### Experiment 28. Y180 (Additive: 0.63% Bnt-D+0.22% PS-5) 2021 Nov. 12

The objective of this experiment is to observe the SRD of 0.63% Bnt-D with 1% PS-5 for the continuous process.

The bnt-D was prepared by centrifuging at 2,715 rpm for 10 minutes. The PS-S solution was made by mixing it with RO water. The concentration of centrifuged bentonite was 1.25%, and it was mixed 50:50 wt % with 0.44% PS-S. Therefore, the initial total active concentration is 0.845% (i.e., 0.625% Bnt-D+0.22% PS-S). Further dilution was done using RO water to make a total concentration of 0.625%. The aspen strands were prepared by increasing the moisture level to 10% and treating it with PM200 pMDI. The SS plate was cleaned by using the ‘regular cleaning method.’ In this test, full-mat panels were built. Following the hot plate method, the additive was sprayed onto the hot plates using the HVLP sprayer. By following the ‘Manual Pressing Procedure,’ the sustainability test for the continuous press was done. The PCD was 3.57E+00 g/m², and chosen application dose was 5.24E−01 g/m².

Post spraying, a light grey dried bentonite layer was formed on the SS plate, and it was transferred onto the wood panel, which was not noticeable. This experiment ended at 7th presses due to being short on strands. All 7 presses showed a clean panel, meaning that the additive seems to be more attached to the SS plate. The 10 presses were not observed due to the shortage of strands prepared.

TABLE 28
Experiment 28 Release Result.

| | Bnt - D | PS-5 | | Wt. | Application | |
|---|---|---|---|---|---|---|
| Press | Concentration | Concentration | % Total Active | Additive | dose | Release |
| # | (%) | (%) | Concentration | (g) | (g/m²) | Result |
| 1 | 6.30E−01 | 2.20E−01 | 8.45E−01 | 15 | 3.57E+00 | 0 |
| | | | (Bnt-to-PS-5 | | | |
| | | | ratio = 2.84) | | | |
| 2 | 4.69E−01 | 1.56E−01 | 6.25E−01 | 3 | 5.24E−01 | 0 |
| 3 | 4.69E−01 | 1.56E−01 | 6.25E−01 | 3 | 5.24E−01 | 0 |
| 4 | 4.69E−01 | 1.56E−01 | 6.25E−01 | 3 | 5.24E−01 | 0 |
| 5 | 4.69E−01 | 1.56E−01 | 6.25E−01 | 3 | 5.24E−01 | 0 |
| 6 | 4.69E−01 | 1.56E−01 | 6.25E−01 | 3 | 5.24E−01 | 0 |
| 7 | 4.69E−01 | 1.56E−01 | 6.25E−01 | 3 | 5.24E−01 | 0 |

The ratio of Bnt-D to SHMP is 0.63/0.22=2.86. The Bnt-D to total ratio is 6.30E−01/8.45E−01=0.74, and the PS-5 to total ratio is 1−0.74=0.26. The SRD of total application was 5.24E−01 g/m². The SRD of Bnt-D is 5.24E−01 g/m²*0.74=3.88E−01 g/m², and the SRD of PS-5 is 5.24E−01 g/m²*0.26=1.36E−01 g/m².

In conclusion, the release was observed in every seven presses. A tinted layer was formed on the SS plate, and they were not transferred onto the wood panel. This experiment can be repeated to see if sustainable releases can be achieved.

Experiment 29. Y184 (Additive: 4% Bnt-E Made with 20 mM SHMP 2021 Nov. 16 and Bnt-E Alone)

The objective of this experiment is to observe the release performance of bentonite (E) for the multi-opening press. Also, the synergy of bentonite (E) and 20 mM SHMP was tested.

There were two bnt-E samples tested in this experiment. The first Bnt-E sample was prepared by first making 7.63% bentonite with 1.22% SHMP. (Bnt-to-SHMP ratio=6.77; Bnt-to-total ratio=0.871) Then, It was further diluted to 4% with RO water. Hence, no centrifugation was done. The second bentonite(E) sample was prepared by centrifugation. SHMP was not added to bentonite.

Additionally, RO water was tested and see if there was a difference observed between bentonite samples and RO water. The aspen strands were prepared by increasing the moisture level to 10% and treating it with PM200 pMDI. The MS plate was cleaned by using the ‘regular cleaning method.’ In this test, full-mat panels were built. The additive was sprayed onto the wood panel with a hand sprayer following the multi-opening test method. The pre-conditioning was not done. The multi-opening press was done by following the ‘Manual Pressing Procedure.’

Both bentonite samples showed no releases for the multi-opening press in this experiment. The same observation was made in every press. The wood panel showed severely burnt spots, different sizes of piks stuck on the MS plate and no dried bentonite layer formation on both MS plate and wood panel. To see whether it's bentonite affected the result, RO water was tested alone as a blank. The same observation was made for RO water testing; severely burnt spots and many piks stuck on the MS plate. Therefore, bentonite is suspected of not forming an even layer on the wood panel. This is supported by observing no formation of dried bentonite layer on both MS plate and similar observation RO water testing. This could be due to bentonite(E) getting embedded in the pores of strands which leads to observing the effect of RO water.

TABLE 29
Experiment 29 Release Result.

| | | | Wt. | Application | | |
|---|---|---|---|---|---|---|
| Press | | % Total Active | Additive | dose | Release | |
| # | Additive | Concentration | (g) | (g/m²) | Result | Piks |
| 1 | Uncentrifuged | 4.00E−02 | 6.15 | 1.28E+00 | Stuck | A lot |
| | bentonite + SHMP | | | (Bnt: 1.11E+00) | | |
| 2 | Bnt-to-SHMP | 1.00E−02 | 3.22 | 1.68E−01 | Stuck | A lot |
| | ratio = 6.77 | | | | | |
| 3 | Centrifuged | 1.00E−02 | 3.25 | 1.68E−01 | Stuck | A lot |
| 4 | bentonite | 1.00E−02 | 23.95 | 1.24E+00 | Stuck | 10 piks |
| 5 | RO water | 1.00E+02 | 3.55 | N/A | stuck | A lot |

In conclusion, the bnt-E didn't show release when tested for the multi-opening press. There were severely burnt spots on the wood panel, piks on the MS plate and no dried bentonite layer formed on both MS plate and panel.

### Experiment 30. Y186 (Additive: 0.414% Bnt-D+0.414% Y2) 2021 Nov. 25

The objective of this experiment is to observe synergy between bentonite with Y2 in both continuous press and multi-opening press.

First, the additive was prepared by mixing 0.827% Bnt-D and 0.827% Y2 in 50:50 wt %. The Bnt-D was centrifuged, and it was further diluted from 1.25% to 0.827% with RO water. The Y2 was diluted from 34.9% to 0.827% with RO water. The total concentration of the additive was 0.827%. The aspen strands were prepared by increasing the moisture level to 10% and treating it with PM200 pMDI. The SS and MS plates were cleaned using the ‘regular cleaning method.’ In this test, both full-mat panels and three-layered panels were built. The additive was sprayed onto the hot plates using the HVLP sprayer for the continuous test, following the hot plate method.

On the other hand, the cold plate method was used for the multi-opening test. Pre-conditioning was not done since new plates were used in every pressing. Following the ‘Manual Pressing Procedure,’ the reference test for both the multi-opening and the continuous press was done.

When the continuous hot plate method was tested with the full-mat panel, the release was observed at 3.47E+00 g/m², and no piks were observed. However, an accurate dose was not measured due to Y2 bouncing from the hot plate. The cold plate method with MS plate using a multi-opening press procedure was tested with a full mat to be accurate with the dose applied. This didn't show release, and it was suspected to be due to uneven spraying of additives using a hand sprayer. Half of the panel was severely burnt, and many piks were observed on the SS plate. A three-layer method was used to see whether this was due to the uneven spray. Unfortunately, the three-layer method did not change the result. When used MS for multi-opening press testing, the MS plate started to get darker and burnt (oxidation), which could be due to the water component since water is corrosive to the MS plate.

TABLE 30
Experiment 30 Release Result.

| | | | Y2 | Bnt-D | | | |
|---|---|---|---|---|---|---|---|
| | | | application | application | Application | | |
| Press | Press | Wood | dose | dose | dose | Release | |
| # | method | panel | (g/m²) | (g/m²) | (g/m²) | Result | Piks |
| 1 | Continuous | Full matt | 1.74E+00 | 1.74E+00 | 3.47E+00 | 0 | N/A |
| | hot plate | | | | | | |
| 2 | Multi- | | 1.06E+00 | 1.06E+00 | 2.11E+00 | Stuck | A lot |
| 3 | opening, | Three- | 1.14E+00 | 1.14E+00 | 2.28E+00 | Stuck | A lot |
| 4 | cold plate | layered | 4.94E−01 | 4.94E−01 | 9.87E−01 | Stuck | A lot |

The ratio of Bnt-D to Y2 is 1:1. In conclusion, although adding Y2 to bentonite does show releases in the continuous hot plate method, it does not improve the release performance in the multi-opening cold plate method.

### Experiment 31. Y188 (Additive: 2.34% Bentonite-D+2.34% Y2 2021 Nov. 26 Suspension)

The objective of this experiment is to observe the synergy between bentonite with Y2 for a multi-opening test.

There were two additives tested in this experiment. The first additive was made by mixing 4.67% Y2 and 4.68% Bnt-D in 50:50 wt %. Such sample was made using a centrifuge-separated Bnt-D and Y2 diluted with RO water. Hence the initial total additive concentration was 4.675%. The second additive tested was 10% active Y2. The sample was prepared by diluting with RO water. Y2 was used as an additive because it was tested many times to show its releasing properties in both continuous and multi-opening press. The aspen strands were prepared by increasing the moisture level to 10% and treating it with PM200 pMDI. The MS plate was cleaned by using the ‘regular cleaning method.’ In this test, full-mat panels were built. The additive was sprayed onto wood panels using a hand-sprayer. The pre-conditioning was not done since new plates were used in every pressing. The reference test for the multi-opening press was done by following the ‘Manual Pressing Procedure.’

First, testing 2.34% Bnt-D with 2.34% Y2 resulted in a release when 1.48E+01 g/m² was applied, but the release was not observed when 5.09E+00 g/m² was applied. Severe burning of both wood panel and MS plate was observed. There was a strong odour as well coming from the burning. Corrosion was suspected.

Then 10% Y2 was tested alone. There were piks observed on the MS plate, and browning of the wood panel was observed. There was neither odour nor severe burning of the panel and MS plate. This suggests that the odour and burning might be caused by bentonite or higher water content.

TABLE 31
Experiment 31 Release Result.

| | | | Wt. | Application | | |
|---|---|---|---|---|---|---|
| Press | | % Total Active | Additive | dose | Release | |
| # | Additive | Concentration | (g) | (g/m²) | Result | Piks |
| 1 | 2.34% Bnt-D + | 4.68E+00 | 10 | 1.48E+01 | 0 | N/A |
| | 2.34% Y2. Ratio | | | (Bnt dose 7.4) | | |
| 2 | of Bnt-E to Y2 = | 4.68E+00 | 3.44 | 5.09E+00 | Stuck | N/A |
| | 1:1 | | | | | |
| 3 | Y2 | 1.00E+01 | 6 | 1.90E+01 | 0 | 1 sm |
| 4 | | 1.00E+01 | 6 | 1.90E+01 | Stuck | 5 md |
| 5 | | 1.00E+01 | 6 | 1.90E+01 | 0 | N/A |
| 6 | | 1.00E+01 | 4.5 | 1.36E+01 | 0 | 1 sm |

The Bnt-D to Y2 ratio is 1:1. In conclusion, when bentonite is mixed with Y2, the release can be observed when a large dose is applied; however, the burning of MS plate and wood panel is a problem, and this is not caused by Y2 since the severe burning is not observed when Y2 is sprayed alone. When tested for continuous press, bentonite does not show burning or odour, but it requires further examination for the multi-opening press.

### Experiment 32. Y190 (Additive: 4.25% Y2) 2021 Nov. 30

The objective of this experiment is to test Y2 alone to compare the release performance of Y2 with Bnt (E).

The Y2 was prepared by diluting it with RO water from 34.9% to 4.25%. The aspen strands were prepared by increasing the moisture level to 10% and treating it with PM200 pMDI. The SS plate was cleaned by using the ‘regular cleaning method.’ In this test, full-mat panels were built. The additive was sprayed onto a cold plate and heated to 220 C in the oven following the cold plate method. The cold plate method was used because Y2 was bouncing off when sprayed on the hot plate. The pre-conditioning was not done. The reference test for the continuous press was done by following the ‘Manual Pressing Procedure.’

In this experiment, the MRD of Y2 was 3.77E−02 g/m². After pressing, spots of small circles were found on the SS plate and wood panel. In addition, there were brown spots observed on the SS plate. As the number of presses increased, the SS plate came out clean. Unfortunately, the experiment was not continued because the prepared strands ran out.

TABLE 32
Experiment 32 Release Result.

| | % Total Active | Wt. Additive | Application | Release |
|---|---|---|---|---|
| Press # | Concentration | (g) | dose (g/m²) | Result |
| 1 | 4.25E+00 | 1 | 1.19E+00 | 0 |
| 2 | 4.25E+00 | 1 | 1.19E+00 | 0 |
| 3 | 2.13E+00 | 1 | 5.94E−01 | 0 |
| 4 | 2.13E+00 | 1 | 5.94E−01 | 0 |
| 5 | 1.06E+00 | 1 | 2.97E−01 | 0 |
| 6 | 1.06E+00 | 1 | 2.97E−01 | 0 |
| 7 | 5.31E−01 | 1 | 1.49E−01 | 0 |
| 8 | 5.31E−01 | 1 | 1.49E−01 | 0 |
| 9 | 2.66E−01 | 1 | 7.43E−02 | 0 |
| 10 | 2.66E−01 | 1 | 7.43E−02 | 0 |
| 11 | 1.33E−01 | 1 | 3.77E−02 | 0 |
| 12 | 1.33E−01 | 1 | 3.77E−02 | 0 |
| 13 | 6.65E−02 | 1 | 1.88E−02 | stuck |

In conclusion, the MRD of Y2 is 3.77E−02 g/m².

### Experiment 33. Y192 (Additive: 2.5% Aqueous Bnt-E) 2021 Dec. 2

The objective of this experiment is to compare the bentonite's releasing performance with Y2 alone.

The Bnt-E was prepared by first taking a fine fraction of suspension, drying them in a 104 C oven, grinding them to small particles and redispersing them into water. The ground sample was redispersed in RO water to make a 2.5% suspension. In this experiment, sample contamination is suspected since there was white plastic-textured powder observed in the sample after redispersing them. Next, the aspen strands were prepared by increasing the moisture level to 10% and treating it with PM200 pMDI. The SS plate was cleaned by using the ‘regular cleaning method.’ In this test, full-mat panels were built. The additive was sprayed onto a hot plate following the hot plate method. The pre-conditioning was not done. The reference test for the continuous press was done by following the ‘Manual Pressing Procedure.’

In this experiment, the release was observed even at 3.77E−02 g/m², but the experiment couldn't be continued due to the shortage of prepared strands. There was sticking observed at the 9th press, but the reason is unknown. After spraying, a tinted dried bentonite layer formed on the SS plate. Clean wood panels were found in every press. There were brown spots noticed on the SS plate, and it is suspected to have transferred from darker strands because the brown spots on the SS plate align with the location of darker fibres.

TABLE 33
Experiment 33 Release Result.

| | % Total Active | Wt. Additive | Application | Release |
|---|---|---|---|---|
| Press # | Concentration | (g) | dose (g/m²) | Result |
| 1 | 2.50E+00 | 1.7 | 1.19E+00 | 0 |
| 2 | 2.50E+00 | 1.7 | 1.19E+00 | 0 |
| 3 | 1.25E+00 | 1.7 | 5.94E−01 | 0 |
| 4 | 1.25E+00 | 1.7 | 5.94E−01 | 0 |
| 5 | 6.25E−01 | 1.7 | 2.97E−01 | 0 |
| 6 | 6.25E−01 | 1.7 | 2.97E−01 | 0 |
| 7 | 3.12E−01 | 1.7 | 1.49E−01 | 0 |
| 8 | 3.12E−01 | 1.7 | 1.49E−01 | 0 |
| 9 | 1.56E−01 | 1.7 | 7.43E−02 | Stuck |
| 10 | 1.56E−01 | 1.7 | 7.43E−02 | 0 |
| 11 | 7.80E−02 | 1.7 | 3.77E−02 | 0 |

In conclusion, the release might go lower than 3.77E−02 g/m². Clean wood panels were made in every experiment.

### Experiment 34. J33 (Additive: 3.6% Aqueous Bnt-E Suspension) 2022 Jan. 13

The objective of this experiment is to observe the MRD of Bnt-E prepared by gravity separation and distillation for the continuous process.

The Bnt-E suspension was prepared by following the ‘Concentrate via rotavap’ method. The measured concentration was 3.6%, and the suspension's pH was 9.28. The aspen strands were prepared by increasing the moisture level to 10% and treating it with PM200 pMDI. The SS plate was cleaned by using the ‘regular cleaning method.’ In this test, full-mat panels were built. The additive was sprayed onto a hot plate following the hot plate method. The preconditioning was done by applying 2.42E+00 g/m² to follow InnoTech Alberta's preconditioning method. Finally, the reference test for the continuous press was done by following the ‘Manual Pressing Procedure.

In this experiment, the MRD was observed at 9.69E−03 g/m² using the 75% wood panel method. The consolidated bentonite layer was formed on the SS plate, and it was transferred to the wood panel. After the 6th press, the wood panel did not have any dried bentonite layer transferred from the SS plate. At 4.31 E−03 g/m², both releasing and sticking were observed, indicating that 4.31E−03 g/m² might be the release failing point.

TABLE 34
Experiment 34 Release Result.

| | | Wt. | | |
|---|---|---|---|---|
| | % Total Active | Additive | Application | Release |
| Press # | Concentration | (g) | dose (g/m²) | Result |
| preconditioning | 3.60E+00 | 2.4 | 2.42E+00 | N/A |
| 1 | 3.60E+00 | 2.4 | 2.42E+00 | 0 |
| 2 | 1.80E+00 | 2.4 | 1.21E+00 | 0 |
| 3 | 9.00E−01 | 2.4 | 6.05E−01 | 0 |
| 4 | 4.50E−01 | 2.4 | 3.02E−01 | 0 |
| 5 | 2.30E−01 | 2.4 | 1.51E−01 | 0 |
| 6 | 1.10E−01 | 2.4 | 7.53E−02 | 0 |
| 7 | 5.50E−02 | 2.4 | 3.77E−02 | 0 |
| 8 | 2.80E−02 | 2.4 | 1.94E−02 | 0 |
| 9 | 1.40E−02 | 2.4 | 9.69E−03 | 0 |
| 10 | 7.00E−03 | 2.4 | 4.31E−03 | stuck |
| 11 | 7.00E−03 | 2.4 | 4.31E−03 | 0 |

In conclusion, MRD of Bnt-E prepared via rotavapor is 9.69E−03 g/m².

### Experiment 35. J35 (Additive: 1.8% Aqueous Bnt-E+1.8% AEPE 2022 Jan. 14 Suspension)

The objective of this experiment is to observe synergy and MRD of Bnt-E with AEPE for the continuous process.

The Bnt-E was prepared by using the ‘concentrate via rotavap’ method. The concentration of the Bnt-E was 3.6%, and the pH was 9.28. The stock solution of AEPE was assumed to be 100% active. The AEPE solution was first titrated with 10% NaOH to make 13.01% active with a pH of 9.08. Then, they were further diluted with RO water to make 3.6% active with a pH of 9.09. The additive was made by mixing 3.6% Bnt-E with 3.6% AEPE in 50:50 wt %. Therefore, the initial total active concentration without considering NaOH as an additive was 3.6%. The aspen strands were prepared by increasing the moisture level to 10% and treating it with PM200 pMDI. The SS plate was cleaned by using the ‘regular cleaning method.’ In this test, 75% panels were built. Following the hot plate method, the additive was sprayed onto a hot plate. The preconditioning was done at 2.42E+00 g/m². The reference test for the continuous press was done by following the ‘Manual Pressing Procedure.’

In this experiment, the MRD of the additive was observed at 1.94E−02 g/m². There was sticking observed on the 6th press, but the release was observed when the panel was lightly tapped on the table. Also, since the following two presses with lower application doses show release, the sticking could be an error or the range where it might start not releasing. There was light browning observed on the SS plate and less formation of dried bentonite layer compared to when bentonite is used alone. The wood panel came out extremely clean, meaning that none of the panels had dried bentonite spots or burnt spots. This additive provides better quality of wood panel while showing releases at such low dosage.

TABLE 35
Experiment 35 Release Result.

| | | Wt. | | |
|---|---|---|---|---|
| | % Total Active | Additive | Application | Release |
| Press # | Concentration | (g) | dose (g/m²) | Result |
| preconditioning | 3.60E+00 | 2.4 | 2.42E+00 | N/A |
| | Bnt-to-AEPE | | | |
| | ratio = 1 | | | |
| 1 | 3.60E+00 | 2.4 | 2.42E+00 | 0 |
| 2 | 1.80E+00 | 2.4 | 1.21E+00 | 0 |
| 3 | 9.00E−01 | 2.4 | 6.05E−01 | 0 |
| 4 | 4.50E−01 | 2.4 | 3.02E−01 | 0 |
| 5 | 2.30E−01 | 2.4 | 1.51E−01 | 0 |
| 6 | 1.10E−01 | 2.4 | 7.53E−02 | Stuck |
| 7 | 5.50E−02 | 2.4 | 3.77E−02 | 0 |
| 8 | 2.80E−02 | 2.4 | 1.94E−02 | 0 |
| 9 | 1.40E−02 | 2.4 | 9.69E−03 | stuck |

In conclusion, the MRD of the mixed additive is 1.94E−02 g/m². The MRD of Bnt is 9.7E−3 g/m² at Bnt-to-AEPE ratio=1. The preconditioning dose of bentonite is 1.22 g/m². This additive improves the quality of wood panels.

### Experiment 36. J36 (Additive: 3.6% Aqueous AEPE) 2022 Jan. 17

The objective of this experiment is to observe synergy and MRD of Bnt-E with AEPE suspension for a continuous process. Here, the AEPE was tested alone.

The AEPE was first diluted with RO water, and pH was adjusted with 10% NaOH. This stock sample was 13.01% active. Then it was further diluted to be 3.6% using RO water. The pH of the AEPE tested for release was 9.12. The aspen strands were prepared by increasing the moisture level to 10% and treating it with PM200 pMDI. The SS plate was cleaned by using the ‘regular cleaning method.’ In this test, 75% panels were built. The additive was sprayed onto a hot plate following the hot plate method. The preconditioning was done at 2.42E+00 g/m². The reference test for the continuous press was done by following the ‘Manual Pressing Procedure.’

In this experiment, the AEPE showed no release when 2.42E+00 g/m² was applied to the SS plate, indicating that AEPE does not show any releasing properties. This could be due to the low application dose applied, or AEPE might be bouncing out from the heated SS plate. There were several piks observed on the SS plate on the second press. In addition, a few burnt spots were observed on the wood panel, but it wasn't noticeable.

TABLE 36
Experiment 36 Release Result.

| | % Total | Wt. | Application | | |
|---|---|---|---|---|---|
| | Active Con- | Additive | dose | Release | |
| Press # | centration | (g) | (g/m²) | Result | Piks |
| preconditioning | 3.60E+00 | 2.4 | 2.42E+00 | N/A | N/A |
| 1 | 3.60E+00 | 2.4 | 2.42E+00 | Stuck | N/A |
| 2 | 3.60E+00 | 2.4 | 2.42E+00 | Stuck | 5 sm |

In conclusion, the AEPE does not have releasing properties at 2.42E+00 g/m².

### Experiment 37. J37 (Additive: 3% Aqueous NAH2PO4) 2022 Jan. 17

NA

### Experiment 38. J39 (Additive: 3% pH 7 Bnt-E) 2022 Jan. 19

The objective of this experiment is to see the effect of pH on the release performance of bentonite. Therefore, the pH used here is adjusted to 7 using H3PO4 and NaOH.

First, the Bnt-E sample was prepared by the ‘concentrate via rotavap’ method. The pH of the bentonite suspension was 9.23. The pH of the suspension was adjusted to be 7.18 using H3PO4 and NaOH. Next, the aspen strands were prepared by increasing the moisture level to 10% and treated with PM200 pMDI. The SS plate was cleaned by the ‘regular cleaning method.’ In this test, 75% panel was built. Then, the additive was sprayed onto the hot SS plate using the HVLP sprayer, following the hot plate method. About 2.43E+00 g/m² of preconditioning was applied onto the SS plate. Finally, following the ‘Manual Pressing Procedure,’ the reference test was done to obtain the MRD value.

In this experiment, the MRD was observed at 1.52E−01 g/m² using 75% wood panel method. The appearances of the plate and panels were similar to many bentonite experiments done previously; a consolidated bentonite layer was observed, and it was transferred to the wood panel. As the number of presses increased, less dried bentonite layer transfer was observed.

TABLE 38
Experiment 38 Release Result.

| | | Wt. | | |
|---|---|---|---|---|
| | % Total Active | Additive | Application | Release |
| Press # | Concentration | (g) | dose (g/m²) | Result |
| preconditioning | 3.00E+00 | 2.9 | 2.43E+00 | N/A |
| 1 | 3.00E+00 | 2.9 | 2.43E+00 | 0 |
| 2 | 1.50E+00 | 2.9 | 1.22E+00 | 0 |
| 3 | 7.50E−01 | 2.9 | 6.08E−01 | 0 |
| 4 | 3.75E−01 | 2.9 | 3.05E−01 | 0 |
| 5 | 1.88E−01 | 2.9 | 1.52E−01 | 0 |
| 6 | 9.40E−02 | 2.9 | 7.64E−02 | Stuck |
| 7 | 9.40E−02 | 2.0 | 7.64E−02 | 0 |

In conclusion, the MRD of the additive is 1.52E−01 g/m² when its pH is adjusted to 7. This MRD is much higher than when bentonite stock solution was tested with an unadjusted pH of 9 (See Exp 34).

### Experiment 39. J42 (Additive: 3% pH 8.5 Bnt (E)) 2022 Jan. 19

The objective of this experiment is to see the effect of pH on the release performance of Bnt-E. Therefore, the pH is adjusted to 8.5 using H3PO4 and NaOH.

First, the Bnt-E sample was prepared by the ‘concentrate via rotavap’ method. The pH of the concentrated bentonite suspension was 9.23. The pH of such suspension was adjusted to be 8.54 using H3PO4. The aspen strands were prepared by increasing the moisture level to 10% and treated with PM200 pMDI. The SS plate was cleaned by the ‘regular cleaning method.’ In this test, 75% panel was built. Then, the additive was sprayed onto the hot SS plate using the HVLP sprayer, following the hot plate method. About 2.43E+00 g/m² of preconditioning was applied onto the SS plate. Following the ‘Manual Pressing Procedure,’ the reference test was done to obtain the MRD value.

In this experiment, the MRD was observed at 2.43E+00 g/m². This was unexpected as pH 7 adjusted bentonite showed release at 1.52E−01 g/m² (Exp 38), and bentonite suspension that is not adjusted for pH showed release at 2.57E−03 g/m² (Exp 56). These non-releases could be due to the time-dependence of pH or H3PO4 and NaOH reacting with bentonite differently at pH 8. The consolidated bentonite layer was formed, and it was mainly transferred to the wood panel in the first press. On the third press, the wood panel was almost clean.

TABLE 39
Experiment 39 Release Result.

| | | Wt. | | |
|---|---|---|---|---|
| | % Total Active | Additive | Application | Release |
| Press # | Concentration | (g) | dose (g/m²) | Result |
| preconditioning | 3.00E+00 | 2.9 | 2.43E+00 | N/A |
| 1 | 3.00E+00 | 2.9 | 2.43E+00 | 0 |
| 2 | 1.50E+00 | 2.9 | 1.22E+00 | Stuck |
| 3 | 7.50E−01 | 2.9 | 6.08E−01 | stuck |

In conclusion, the MRD of the additive is 2.43E+00 g/m² when pH is at 8.5.

### Experiment 40. J44 (Additive: 3% pH 9.5 Bnt-E) 2022 Jan. 25

The objective of this experiment is to see the effect of pH on the release performance of bentonite. The pH of the additive is adjusted to 9.5 using H3PO4 and NaOH.

First, the Bnt-E sample was prepared by the ‘concentrate via rotavap’ method. The additive was then diluted with 10% NaOH and RO water. The total concentration of the bentonite was 3.0%, and the pH of the suspension was 9.23. Next, the aspen strands were prepared by increasing the moisture level to 10% and treated with PM200 pMDI. The SS plate was cleaned by the ‘regular cleaning method.’ In this test, 75% panel was built. Then, the additive was sprayed onto the hot SS plate using the HVLP sprayer, following the hot plate method. About 2.43E+00 g/m² of preconditioning was applied onto the SS plate. Following the ‘Manual Pressing Procedure,’ the reference test was done to obtain the MRD value.

The bentonite suspension with pH adjusted to 9.5 did not show release in this experiment. This is suspected to be due to the formation of sodium silicate, which is a known sticking agent. More than one press was not done because it is already not usual to see sticking at first press.

TABLE 40
Experiment 40 Release Result.

| | | Wt. | | |
|---|---|---|---|---|
| | % Total Active | Additive | Application | Release |
| Press # | Concentration | (g) | dose (g/m²) | Result |
| preconditioning | 3.00E+00 | 2.9 | 2.43E+00 | N/A |
| 1 | 3.00E+00 | 2.9 | 2.43E+00 | Stuck. |

In conclusion, the release is not observed when the pH of bentonite is adjusted to 9.5 using NaOH, possibly due to the formation of sodium silicate.

### Experiment 41. J38 (Additive: 10% AEPE) 2022 Jan. 25

The objective of this experiment is to see the effect of synergy when AEPE is added to bentonite. This experiment was repeated because there was a controversy about AEPE's releasing result.

First, the AEPE sample was prepared by titrating with 10% NaOH and then diluting it with RO water. The total concentration is 10%, and its pH was 9.38. Next, the aspen strands were prepared by increasing the moisture level to 10% and treated with PM200 pMDI. The SS plate was cleaned by the ‘regular cleaning method.’ In this test, 75% panel was built. Then, the additive was sprayed onto the cold SS plate, following the cold plate spray method. About 4.20E+00 g/m² of preconditioning was applied to the SS plate. Following the ‘Manual Pressing Procedure,’ the reference test was done to obtain the MRD value.

A cold plate method was used in this experiment because AEPE was bouncing off when sprayed onto a hot plate. When AEPE was sprayed on the cold SS plate and heated to 220 C in the oven, the AEPE shrunk as the water dried and left circular marks on the SS plate. Gibbs Marangoni Effect can explain this phenomenon. This observation suggests a possibility of an uneven spray of the additive. The MRD of the AEPE was observed at 4.20E+00 g/m². The circular marks were transferred onto the wood panel after pressing.

TABLE 41
Experiment 41 Release Result.

| | | Wt. | | |
|---|---|---|---|---|
| | % Total Active | Additive | Application | Release |
| Press # | Concentration | (g) | dose (g/m²) | Result |
| preconditioning | 1.00E+01 | 1.5 | 4.20E+00 | N/A |
| 1 | 1.00E+01 | 1.5 | 4.20E+00 | 0 |
| 2 | 5.00E+00 | 1.5 | 2.10E+00 | stuck |

In conclusion, the MRD of AEPE is 4.20E+00 g/m² when tested for cold plate continuous press.

### Experiment 42. J9 (Additive: 0.9% Aqueous Bnt-E Suspension) 2021 Dec. 14

This experiment aims to determine the optimal wood panel mass to increase productivity while observing similar releases as when a full-mat wood panel is made. In this test, 25% wood panel mass was tested (approximately 27 g)

First, the Bnt-E sample was prepared by the ‘fine fraction’ method. The concentration of the additive was 0.9%, and the pH of the additive was 9.40. The aspen strands were prepared by increasing the moisture level to 10% and treating it with PM200 pMDI. The SS plate was cleaned by the ‘regular cleaning method.’ In this test, the wood form was built the same way as when the full-mat was built using 25% of strands mass (˜27 g). Then, the additive was sprayed onto a hot plate without any pre-conditioning. Following the ‘Manual Pressing Procedure,’ the reference test was done to obtain the MRD value.

In this experiment, the MRD of Bnt-E on the 25% panel mass was 7.55E−02 g/m². On the 4th press, a tacky release was observed. When the release was observed, the panels seemed to be stuck onto the bottom plate, leading to force releases when the upper SS plate was removed. Burnt spots were observed on both the front and back of the wood form. A tinted dried bentonite layer was observed, and no dried bentonite layer was transferred to the wood panel due to the low concentration of bentonite being sprayed.

TABLE 42
Experiment 42 Release Result.

| | % Total Active | Wt. Additive | Application | Release |
|---|---|---|---|---|
| Press # | Concentration | (g) | dose (g/m²) | Result |
| 1 | 9.00E−01 | 4.8 | 1.21E+00 | 0 |
| 2 | 4.50E−01 | 4.8 | 6.04E−01 | 0 |
| 3 | 2.25E−01 | 4.8 | 3.02E−01 | 0 |
| 4 | 1.13E−01 | 4.8 | 1.51E−01 | 0 |
| 5 | 5.63E−02 | 4.8 | 7.55E−02 | 0 |
| 6 | 2.81E−02 | 4.8 | 3.78E−02 | stuck |

In conclusion, the MRD of Bnt (E) on the 25% wood panel is 7.55E−02 g/m². The release could have been affected by wood form stuck on the bottom plate.

### Experiment 43. J15 (Additive: 0.9% Aqueous Bnt-E Suspension) 2021 Dec. 16

This experiment aims to determine the optimal wood panel mass to increase productivity while observing similar releases as when a full-mat is used. In this test, 75% wood panel mass was tested (approximately 82 g)

First, the Bnt-E sample was prepared by the ‘Fine fraction’ method. The concentration of the additive was 0.9%, and the pH of the additive was 9.40. The aspen strands were prepared by increasing the moisture level to 10% and treating it with PM200 pMDI. The SS plate was cleaned by the ‘regular cleaning method.’ In this test, the wood form was built the same way as when the full-mat was built using 75% of strands mass (˜82 g). Then, the additive was sprayed onto a hot plate without any pre-conditioning. Following the ‘Manuel Pressing Procedure,’ the reference test was done to obtain the MRD value.

In this experiment, the MRD of Bnt-E on 75% panel mass was 3.02E−01 g/m². On the 3rd press, a tacky release was observed. A tinted dried bentonite layer was observed on the SS plate. Due to the low concentration of bentonite being sprayed, no dried bentonite layer was transferred to the wood panel. Compared to the 25% panel mass experiment (Exp-42), the MRD was four times higher, but cleaner wood panels were made. Also, the wood panel was not stuck onto the bottom plate, suggesting that 75% panel mass is more likely to provide accurate data than 25% panel mass.

TABLE 43
Experiment 43 Release Result.

| | % Total Active | Wt. Additive | Application | Release |
|---|---|---|---|---|
| Press # | Concentration | (g) | dose (g/m²) | Result |
| 1 | 9.00E−01 | 4.8 | 1.21E+00 | 0 |
| 2 | 4.50E−01 | 4.8 | 6.04E−01 | 0 |
| 3 | 2.25E−01 | 4.8 | 3.02E−01 | 0 |
| 4 | 1.13E−01 | 4.8 | 1.51E−01 | stuck |
| 5 | 1.13E−01 | 4.8 | 1.51E−01 | stuck |

In conclusion, the MRD of Bnt (E) on the 75% wood panel is 3.02E−01 g/m².

### Experiment 44. J20 (Additive: 0.9% Aqueous Bnt-E Suspension) 2021 Dec. 20

This experiment aims to determine the optimal wood panel mass to increase productivity while observing similar releases as when a full-mat is used. 100% wood panel mass was tested (approximately 110 g).

First, the Bnt-E sample was prepared by the ‘Fine fraction’ method. The additive was 0.9% active, and the pH was 9.40. The aspen strands were prepared by increasing the moisture level to 10% and treating it with PM200 pMDI. The SS plate was cleaned by the ‘regular cleaning method.’ In this test, a full-mat was built. Then, the additive was sprayed onto a hot plate without any pre-conditioning. Following the ‘Manuel Pressing Procedure,’ the reference test was done to obtain the MRD value.

In this experiment, the MRD of Bnt-E on a full-mat panel was 3.02E−01 g/m². Both 4th and 5th presses didn't show release, but the panel was easily removed from the SS top plate by tapping on the table. A tinted dried bentonite layer was observed on the SS plate, and no dried bentonite layer was transferred to the wood panel, possibly due to the low concentration of bentonite sprayed. The MRD of full-mat was the same as the 75% panel mass experiment (Exp-43). This finding supports that the 75% panel mass shows the most representable result as 100% panel mass.

TABLE 44
Experiment 44 Release Result.

| | % Total Active | Wt. Additive | Application | Release |
|---|---|---|---|---|
| Press # | Concentration | (g) | dose (g/m²) | Result |
| 1 | 9.00E−01 | 4.8 | 1.21E+00 | 0 |
| 2 | 4.50E−01 | 4.8 | 6.04E−01 | 0 |
| 3 | 2.25E−01 | 4.8 | 3.02E−01 | 0 |
| 4 | 1.13E−01 | 4.8 | 1.51E−01 | stuck |
| 5 | 1.13E−01 | 4.8 | 1.51E−01 | stuck |

In conclusion, the MRD of Bnt-E on the 100% wood panel is 3.02E−01 g/m². The 75% panel mass would be an excellent option for getting the most representative data and increasing productivity.

### Experiment 45. J66 (Additive: 10% Y2+2.73% Bnt-E) 2022 Mar. 2

The objective of this experiment is to determine the MRD of the additive when tested for a multi-opening press.

First, the Bnt-E sample was prepared by the ‘concentrate via rotavap’ method. The additive was 3.83% active with a pH of 8.97. The Bnt-E solution was then diluted from 34.948% Y2 to 10%. The total concentration was 12.73%, and the additive's pH was 8.42. The aspen strands were prepared by increasing the moisture level to 10% and treating it with PM200 pMDI. The SS plate was cleaned by the ‘regular cleaning method.’ In this test, 75% panels were built. Then, the additive was sprayed onto the wood panel using the HVLP sprayer, following the multi-opening test procedure. About 1.21E+01 g/m² of preconditioning was applied to the wood panel, and the additive-treated panel was rested for 2 minutes. Then the first spray was made. The additive-treated panel rested for 2 minutes before pressing in every press. Following the ‘Manuel Pressing Procedure,’ the reference test was done to obtain the MRD value.

In this experiment, the MRD of the additive was 7.50E−01 g/m². Throughout the experiment, many piks were observed on the MS plate. The outer edge of the panel that was in contact with the plate showed the highest amount of piks. These piks were more evident at the lower concentration, where it started to show tacky releases and sticking. Also, a brown liquid-textured streak was observed on the MS plate, and a darkening of the MS plate was observed. This is suspected to be due to the corrosion of the MS plate. Finally, the wood panel showed many burnt spots near the center, which could be due to the reduced panel mass used.

TABLE 45
Experiment 45 Release Result.

| | | | | Wt. | application | | |
|---|---|---|---|---|---|---|---|
| Press | | | % Total Active | Additive | dose | Release | |
| # | % Y2 | % Bnt 03 | Concentration | (g) | (g/m²) | Result | Piks |
| PC | 1.00E+01 | 2.73E+00 | 1.27E+01 | 3.01 | 1.21E+01 | — | — |
| 1 | 1.00E+01 | 2.73E+00 | 1.27E+01 | 3.02 | 1.21E+01 | 0 | — |
| 2 | 1.00E+01 | 2.73E+00 | 1.27E+01 | 3.03 | 1.22E+01 | 0 | — |
| 3 | 5.00E+00 | 1.37E+00 | 6.35E+00 | 3.37 | 6.77E+00 | 0 | 1 md |
| 4 | 2.50E+00 | 6.83E−01 | 3.18E+00 | 3.01 | 3.02E+00 | 0 | — |
| 5 | 1.25E+00 | 3.41E−01 | 1.59E+00 | 3.12 | 1.56E+00 | 0 | 1 md |
| 6 | 6.25E−01 | 1.71E−01 | 7.94E−01 | 3.00 | 7.50E−01 | 0 | >5 sm |
| 7 | 3.13E−01 | 8.53E−02 | 3.97E−01 | 3.04 | 3.80E−01 | stuck | — |
| 8 | 1.56E−01 | 4.27E−02 | 1.98E−01 | 3.12 | 1.95E−01 | stuck | >5 sm |

The Bnt-to-Y2 ratio is 0.0273/0.1=0.273. The Y2-to-total active ratio is 0.1/0.127=0.787. The bentonite-to-total active ratio is 1−0.787=0.213. The MRD of Y2 is 7.50E−01*0.787=5.903E−01 g/m², when its PCD is 1.21 E+01*0.787=9.523 g/m². The bentonite's MRD is 7.50E−01*0.213=1.598E−01 g/m², when its PCD is 1.21E+01*0.213=3.119 g/m². The MRD of additive is 7.50E−01 g/m² when tested for multi-opening press.

### Experiment 46. J67 (Additive: 10% Y2) 2022 Mar. 3

The objective of this experiment is to determine the MRD of the 10% Y2 when tested for multi-opening press and compare it to Exp-45.

First, the Y2 sample was diluted to 10% with RO water from 34.95%. The pH of the additive was 8.49. Next, the aspen strands were prepared by increasing the moisture level to 10% and treating it with PM200 pMDI. Next, the SS plate was cleaned by the ‘regular cleaning method.’ In this test, 75% panels were built. Then, the additive was sprayed onto the wood panel using the HVLP sprayer, following the multi-opening test procedure. About 1.01 E+01 g/m² of preconditioning was applied to the wood panel, and the additive-treated panel was rested for 2 minutes. Then, the first spray was made. The additive-treated panel rested for 2 minutes before pressing in every press. Following the ‘Manuel Pressing Procedure,’ the reference test was done to obtain the MRD value.

In this experiment, the MRD of the additive was calculated to be 4.93E+00 g/m², which is a much higher value than Exp-45. There were few piks observed, and a darkening of the MS plate was observed. The darkening was suspected to be due to the corrosion of the MS plate. The wood panel showed many burnt spots near the center, which could be due to reduced panel mass used instead of full-mat. The appearance of the MS plate and the wood panel were similar to Exp-45.

TABLE 46
Experiment 46 Release Result.

| | % Total | Wt. | | | |
|---|---|---|---|---|---|
| Press | Active | Additive | application | Releasing | |
| # | Concentration | (g) | dose (g/m²) | force (N) | Piks |
| PC | 1.00E+01 | 3.20 | 1.01E+01 | — | — |
| 1 | 1.01E+02 | 3.00 | 9.49E+00 | 0 | — |
| 2 | 1.00E+01 | 3.00 | 9.49E+00 | 0 | — |
| 3 | 5.00E+00 | 3.12 | 4.93E+00 | 0 | 1 md |
| 4 | 2.50E+00 | 3.02 | 2.39E+00 | stuck | — |
| 5 | 1.25E+00 | 3.40 | 1.34E+00 | stuck | 1 md |

In conclusion, the MRD of additive is 4.93E+00 g/m² when tested for the multi-opening press.

### Experiment 47. J69 (Additive: 12.7% Y2) 2022 Mar. 4

The objective of this experiment is to determine the MRD of the 12.7% Y2 when tested for multi-opening press and compare the value with Exp-45.

First, the Y2 sample was diluted to 12.7% with RO water from 34.95%. The pH of the additive was 8.50. Next, the aspen strands were prepared by increasing the moisture level to 10% and treating it with PM200 pMDI. Next, the MS plate was cleaned by the ‘regular cleaning method.’ In this test, 75% panels were built. Then, the additive was sprayed onto the wood panel using the HVLP sprayer, following the multi-opening test procedure. About 1.32E+01 g/m² of preconditioning was applied to the wood panel, and the additive-treated panel rested for 2 minutes. Then the first spray was made. The additive-treated panel rested for 2 minutes before pressing in every press. Following the ‘Manuel Pressing Procedure,’ the reference test was done to obtain the MRD value.

In this experiment, the calculated MRD of the additive was 1.50E+00 g/m², which is similar to the Exp-45 result. There were few piks observed, and darkening of the MS plate was also observed. The darkening was suspected to be due to the corrosion of the MS plate. The wood panel showed many burnt spots near the center, which could be due to reduced panel mass used instead of full-mat. The appearances of the MS plate and the wood panel were similar to Exp-45.

TABLE 47
Experiment 47 Release Result.

| Press | % Total Active | Wt. | application | Releasing | |
|---|---|---|---|---|---|
| # | Concentration | Additive (g) | dose (g/m²) | force (N) | Piks |
| PC | 1.27E+01 | 3.28 | 1.32E+01 | — | — |
| 1 | 1.27E+01 | 2.88 | 1.16E+01 | 0 | — |
| 2 | 1.27E+01 | 3.11 | 1.25E+01 | 0 | — |
| 3 | 6.35E+00 | 3.05 | 6.13E+00 | 0 | 1 lg |
| 4 | 3.18E+00 | 3.30 | 3.31E+00 | 0 | — |
| 5 | 1.59E+00 | 3.00 | 1.50E+00 | 0 | — |
| 6 | 7.94E−01 | 3.10 | 7.75E−01 | stuck | — |
| 7 | 3.97E−01 | 3.08 | 3.80E−01 | stuck | 1 md |

In conclusion, the MRD of additive is 1.50E+00 g/m² when tested for multi-opening press.

### Experiment 48. J72 (Additive: 10% Y2+2.73% Bnt-E) 2022 Mar. 8

The objective of this experiment is to replicate the result from Exp-45.

First, the additive tested in this experiment was the same sample as Exp-45 (J66). The aspen strands were prepared by increasing the moisture level to 10% and treating it with PM200 pMDI. The MS plate was cleaned by the ‘regular cleaning method.’ In this test, 75% panels were built. Then, the additive was sprayed onto the wood panel using the HVLP sprayer, following the multi-opening test procedure. About 1.25E+01 g/m² of preconditioning was applied to the wood panel, and the additive-treated panel was rested for 2 minutes. Then the first spray was made. The additive-treated panel rested for 2 minutes before pressing in every press. By following the ‘Manuel Pressing Procedure,’ the reference test was done to obtain the MRD value

The MRD of the additive ranges from 1.64E+00 g/m² to 3.79E−01 g/m². On the 6th press, about 1.7 g of additive was sprayed accidentally and didn't release. However, on the 7th press, it showed release. This suggests that applying a higher amount maybe leads to sticking issues, possibly due to water or one component working as a sticking agent. There were few piks observed, and a darkening of the MS plate was observed. The darkening was suspected to be due to the corrosion of the MS plate. The wood panel showed many burnt spots near the center, which could be due to reduced panel mass used instead of a full mat. The appearance of the MS plate and the wood panel was similar to Exp-45.

TABLE 48
Experiment 48 Release Result.

| | | | | Wt. | application | Releasing | |
|---|---|---|---|---|---|---|---|
| Press | | | % Total Active | Additive | dose | force | |
| # | % Y2 | % Bnt-E | Concentration | (g) | (g/m²) | (N) | Piks |
| PC | 1.00E+01 | 2.73E+00 | 1.27E+01 | 3.12 | 1.25E+01 | — | — |
| 1 | 1.00E+01 | 2.73E+00 | 1.27E+01 | 2.92 | 1.17E+01 | 0 | 1 md |
| 2 | 1.00E+01 | 2.73E+00 | 1.27E+01 | 3.21 | 1.29E+01 | 0 | — |
| 3 | 5.00E+00 | 1.37E+00 | 6.35E+00 | 3.08 | 6.19E+00 | 0 | 1 md, 1 lg |
| 4 | 2.50E+00 | 6.83E−01 | 3.18E+00 | 3.11 | 3.12E+00 | 0 | — |
| 5 | 1.25E+00 | 3.41E−01 | 1.59E+00 | 3.28 | 1.64E+00 | 0 | — |
| 6 | 6.25E−01 | 1.71E−01 | 7.94E−01 | 4.73 | 1.18E+00 | stuck | — |
| 7 | 3.13E−01 | 8.53E−02 | 3.97E−01 | 3.03 | 3.79E−01 | 0 | — |
| 8 | 1.56E−01 | 4.27E−02 | 1.98E−01 | 3.13 | 1.96E−01 | stuck | — |

The Bnt-to-Y2 ratio is 0.0273/0.1=0.273. The Y2 to total solid ratio is 0.1/0.127=0.787. The Bnt-to-total solid ratio is 1−0.787=0.213. The MRD of Y2 is 0.787*1.64E+00 g/m²=1.291 g/m² when its PCD is 1.25E+01*0.787=9.838 g/m². The bentonite's MRD is 1.64*0.213=3.493E−01 g/m², when its PCD is 0.213*1.25E+01=2.663 g/m². In conclusion, the MRD of the total additive ranges from 1.64E+00 g/m² to 3.79E−01 g/m² when tested for multi-opening press.

### Experiment 49. P103C (Additive: 5% Hydroxyapatite in 1% PS-5 2021 Dec. 6

### Solution

The objective of this experiment is to observe the releasing performance of hydroxyapatite.

In this experiment, the additive was prepared by dispersing hydroxyapatite powder in a 1% PS-5 solution and stirred overnight. The aspen strands were prepared by increasing the moisture level to 10% and treating it with PM200 pMDI. The SS plate was cleaned by the ‘regular cleaning method.’ In this test, the wood form was built in two different ways. The first press was done on 50% wood panel mass, whereas the rest of the presses were done on the full-mat method. Then, the additive was sprayed onto a hot plate without any pre-conditioning. By following the ‘Manuel Pressing Procedure,’ the releasing property of the hydroxyapatite was tested.

The experiment shows that the additive does not show any release properties when 4.74E+00 g/m² is applied. Also, extensive strands were stuck on the SS plates (Press 1 and 2). To see whether this is due to the hydroxyapatite, the PS-5 was tested for releasing performance alone (Press 3 and 4). Although the PS-5 did not show any releases, it made a cleaner SS plate (i.e., no piks) and wood panel than hydroxyapatite mixed in PS-5. This supports that the piks observed on presses 1 and 2 could be due to the hydroxyapatite, which leads to the panel sticking to the SS plate.

TABLE 49
Experiment 49 Release Result.

| | | | % | | Wt. | application | Releasing | |
|---|---|---|---|---|---|---|---|---|
| Press | | % PS-5 | Hydroxyapatite | % Total Active | Additive | dose | force | |
| # | Additive | concentration | concentration | Concentration | (g) | (g/m²) | (N) | Piks |
| 1 | P103C | 9.50E−01 | 5.00E−00 | 5.95E−00 | 3.00 | 4.74E+00 | stuck | 1 ex-Lg |
| 2 | | 9.50E−01 | 5.00E−00 | 5.95E−00 | 3.00 | 4.74E+00 | stuck | 4 Lg |
| 3 | PS-5 | 5.00E−00 | N/A | 5.00E−00 | 3.00 | 4.74E+00 | stuck | — |
| 4 | | 1.00E−00 | N/A | 1.00E−00 | 3.00 | 9.49E−01 | stuck | — |

The ratio of Hydroxyapatite to PS-5 is 0.05/0.0095=5.26. The ratio of PS-5 to total solid is 0.0095/0.0595=0.16. The ratio of Hydroxyapatite to total solid is 0.84. The Hydroxyapatite's MRD>3.98 g/m². In conclusion, hydroxyapatite does not have any releasing property within the concentration range studied.

### Experiment 50. J73 (Additive: 10.0% Bioterge AS-40+2.7% Bnt-E) 2022 Mar. 11

This experiment aims to see a synergy of Bioterge AS-40 and bentonite-E mixture for the multi-opening press.

First, the Bnt-E sample was prepared by the ‘concentrate via rotavap’ method. The additive was measured to be 3.83% active. The Bnt-E solution was then used to dilute pH corrected 40% Bioterge AS-40 to 10%. The total concentration of the additive was calculated to be 12.7%. The pH of the additive was 9.01. The aspen strands were prepared by increasing the moisture level to 10% and treated with PM200 pMDI. The MS plate was cleaned by the ‘regular cleaning method.’ In this test, 75% panels were built. Then, the additive was sprayed onto the wood panel using the HVLP sprayer, following the multi-opening test procedure. About 1.10E+01 g/m² of preconditioning was applied to the wood panel, and the additive-treated panel was rested for 2 minutes. Then the first spray of 1.12E+01 g/m² was made. The panel was rested for 2 minutes after spraying the additive and before pressing. Following the ‘Manual Pressing Procedure,’ the reference test was done to obtain the MRD value.

The experiment shows that the additive does not release. However, the release was easier on the second press, suggesting it might show release at a higher concentration. On the MS plate, there were burnt spots, white spots, and some piks were observed. The white spots on the MS plate were unusual when testing bentonite as a releasing agent. This might mean that the formation of white spots is due to the Bioterge AS-40. Every panel showed burnt spots, mainly in the center.

TABLE 50
Experiment 50 Release Result.

| | | | | Wt. | Application | releasing |
|---|---|---|---|---|---|---|
| Press | | | % Total Active | Additive | dose | force |
| # | % AS 40 | % Bnt-E | Concentration | (g) | (g/m²) | (N) |
| PC | 1.00E+01 | 2.70E+00 | 1.27E+01 | 3.10 | 1.10E+01 | — |
| 1 | 1.00E+01 | 2.70E+00 | 1.27E+01 | 3.14 | 1.12E+01 | stuck |
| 2 | 1.00E+01 | 2.70E+00 | 1.27E+01 | 3.07 | 1.09E+01 | stuck |

The bentonite-to-AS 40 ratio is 0.027/0.1=0.27. The ratio of AS 40-to-total active is 0.1/0.127=0.79. The ratio of bentonite to total active is 0.21. The MRD ratio is not calculated, as there is no release observed. When the ratio of bentonite to AS 40 ratio is 0.27, the MRD of bentonite>2.35E+00 g/m² at the bentonite's PCD of 2.31 g/m². In conclusion, the 12.7% sulfonate and bentonite mixture do not show any releasing property.

### Experiment 51. J77 (Additive: 12.7% Bioterge AS-40) 2022 Mar. 11

The objective of this experiment is to test the release performance of Bioterge AS-40 alone and compare its value to the Exp-50.

The bioterge AS-40 was first mixed with 10% NaOH to correct the pH to 9.05. Then they were further diluted with RO water. The final pH of the additive was 9.22, and the total concentration of the additive was 12.7%. The aspen strands were prepared by increasing the moisture level to 10% and treated with PM200 pMDI. The MS plate was cleaned by the ‘regular cleaning method.’ In this test, 75% panels were built. Then, the additive was sprayed onto the wood panel using the HVLP sprayer, following the multi-opening test procedure. About 1.07E+01 g/m² of preconditioning was applied to the wood panel, and the additive-treated panel was rested for 2 minutes. Then the first spray was made. The additive-treated panel rested for 2 minutes before pressing in every press. Following the ‘Manual Pressing Procedure,’ the reference test was done to obtain the MRD value.

The experiment shows that the additive does not release when 1.07E+01 g/m² is applied. However, the release was easier on the second press, suggesting it might show release at a higher concentration. On the MS plate, there were dark spots and white spots. The darkening of the MS plate might indicate corrosion of the metal plate. The white spots observed in this experiment support that the white spots observed in Exp-50 are due to Bioterge AS-40. Every panel showed burnt spots, mainly in the center.

TABLE 51
Experiment 51 Release Result.

| Press | % Total Active | Wt. Additive | Application | releasing |
|---|---|---|---|---|
| # | Concentration | (g) | dose (g/m²) | force (N) |
| PC | 1.27E+01 | 3.00 | 1.07E+01 | — |
| 1 | 1.27E+01 | 3.00 | 1.07E+01 | stuck |
| 2 | 1.27E+01 | 2.98 | 1.06E+01 | stuck |

In conclusion, the additive does not show releasing the property.

### Experiment 52. J82 (Additive: 40% Bioterge AS-40) 2022 Mar. 14

The objective of this experiment is to see the release property of Bioterge AS-40 alone when tested for the multi-opening press.

The Bioterge AS-40 provided by the manufacturer was 40% active. Hence, a small amount of 10% of NaOH was added to correct the pH to 9.04. The total active concentration of the sample is 39.9%. The aspen strands were prepared by increasing the moisture level to 10% and treated with PM200 pMDI. The MS plate was cleaned by the ‘regular cleaning method.’ In this test, 75% panels were built. Then, the additive was sprayed onto the wood panel using the HVLP sprayer, following the multi-opening test procedure. About 3.85E+01 g/m² of preconditioning was applied to the wood panel, and the additive-treated panel rested for 2 minutes. Then, the first spray was made. The additive-treated panel rested for 2 minutes before pressing in every press. Following the ‘Manual Pressing Procedure,’ the reference test was done to obtain the MRD value.

The experiment shows that the additive does release properties when applied at a high application dose. The MRD of the additive was 1.90E+01 g/m². On the MS plate, there were dark spots and white spots. The darkening of the MS plate might suggest corrosion of the metal plate. The white spots are possibly due to the foam formation during the press cycle. The foam was evident, especially when 40% active additive was sprayed; however, it was less evident when 20% or less active additive was sprayed. At the end of the press cycle, the foam turned into a powder. Every panel showed burnt spots, mainly in the center.

TABLE 52
Experiment 52 Release Result.

| Press | % Total Active | Wt. Additive | Application | releasing |
|---|---|---|---|---|
| # | Concentration | (g) | dose (g/m²) | force (N) |
| PC | 4.00E+01 | 3.04 | 3.85E+01 | — |
| 1 | 4.00E+01 | 3.07 | 3.88E+01 | 0 |
| 2 | 4.00E+01 | 3.00 | 3.80E+01 | 0 |
| 3 | 2.00E+01 | 3.00 | 1.90E+01 | 0 |
| 4 | 1.00E+01 | 3.11 | 9.84E+00 | stuck |
| 5 | 5.00E+00 | 3.35 | 5.30E+00 | stuck |

In conclusion, the Bioterge AS-40 shows releasing property at a high dosage. Its MRD value is 1.90E+01 g/m². The foam formation could be the reason why it shows release.

### Experiment 53. J80 (Additive: 20% Bioterge AS-40) 2022 Mar. 11

The objective of this experiment is to obtain the MRD value of Bioterge AS-40 alone when tested for the multi-opening press.

The Bioterge AS-40 provided by the manufacturer was 40% active. A small amount of 10% of NaOH was added to increase the pH to 9.40; then, they were further diluted to 20% with RO water. The aspen strands were prepared by increasing the moisture level to 10% and treated with PM200 pMDI. The MS plate was cleaned by the ‘regular cleaning method.’ In this test, 75% panels were built. Then, the additive was sprayed onto the wood panel using the HVLP sprayer, following the multi-opening test procedure. About 2.11E+01 g/m² of preconditioning was applied to the wood panel, and the additive treated panel rested for 2 minutes. Then the first spray was made. The additive sprayed panel rested for 2 minutes before pressing in every press. Following the ‘Manual Pressing Procedure,’ the reference test was done to obtain the MRD value.

The experiment shows that the release does not occur when 1.94E+01 g/m² is applied. On the MS plate, there were dark spots suspected to be due to corrosion. The white spots and foaming were not as evident as Exp-52, due to applying a lower additive concentration. There were burnt spots on the center of the panels.

TABLE 53
Experiment 53 Release Result.

| Press | % Total Active | Wt. Additive | application | releasing |
|---|---|---|---|---|
| # | Concentration | (g) | dose (g/m²) | force (N) |
| PC | 2.00E+01 | 3.33 | 2.11E+01 | — |
| 1 | 2.00E+01 | 3.07 | 1.94E+01 | stuck |
| 2 | 2.00E+01 | 3.12 | 1.97E+01 | stuck |

In conclusion, the MRD of the additive must be greater than 2.11E+01 g/m².

### Experiment 54. J84 (Additive: 17% Bioterge AS-40+3% Bnt-E) 2022 Mar. 16

This experiment aims to see the synergy between bioterge AS-40 with Bnt-E in the multi-opening press.

The bentonite-E was prepared by concentrating the fine fraction of the bentonite suspension with the rotavapor. The measured concentration of the concentrated Bnt-E was 7.63%. The Bioterge AS-40 provided by the manufacturer was 40% active. A small amount of 10% of NaOH was added to the Bioterge AS-40 to increase the pH to 9.27. Then, they were further diluted with Bnt-E and RO water. The total concentration was 20% (17% bioterge AS-40+3% Bnt-E), and the pH of the additive was 9.12. The aspen strands were prepared by increasing the moisture level to 10% and treated with PM200 pMDI. The MS plate was cleaned by the ‘regular cleaning method.’ In this test, 75% panels were built. Then, the additive was sprayed onto the wood panel using the HVLP sprayer, following the multi-opening test procedure. About 1.80E+01 g/m² of preconditioning was applied to the wood panel, and the additive-treated panel was rested for 2 minutes. Then the first spray was made. The additive-treated panel was rested for 2 minutes before pressing in every press. Following the ‘Manual Pressing Procedure,’ the reference test was done to obtain the MRD value.

The experiment shows that the MRD of the additive is 5.33E0-1 g/m². Compared to Exp-53, the MRD of 17% Bioterge AS-40 with 3% Bnt-E is much lower. The MRD is also lower than Exp-52, where preconditioning is about twice higher than in this experiment, and the MRD is 1.90E+01 g/m². On the MS plate, there was a bit of darkening, which might be due to the corrosion of the metal. There were also piks observed, especially on the last two presses where sticking was observed. On the surface of the wood panel, a nice coating was made. The first two presses showed darker panels than the other ones, possibly due to the higher application doses applied.

TABLE 54
Experiment 54 Release Result.

| | | | | Wt. | application | Releasing |
|---|---|---|---|---|---|---|
| Press | | | % Total Active | Additive | dose | force |
| # | % AS 40 | % Bnt-E | Concentration | (g) | (g/m²) | (N) |
| PC | 1.70E+01 | 3.00E+00 | 2.00E+01 | 3.22 | 1.80E+01 | — |
| 1 | 1.70E+01 | 3.00E+00 | 2.00E+01 | 3.17 | 1.77E+01 | 0 |
| 2 | 1.70E+01 | 3.00E+00 | 2.00E+01 | 3.09 | 1.73E+01 | 0 |
| 3 | 8.50E+00 | 1.50E+00 | 1.00E+01 | 3.03 | 8.48E+00 | 0 |
| 4 | 4.25E+00 | 7.50E−01 | 5.00E+00 | 3.37 | 4.71E+00 | 0 |
| 5 | 2.13E+00 | 3.75E−01 | 2.50E+00 | 3.12 | 2.18E+00 | 0 |
| 6 | 1.06E+00 | 1.88E−01 | 1.25E+00 | 3.13 | 1.09E+00 | 0 |
| 7 | 5.31E−01 | 9.38E−02 | 6.25E−01 | 3.05 | 5.33E−01 | 0 |
| 8 | 2.66E−01 | 4.69E−02 | 3.13E−01 | 3.27 | 2.86E−01 | stuck |
| 9 | 1.33E−01 | 2.34E−02 | 1.56E−01 | 3.01 | 1.32E−01 | stuck |

The Bnt-to-AS-40 ratio is 0.03/0.17=0.18. The AS-40-to-total solid ratio is 17/20=0.85. The bentonite to total solid ratio is 0.15. The MRD of AS-40 is 5.33E−1*0.85=4.53E−01 g/m² when the PCD of AS-40 is 1.80E+01*0.85=1.53E+01 g/m².

In conclusion, the MRD of the additive is 5.33E0-1 g/m², and it indicates that bentonite might be helping the release of Bioterge AS-40.

### Experiment 55. J85 (Additive: 3% Bnt-E) 2022 Mar. 18

The objective of this experiment is to examine the release performance of Bnt-E in the Multi-opening testing.

The bentonite-E was prepared by concentrating the fine fraction of bentonite suspension with the rotavapor. The concentrated bentonite-E was further diluted with RO water. The measured concentration of Bnt-E was 3.0%, and its pH was 9.08. The aspen strands were prepared by increasing the moisture level to 10% and treated with PM200 pMDI. The MS plate was cleaned by the ‘regular cleaning method.’ In this test, 75% panels were built. Then, the additive was sprayed onto the wood panel using the HVLP sprayer, following the multi-opening test procedure. About 3.02E+00 g/m² of preconditioning was applied to the wood panel, and the additive treated panel was rested for 2 minutes. Then the first spray was made. The additive sprayed panel was rested for 2 minutes before pressing in every press. Following the ‘Manual Pressing Procedure,’ the reference test was done to obtain the MRD value.

The experiment shows that releases cannot be observed when 3.02E+00 g/m² of bentonite is applied. The experiment ended only after the first press because it was stuck hard (i.e., it required significantly higher force to remove the panel using a scraper.) When the panel was removed with force, there were many piks of different sizes stuck to the MS plate, suggesting how stuck the panel was. Dark spots were observed on the MS plate, which is suspected of corrosion.

TABLE 55
Experiment 55 Release Result.

| Press | % Total Active | Wt. Additive | application | Releasing |
|---|---|---|---|---|
| # | Concentration | (g) | dose (g/m²) | force (N) |
| PC | 3.00E−00 | 3.19 | 3.02E+00 | — |
| 1 | 3.00E−00 | 3.07 | 2.92E+00 | stuck |

In conclusion, the release was not observed when 3.00E00 g/m² of Bnt-E was applied for the multi-opening press testing.

### Experiment 56. J86 (Additive: 3% Bnt-E) 2022 Mar. 22

The objective of this experiment is to examine the release performance of Bnt-E in Continuous testing.

The bentonite-E was prepared by concentrating the fine fraction of bentonite suspension with the rotavapor. The concentrated bentonite-E was further diluted with RO water. The measured concentration of the Bnt-E was 3.0%, and the pH was 9.08. The aspen strands were prepared by increasing the moisture level to 10% and treated with PM200 pMDI. The SS plate was cleaned by the ‘regular cleaning method.’ In this test, 75% panels were built. Then, the additive was sprayed onto the hot SS plate using the HVLP sprayer, following the hot plate method. About 2.75E+00 g/m² of preconditioning was applied to the hot plate. Following the ‘Manual Pressing Procedure,’ the reference test was done to obtain the MRD value.

The experiment shows that the MRD of the Bnt-E in continuous testing is 2.69E−03 g/m². There were no piks observed in this experiment. The dried bentonite layer was formed at a high concentration and started fading as the number of presses increased.

TABLE 56
Experiment 56 Release Result.

| Press | % Total Active | Wt. Additive | application | Releasing |
|---|---|---|---|---|
| # | Concentration | (g) | dose (g/m²) | force (N) |
| PC | 3.00E+00 | 2.9 | 2.75E+00 | — |
| 1 | 3.00E+00 | 2.9 | 2.75E+00 | 0 |
| 2 | 1.50E+00 | 2.9 | 1.38E+00 | 0 |
| 3 | 7.50E−01 | 2.9 | 6.88E−01 | 0 |
| 4 | 3.75E−01 | 2.9 | 3.44E−01 | 0 |
| 5 | 1.88E−01 | 2.9 | 1.72E−01 | 0 |
| 6 | 9.38E−02 | 2.9 | 8.60E−02 | 0 |
| 7 | 4.69E−02 | 2.9 | 4.30E−02 | 0 |
| 8 | 2.34E−02 | 2.9 | 2.15E−02 | 0 |
| 9 | 1.17E−02 | 2.9 | 1.08E−02 | 0 |
| 10 | 5.86E−03 | 2.9 | 5.38E−03 | 0 |
| 11 | 2.93E−03 | 2.9 | 2.69E−03 | 0 |
| 12 | 1.46E−03 | 2.9 | 1.34E−03 | stuck |

In conclusion, the MRD of the additive in continuous testing is 2.69E−03 g/m².

### Experiment 57. J90 (Additive: 2.57% Bnt-E+0.43% SHMP) 2022 Mar. 24

This experiment aims to examine the release performance of Bnt-E and SHMP suspension in continuous press testing.

The bentonite-E was prepared by concentrating the fine fraction of bentonite suspension with the rotavapor. And 2% SHMP solution was made with RO water, and its pH was 6.25. The bentonite E suspension was then diluted with 2% SHMP solution and RO water to achieve 2.57% Bnt-E+0.43% SHMP solution. The total concentration of the additive was 3.0%, and its pH was 6.97. The aspen strands were prepared by increasing the moisture level to 10% and treated with PM200 pMDI. The SS plate was cleaned by the ‘regular cleaning method.’ In this test, 75% panels were built. Then, the additive was sprayed onto the hot SS plate using the HVLP sprayer, following the hot plate method. About 2.75E+00 g/m² of preconditioning was applied to the hot plate. Following the ‘Manual Pressing Procedure,’ the reference test was done to obtain the MRD value.

The experiment shows that the MRD of the Bnt-E with SHMP suspension in continuous testing is 2.69E−03 g/m². There were stickings observed on the 3rd and 7th press. The reason for sticking on the 3rd press is unknown, but the sticking on the 7th press is due to the sprayer issue. There were no piks observed in this experiment. The dried bentonite layer was formed at a high concentration on the SS plate and started fading as the number of presses increased. In press 1 and 2, the dried bentonite layer was transferred from the SS plate to the wood panel, but the dried bentonite layer was invisible from the 3rd press until the last press.

TABLE 57
Experiment 57 Release Result.

| | | | | Wt. | Application | Releasing |
|---|---|---|---|---|---|---|
| Press | | | % Total Active | Additive | dose | force |
| # | % SHMP | % Bnt04 (A) | Concentration | (g) | (g/m²) | (N) |
| PC | 4.30E−01 | 2.57E+00 | 3.00E+00 | 2.9 | 2.75E+00 | — |
| 1 | 4.30E−01 | 2.57E+00 | 3.00E+00 | 2.9 | 2.75E+00 | 0 |
| 2 | 2.15E−01 | 1.29E+00 | 1.50E+00 | 2.9 | 1.38E+00 | 0 |
| 3 | 1.08E−01 | 6.43E−01 | 7.50E−01 | 2.9 | 6.88E−01 | stuck |
| 4 | 5.38E−02 | 3.21E−01 | 3.75E−01 | 2.9 | 3.44E−01 | 0 |
| 5 | 2.69E−02 | 1.61E−01 | 1.88E−01 | 2.9 | 1.72E−01 | 0 |
| 6 | 1.34E−02 | 8.03E−02 | 9.38E−02 | 2.9 | 8.60E−02 | 0 |
| 7 | 6.72E−03 | 4.02E−02 | 4.69E−02 | 2.9 | 4.30E−02 | stuck |
| 8 | 3.36E−03 | 2.01E−02 | 2.34E−02 | 2.9 | 2.15E−02 | 0 |
| 9 | 1.68E−03 | 1.00E−02 | 1.17E−02 | 2.9 | 1.08E−02 | 0 |
| 10 | 8.40E−04 | 5.02E−03 | 5.86E−03 | 2.9 | 5.38E−03 | 0 |
| 11 | 4.20E−04 | 2.51E−03 | 2.93E−03 | 2.9 | 2.69E−03 | 0 |
| 12 | 2.10E−04 | 1.25E−03 | 1.46E−03 | 2.9 | 1.34E−03 | stuck |

In conclusion, in the continuous testing, the mixed additive's MRD is 2.69E−03 g/m²; the bentonite's MRD is 2.31E−03 g/m²; the Bnt-to SHMP ratio is 5.98. The Bnt PCD is 2.36 g/m². The Bnt-to-total ratio=0.857.

### Experiment 58. J48 (Additive: 1.5% Bnt-E+1.5% Bioterge AS-40 2022 Feb. 4 Suspension)

This experiment examines the release performance of Bnt-E and Bioterge AS-40 suspension in continuous press testing on a cold plate.

The bentonite-E was prepared by concentrating the fine fraction of bentonite suspension with the rotavapor. The concentrated bentonite was diluted from 4.81% to 3% with RO water. The Bioterge AS-40 was prepared by first adjusting the pH with NaOH. It was first diluted with RO water from 40% to 15%, and a small amount of NaOH was added. The adjusted pH of ˜15% was 9.50. This 15% Bioterge AS-40 was further diluted to 3%. Then, the 3% Bnt-E and 3% Bnt-E were mixed in a 50:50 wt % ratio. The total active concentration without considering NaOH addition was 3%, and pH was 9.26. The aspen strands were prepared by increasing the moisture level to 10% and treating it with PM200 pMDI. The SS plate was cleaned by the ‘regular cleaning method.’ In this test, 75% panels were built. Then, the additive was sprayed onto a cold plate, following the cold plate method. About 2.14E+00 g/m² of pre-conditioning was applied to the cold plate. Following the ‘Manuel Pressing Procedure,’ the reference test was done to obtain the MRD value.

Initially, the additive was sprayed onto a heated SS plate; however, the additive bounced off the hot plate and instantly formed white solids on top of the SS plate. Therefore, the cold plate method was used to apply an accurate amount of additive in every press.

The MRD of the additive was 1.27E−01 g/m². When the additive was sprayed on a cold SS plate and heated in the oven at 220° C., it formed an uneven consolidated bentonite layer. When pressed at 220° C., a reddish-brown layer formed on the edge of the SS plate, and some were transferred to the wood panel.

TABLE 58
Experiment 58 Release Result.

| | | % | | Wt. | application | Releasing |
|---|---|---|---|---|---|---|
| Press | | Bioterge | % Total Active | Additive | dose | force |
| # | % Bnt-E | AS-40 | Concentration | (g) | (g/m²) | (N) |
| PC | 1.50E+00 | 1.50E+00 | 3.00E+00 | 2.55 | 2.14E+00 | — |
| 1 | 1.50E+00 | 1.50E+00 | 3.00E+00 | 2.57 | 2.16E+00 | 0 |
| 2 | 7.50E−01 | 7.50E−01 | 1.50E+00 | 2.58 | 1.08E+00 | 0 |
| 3 | 3.75E−01 | 3.75E−01 | 7.50E−01 | 2.62 | 5.50E−01 | 0 |
| 4 | 1.88E−01 | 1.88E−01 | 3.75E−01 | 2.59 | 2.68E−01 | 0 |
| 5 | 9.38E−02 | 9.38E−02 | 1.88E−01 | 2.45 | 1.27E−01 | 0 |
| 6 | 4.69E−02 | 4.69E−02 | 9.38E−02 | 2.48 | 6.42E−02 | stuck |
| 7 | 2.34E−02 | 2.34E−02 | 4.69E−02 | 2.58 | 3.34E−02 | stuck |

The ratio of Bnt-E to Bioterge AS-40 is 1:1. In conclusion, the MRD of the additive was 1.27E−01 g/m². Considering the mixture ratio, the MRD of Bnt-E and Bioterge AS-40 individually is 6.35E−02 g/m².

### Experiment 59. J49 (Additive: 1.5% Bnt-E+1.5% Y2 Suspension) 2022 Feb. 7

This experiment aims to examine the release performance of Bnt-E and Y2 suspension in continuous press testing on a cold plate.

The bentonite-E was prepared by concentrating the fine fraction of bentonite suspension with the rotavapor. First, the concentrated bentonite was diluted from 4.81% to 3%. Then, Y2 was prepared by diluting it from 34.95% to 3% with RO water. The 3% Bnt-E and 3% Y2 were mixed in a 1:1 ratio. The total active concentration was 3.0%, with a pH of 8.32. The aspen strands were prepared by increasing the moisture level to 10% and treating it with PM200 pMDI. The SS plate was cleaned by the ‘regular cleaning method.’ In this test, 75% panels were built. Then, the additive was sprayed onto a cold plate, following the cold plate method. The cold plate method was done because droplet bouncing was observed on the hot metal plate with one of the additives used in Y2, Bioterge AS-40 (Exp-58). About 2.43E+02 g/m² of pre-conditioning was applied to the cold plate. Following the ‘Manuel Pressing Procedure,’ the reference test was done to obtain the MRD value.

The experiment shows that the MRD of the additive is 1.90E−00 g/m². After spraying the additive on a cold plate, a consolidated bentonite layer was formed. After pressing, the layer turned into a light brown colour near the edge of the SS plate. Clean panels were made in every press, possibly because the layer transferred to the panel is also light brown.

TABLE 59
Experiment 59 Release Result.

| | | | | Wt. | application | Releasing |
|---|---|---|---|---|---|---|
| Press | | | % Total Active | Additive | dose | force |
| # | % Bnt-E | % Y2 | Concentration | (g) | (g/m²) | (N) |
| PC | 1.50E+00 | 1.50E+00 | 3.00E+00 | 2.9 | 2.43E+00 | N/A |
| 1 | 1.50E+00 | 1.50E+00 | 3.00E+00 | 2.9 | 2.43E+00 | 0 |
| 2 | 7.50E−01 | 7.50E−01 | 1.50E+00 | 2.9 | 1.22E+00 | 0 |
| 3 | 3.75E−01 | 3.75E−01 | 7.50E−01 | 2.9 | 6.09E−01 | 0 |
| 4 | 1.88E−01 | 1.88E−01 | 3.75E−01 | 2.9 | 3.04E−01 | 0 |
| 5 | 9.38E−02 | 9.38E−02 | 1.88E−01 | 2.9 | 1.52E−01 | 0 |
| 6 | 4.69E−02 | 4.69E−02 | 9.38E−02 | 2.9 | 7.61E−02 | 0 |
| 7 | 2.34E−02 | 2.34E−02 | 4.69E−02 | 2.9 | 3.80E−02 | 0 |
| 8 | 1.17E−02 | 1.17E−02 | 2.34E−02 | 2.9 | 1.90E−02 | 0 |
| 9 | 5.86E−03 | 5.86E−03 | 1.17E−02 | 3.41 | 1.12E−02 | stuck |
| 10 | 2.93E−03 | 2.93E−03 | 5.86E−03 | 2.9 | 4.75E−03 | 0 |
| 11 | 1.46E−03 | 1.46E−03 | 2.93E−03 | 2.9 | 2.38E−03 | stuck |
| 12 | 7.32E−04 | 7.32E−04 | 1.46E−03 | 2.9 | 1.19E−03 | stuck |

The ratio of Bnt-E to Y2 is 1:1. In conclusion, the MRD of the additive was 1.90E−00 g/m². Considering the bentonite to Y2 ratio, the MRD of Bnt-E and Y2 individually is 9.50E−02 g/m².

### Experiment 60. J50 (Additive: 3.0% Bnt-E Suspension) 2022 Feb. 8

This experiment aims to examine the release performance of Bnt-E suspension in continuous press testing on a cold plate.

TABLE 60
Experiment 60 Release Result.

| Press | % Total Active | Wt. Additive | application | Releasing |
|---|---|---|---|---|
| # | Concentration | (g) | dose (g/m²) | force (N) |
| PC | 3.00E+00 | 2.91 | 2.44E+00 | — |
| 1 | 3.00E+00 | 2.92 | 2.45E+00 | 0 |
| 2 | 1.50E+00 | 2.94 | 1.23E+00 | 0 |
| 3 | 7.50E−01 | 2.86 | 6.00E−01 | 0 |
| 4 | 3.75E−01 | 2.93 | 3.07E−01 | 0 |
| 5 | 1.88E−01 | 2.89 | 1.52E−01 | 0 |
| 6 | 9.38E−02 | 2.93 | 7.69E−02 | 0 |
| 7 | 4.69E−02 | 2.91 | 3.82E−02 | 0 |
| 8 | 2.34E−02 | 2.90 | 1.90E−02 | 0 |
| 9 | 1.17E−02 | 2.92 | 9.57E−03 | 0 |
| 10 | 5.86E−03 | 2.94 | 4.82E−03 | 0 |
| 11 | 2.93E−03 | 2.97 | 2.43E−03 | 0 |
| 12 | 1.46E−03 | 2.87 | 1.18E−03 | 0 |
| 13 | 7.32E−04 | 2.89 | 5.92E−04 | 0 |
| 14 | 3.66E−04 | 2.89 | 2.96E−04 | stuck |
| 15 | 1.83E−04 | 3.00 | 1.54E−04 | stuck |

The bentonite-E was prepared by concentrating the fine fraction of bentonite suspension with the rotavapor. The concentrated bentonite was diluted from 4.81% to 3% with RO water. The pH of 3% Bnt-E was 9.08. The aspen strands were prepared by increasing the moisture level to 10% and treated with PM200 pMDI. The SS plate was cleaned by the ‘regular cleaning method.’ In this test, 75% panels were built. Then, the additive was sprayed onto a cold plate, following the cold plate method. The cold plate method was used to compare the MRD value of Exp-59 to the MRD of Bnt-E. About 2.44E+00 g/m² of pre-conditioning was applied to the cold plate. Following the ‘Manuel Pressing Procedure,’ the reference test was done to obtain the MRD value.

The experiment shows that the MRD of the Bnt-E is 5.92E−04 g/m². A consolidated bentonite layer was observed on the SS plate, and it was transferred to the wood panel in press 1-5. This layer was no longer noticeable in the press 6-15. The MRD value observed in this experiment was about ten folds lower than the MRD value of bentonite tested on a hot plate (Exp-56). This might suggest the bentonite losing its efficiency when heated, which aligns with the observation when “dried and resuspended bentonite” was tested.

In conclusion, the MRD of the Bnt-E was 5.92E−04 g/m².

### Experiment 61. J54 (Additive: 3.0% Y2 Solution) 2022 Feb. 14

This experiment aims to examine the release performance of Y2 solution in continuous press testing on a cold plate.

The Y2 was prepared by diluting from 34.95% stock solution to 3% with RO water. The pH of the additive was 8.62. The aspen strands were prepared by increasing the moisture level to 10% and treated with PM200 pMDI. The SS plate was cleaned by the ‘regular cleaning method.’ In this test, 75% panels were built. Then, the additive was sprayed onto a cold plate, following the cold plate method. About 2.48E+00 g/m² of pre-conditioning was applied to the cold plate. Following the ‘Manuel Pressing Procedure,’ the reference test was done to obtain the MRD value.

The experiment shows that the MRD of the additive is 9.54E−03 g/m². After spraying the additive on a cold SS plate and heating it, it showed white dots on the SS plate. Once pressing was done, darker brown spots were observed, and transferred to the wood panel in press 1-3. The brown spots were no longer observed after press 4. A waxy layer was formed on the wood panel, which became less evident as more presses were done.

TABLE 61
Experiment 61 Release Result.

| Press | % Total Active | Wt. Additive | application | Releasing |
|---|---|---|---|---|
| # | Concentration | (g) | dose (g/m²) | force (N) |
| PC | 3.00E+00 | 2.95 | 2.48E+00 | — |
| 1 | 3.00E+00 | 2.93 | 2.46E+00 | 0 |
| 2 | 1.50E+00 | 2.90 | 1.22E+00 | 0 |
| 3 | 7.50E−01 | 2.89 | 6.06E−01 | 0 |
| 4 | 3.75E−01 | 2.90 | 3.04E−01 | 0 |
| 5 | 1.88E−01 | 2.92 | 1.53E−01 | 0 |
| 6 | 9.38E−02 | 2.89 | 7.58E−02 | 0 |
| 7 | 4.69E−02 | 2.98 | 3.91E−02 | 0 |
| 8 | 2.34E−02 | 2.90 | 1.90E−02 | 0 |
| 9 | 1.17E−02 | 2.91 | 9.54E−03 | 0 |
| 10 | 5.86E−03 | 2.91 | 4.77E−03 | stuck |
| 11 | 2.93E−03 | 2.91 | 2.39E−03 | stuck |

In conclusion, the MRD of Y2 is 9.54E−03 g/m².

### Experiment 62. This Section was Left Empty Intentionally.

### Experiment 63. J110 (Additive: 3.0% Wt Aqueous Bnt-E 2022 Apr. 20 SUSPENSION)

This experiment aims to see the release performance of Bnt-E on the automatic press for a continuous process.

The 3.0% wt BNT-E suspension was prepared by concentrating the fine fraction of the bentonite suspension with the rotavapor. The concentrated bentonite was diluted from 4.81% wt to 3.00% wt. The pH of the 3%.00 wt Bnt-E was 9.08. The aspen strands were prepared by increasing the moisture level to 10% wt and treating with HM Rubinate 1840 Standard Cure pMDI. The 6 mm thick SS plate was cleaned by the “regular cleaning method.” In this test, 75% wt panels were built. Then, the additive was sprayed onto the 220° C. temperature plate. About 2.43E+00 g/m² of preconditioning dose (PCD) was applied. Then the plate was placed on top of the platen, inserted into the press, and the pressing cycle began. This reference test explored the MRD value by the automatic press.

A consolidated bentonite layer was observed on the SS plate, which was transferred to the wood panel from press #1 to press #6. No panel sticking to the plate was observed in this experiment.

TABLE 63
Experiment 63 Release Result.

| | % Total Active | | | |
|---|---|---|---|---|
| Press | Concentration | Wt. Additive | application | Releasing |
| # | (% wt) | (g) | dose (g/m²) | force (N) |
| PC | 3.00E+00 | 2.9 | 2.43E+00 | — |
| 1 | 3.00E+00 | 2.9 | 2.43E+00 | 0 |
| 2 | 1.50E+00 | 2.9 | 1.22E+00 | 0 |
| 3 | 7.50E−01 | 2.9 | 6.09E−01 | 0 |
| 4 | 3.75E−01 | 2.9 | 3.04E−01 | 0 |
| 5 | 1.88E−01 | 2.9 | 1.52E−01 | 0 |
| 6 | 9.38E−02 | 2.9 | 7.61E−02 | 0 |
| 7 | 4.69E−02 | 2.9 | 3.80E−02 | 0 |

In conclusion, the MRD of the Bnt-E is lower than 3.80E−02 g/m² at 2.43 g/m² PCD under 10% strands moisture, no additional water spraying, and no additional heat treatment conditions.

### Experiment 64. J131 (Additive: 3.0% Wt Aqueous Bnt-E 2022 Jun. 2 Suspension)

This experiment mimics the continuous process and aims to see the impact of drying the applied Bnt-E layer on the 6 mm thick SS plate by reheating the plate in a 220° C. oven for 3 minutes after additive spraying.

The 3.0% wt BNT-E suspension was prepared by concentrating the fine fraction of bentonite suspension with the rotavapor. The concentrated bentonite was diluted from 3.94% wt to 3.0% wt. The pH of the 3.0% wt Bnt-E was 8.53. The aspen strands were prepared by first increasing their moisture level to 10% wt and then treating them with HM Rubinate 1840 Standard Cure pMDI. Next, the SS plate was cleaned by the “regular cleaning method.” In this test, 75% wt panels were built. Then, the additive was sprayed onto the 220° C. temperature plate. Then the plate was placed in the 220° C. temperature-controlled oven for 3 minutes. This step will be referred to as the “3 minutes of heat treatment”. About 4.20E+00 g/m² of preconditioning was applied to the 220° C. temperature plate. The 3 minutes of heat treatment was applied after the preconditioning too. At the start of the press test, the plate was placed on top of the platen, and the pressing cycle began. This reference test further explored the MRD value by the automatic press.

We could not observe any release, probably because the heat treatment led to further moisture loss of the Bnt-E layer. The dried layer might have higher adhesion/cohesion features. A dried bentonite layer formed on the SS plate and several burnt piks were found on the plate.

TABLE 64
Experiment 64 Release Result.

| | Total Active | | | |
|---|---|---|---|---|
| Press | Concentration | Wt. Additive | application | Releasing |
| # | (% wt) | (g) | dose (g/m²) | force (N) |
| PC | 3.00E+00 | 5 | 4.20E+00 | — |
| 1 | 3.00E+00 | 5 | 4.20E+00 | stuck |
| 2 | 1.50E+00 | 5 | 2.10E+00 | stuck |

In conclusion, the MRD of the Bnt-E is higher than 4.20E+00 g/m² at 4.20 g/m² PCD under 10% strand moisture, no additional water spraying, and 3 minutes of additional heat treatment conditions.

### Experiment 65. J150 (Additive: 3.0% Wt Aqueous Bnt-E 2022 Jun. 15 Suspension)

This experiment explores the MRD of Bnt-E on the 6 mm thick SS plate for the continuous process when performed without additional heat treatment of the sprayed layer.

The 3.0% wt Bnt-E suspension was prepared by concentrating the fine fraction of bentonite suspension with the rotavapor. The concentrated bentonite was diluted from 4.81% wt to 3% wt. The pH of the 3% wt Bnt-E was 9.08. The aspen strands were prepared by increasing the moisture level to 10% wt and treated with HM Rubinate 1840 Standard Cure pMDI. The SS plate was cleaned by the “polishing method.” In this test, 75% wt panels were built. About 7.05E+00 g/m² of preconditioning was applied to the 220° C. temperature plate. Then, the additive was sprayed onto the 220° C. temperature plate. Then the plate was placed onto the top of the platen, and the pressing cycle began with the automatic press to obtain the MRD value.

The experiment shows that the MRD of the Bnt-E suspension without the 3 minutes of heat treatment is 6.89E−03 g/m². We observed a consolidated bentonite layer on the SS plate, which was transferred to the wood panel from press 1 to press 10. On the 5^{th} press, the panel didn't show release; however, it could be easily removed with a small force. Compared to the bentonite sample that underwent 3 minutes of heat treatment, the sample performed significantly better, suggesting the importance of some residual moisture in the sprayed layer. This observation also highlights the importance of the moisture level of the strands. However, the preconditioning dose and application doses are higher than in Experiment 64; hence the results were not a fair comparison.

TABLE 65
Experiment 65 Release Result.

| | Total Active | | | |
|---|---|---|---|---|
| Press | Concentration | Wt. Additive | application | Releasing |
| # | (% wt) | (g) | dose (g/m²) | force (N) |
| PC | 3.00E+00 | 8.4 | 7.05E+00 | — |
| 1 | 3.00E+00 | 8.4 | 7.05E+00 | 0 |
| 2 | 1.50E+00 | 8.4 | 3.53E+00 | 0 |
| 3 | 7.50E−01 | 8.4 | 1.76E+00 | 0 |
| 4 | 3.75E−01 | 8.4 | 8.81E−01 | 0 |
| 5 | 1.88E−01 | 8.4 | 4.41E−01 | stuck |
| 6 | 9.38E−02 | 8.4 | 2.20E−01 | 0 |
| 7 | 4.69E−02 | 8.4 | 1.10E−01 | 0 |
| 8 | 2.34E−02 | 8.4 | 5.51E−02 | 0 |
| 9 | 1.17E−02 | 8.4 | 2.75E−02 | 0 |
| 10 | 5.86E−03 | 8.4 | 1.38E−02 | 0 |
| 11 | 2.93E−03 | 8.4 | 6.89E−03 | 0 |
| 12 | 1.46E−03 | 8.4 | 3.44E−03 | stuck |
| 13 | 7.32E−04 | 8.4 | 1.72E−03 | stuck |

In conclusion, the MRD of the Bnt-E is 6.89E−03 g/m² at 7.05 g/m^{z} PCD under 10% strands moisture, with no additional water spraying and no additional heat treatment conditions.

### Experiment 66. J152 (Additive: 3.0% Wt Aqueous Bnt-E 2022 Jun. 15 Suspension)

The objective of this experiment is to see how plate reheating after additive spraying can affect the release performance of bentonite when the moisture content of the strands is elevated. We performed this experiment with 3 minutes of reheating and 16% wt strand moisture level.

The 3.0% wt Bnt-E suspension was prepared by concentrating the fine fraction of bentonite suspension with the rotavapor. The concentrated bentonite was diluted from 4.81% wt to 3.0% wt. The pH of the 3.0% wt Bnt-E was 9.08. The aspen strands were prepared by increasing the moisture level to 15.7% wt and treated with HM Rubinate 1840 Standard Cure pMDI. We cleaned the 6 mm thick SS plate with the “polishing method.” In this test, 75% wt panels were built. The additive was sprayed onto the 220° C. temperature plate, and then the plate was placed in the 220° C. temperature-controlled oven for 3 minutes. About 7.05E+00 g/m² of preconditioning was applied to the 220° C. temperature plate, and the heat treatment was applied too. In the next step, the plate was placed on top of the platen, and the press cycle began with the automatic press.

The experiment shows that the MRD is lower than 1.72E−03 g/m² under 3 minutes of heat treatment and 15.7% wt strand moisture level. This observation suggests that the elevated fibre moisture enhances the release performance of bentonite, and it mitigates the effect of the 3 minutes of heat treatment. We noticed that there was an increased steam generation in every press. The consolidated bentonite layer was formed on the 6 mm thick SS plate and was transferred to the wood panels made in press 1 to 3.

TABLE 66
Experiment 66 Release Result.

| | Total Active | | | |
|---|---|---|---|---|
| Press | Concentration | Wt. Additive | application | Releasing |
| # | (% wt) | (g) | dose (g/m²) | force (N) |
| PC | 3.00E+00 | 8.4 | 7.05E+00 | — |
| 1 | 3.00E+00 | 8.4 | 7.05E+00 | 0 |
| 2 | 1.50E+00 | 8.4 | 3.53E+00 | 0 |
| 3 | 7.50E−01 | 8.4 | 1.76E+00 | 0 |
| 4 | 3.75E−01 | 8.4 | 8.81E−01 | Stuck |
| 5 | 1.88E−01 | 8.4 | 4.41E−01 | 0 |
| 6 | 9.38E−02 | 8.4 | 2.20E−01 | 0 |
| 7 | 4.69E−02 | 8.4 | 1.10E−01 | 0 |
| 8 | 2.34E−02 | 8.4 | 5.51E−02 | 0 |
| 9 | 1.17E−02 | 8.4 | 2.75E−02 | 0 |
| 10 | 5.86E−03 | 8.4 | 1.38E−02 | 0 |
| 11 | 2.93E−03 | 8.4 | 6.89E−03 | 0 |
| 12 | 1.46E−03 | 8.4 | 3.44E−03 | 0 |
| 13 | 7.32E−04 | 8.4 | 1.72E−03 | 0 |

In conclusion, the MRD of the Bnt-E is lower than 1.72E−03 g/m² at 7.05 g/m² PCD under 15.7% wt strands moisture, with no additional water spraying and no additional heat treatment conditions.

### Experiment 67. J154 (Additive: 3.0% Wt Aqueous Bnt-E 2022 Jun. 17 Suspension)

This experiment further explores the impact of the fibre's moisture on the release performance of bentonite. This experiment was done with 3 minutes of heat treatment and at 3% wt strands moisture level.

The 3.0% wt Bnt-E suspension was prepared by concentrating the fine fraction of bentonite suspension with the rotavapor. The concentrated bentonite was diluted from 4.81% wt to 3% wt. The pH of the 3% wt Bnt-E was 9.08. The aspen strands were prepared by reducing the moisture level to 3.3% wt via overnight drying in the oven and were treated with HM Rubinate 1840 Standard Cure pMDI. The 6 mm thick SS plate was cleaned by the “polishing method.” In this test, 75% wt panels were built. Then, the additive was sprayed onto the 220° C. temperature plate. Then the plate was placed in the 220° C. temperature-controlled oven for 3 minutes. Then the plate was placed onto the top of the platen, and the press cycle began. About 7.05E+00 g/m² of preconditioning was applied to the 220° C. temperature plate. The automatic press was used to obtain the MRD value.

The experiment shows that the MRD is higher than 7.05E+00 g/m² when the moisture level of strands was 3.3% wt and when a 3 minutes heat treatment was applied, which confirms that the low moisture content hinders the bentonite's release property irrespective of whether the moisture source is the fibre or the bentonite layer itself.

TABLE 67
Experiment 67 release result.

| | Total Active | | | |
|---|---|---|---|---|
| Press | Concentration | Wt. Additive | application | Releasing |
| # | (% wt) | (g) | dose (g/m²) | force (N) |
| PC | 3.00E+00 | 8.4 | 7.05E+00 | — |
| 1 | 3.00E+00 | 8.4 | 7.05E+00 | stuck |
| 2 | 1.50E+00 | 8.4 | 3.53E+00 | stuck |

In conclusion, the MRD of the Bnt-E is greater than 7.05E+00 g/m² at 7.05 g/m² PCD under 3.3% wt strands moisture, with no additional water spraying and 3 minutes of additional heat treatment conditions.

### Experiment 68. J156 (Additive: 3.0% Wt Aqueous Bnt-E 2022 Jun. 17 Suspension)

This experiment further scrutinizes the moisture's impact on bentonite's release performance.

The 3.0% wt Bnt-E suspension was prepared by concentrating the fine fraction of bentonite suspension with the rotavapor. The concentrated bentonite was diluted from 4.81% wt to 3.0% wt. The pH of the 3.0% wt Bnt-E was 9.08. The aspen strands were prepared by reducing the moisture level to 3.3% wt via overnight drying in the oven and were treated with HM Rubinate 1840 Standard Cure pMDI. The 6 mm thick SS plate was cleaned by the “polishing method.” In this test, 75% wt panels were built, and a hand sprayer sprayed 2.2 g of RO water on top of the panel to scrutinize the moisture level effect observed in Exp 66 and Exp 67. Then, the additive was sprayed onto the 220° C. temperature plate. Then the plate was placed in the 220° C. temperature-controlled oven for 3 minutes. About 7.05E+00 g/m² of preconditioning was applied to the 220° C. temperature plate. Finally, the plate was placed onto the top of the platen, and the press cycle began with the automatic press.

In this experiment, the MRD of the bentonite was 8.81E−01 g/m². We ran this experiment under the same condition as Exp 67, but we applied 2 g of RO water onto the strands. The RO water spray improves the release performance of bentonite, further confirming the impact of moisture on the releasing property of bentonite.

TABLE 68
Experiment 68 Release Result.

| | Total Active | Wt. | | | |
|---|---|---|---|---|---|
| Press | Concentration | Additive | Wt. RO | application | Releasing |
| # | (% wt) | (g) | water (g) | dose (g/m²) | force (N) |
| PC | 3.00E+00 | 8.4 | — | 7.05E+00 | — |
| 1 | 3.00E+00 | 8.4 | 2.20 | 7.05E+00 | 0 |
| 2 | 1.50E+00 | 8.4 | 2.21 | 3.53E+00 | 0 |
| 3 | 7.50E−01 | 8.4 | 2.19 | 1.76E+00 | 0 |
| 4 | 3.75E−01 | 8.4 | 2.21 | 8.81E−01 | 0 |
| 5 | 1.88E−01 | 8.4 | 2.09 | 4.41E−01 | stuck |

In conclusion, the MRD of the Bnt-E is 8.81 E−01 g/m² at 7.05 g/m² PCD under 3.3% wt strands moisture, with 2.2 g additional water spraying and 3 minutes additional heat treatment conditions.

### 2022 Jun. 28

### Experiment 69. J175 (Additive: 3.0% Aqueous Bnt-F Suspension)

In this experiment, we tested the release property of Bnt-F for the continuous process.

The 3.83% Bnt-F suspension was prepared by mixing the 600 ml sample with a Polytron PT 3100 turbine at 18,000 rpm for 3 minutes. The temperature of the mixing of suspension was initially ambient, but it increased by 10-15° C. during mixing. This suspension was then further diluted to make 3% with RO water. The pH of the stock suspension was 9.03. The aspen strands were prepared by increasing their moisture to 10% wt and were treated with HM Rubinate 1840 Standard Cure pMDI. The SS plate was cleaned by the “regular cleaning method”. In this test, 75% panels were built. About 2.52E+00 g/m² of preconditioning was applied to the 220° C. temperature plate. The additive was sprayed onto the 220° C. temperature plate. Then the plate was placed onto the top of the platen, and the press cycle began with the automatic press to obtain the MRD value.

In this experiment, the MRD of the bentonite was 2.52E+00 g/m². There was a consolidated bentonite layer formed on the SS plate. There were also several brown streaks on the plate, which aligned with darker strands on top of the panel. In this experiment, neither the 3 minutes of heat treatment nor the 2 g water spraying was applied.

TABLE 69
Experiment 69 Release Result.

| | Total Active | | | |
|---|---|---|---|---|
| Press | Concentration | Wt. Additive | application | Releasing |
| # | (%) | (g) | dose (g/m²) | force (N) |
| PC | 3.00E+00 | 3 | 2.52E+00 | — |
| 1 | 3.00E+00 | 3 | 2.52E+00 | 0 |
| 2 | 1.50E+00 | 3 | 1.26E+00 | stuck |
| 3 | 7.50E−01 | 3 | 6.30E−01 | stuck |

In conclusion, the MRD of the Bnt-F is 2.52E+00 g/m² at 2.52 g/m² PCD under 10% wt strand moisture, with no additional water spraying and no additional heat treatment conditions.

### 2022 Jun. 28

### Experiment 70. J174 (Additive: 3.0% Aqueous Bnt-F Suspension)

This experiment aims to see the release property of BNT-F for the continuous process with water spraying.

The 3.83% Bnt-F suspension tested in this experiment was the same as used in Exp 69. The aspen strands were prepared by increasing the moisture to 10% and were treated with HM Rubinate 1840 Standard Cure pMDI. The SS plate was cleaned by the “regular cleaning method”. In this test, 75% panels were built, and 2 g of RO water was sprayed on the panel. The additive was sprayed onto the 220° C. temperature plate. About 2.52E+00 g/m² of preconditioning was also applied to the 220° C. temperature plate. Then the plate was placed onto the top of the platen, and the press cycle began with the automatic press.

In this experiment, the MRD of the bentonite was 1.97E−02 g/m². Compared to Exp 69, the MRD found in this experiment is much lower, probably because of the water sprayed onto the panel, which aligns with the outcomes of Exp 66-68. There was a consolidated bentonite layer formed on the SS plate. There were also several brown streaks on the plate aligned with darker strands placed on top of the panel. On press 6, a sticking was observed, but it occurred because no water was sprayed on the panel at this step.

TABLE 70
Experiment 70 Release Result.

| | Total Active | Wt. | Wt. RO | application | Releasing |
|---|---|---|---|---|---|
| Press | Concentration | Additive | water | dose | force |
| # | (%) | (g) | (g) | (g/m²) | (N) |
| PC | 3.00E+00 | 3 | — | 2.52E+00 | — |
| 1 | 3.00E+00 | 3 | 2.20 | 2.52E+00 | 0 |
| 2 | 1.50E+00 | 3 | 2.07 | 1.26E+00 | 0 |
| 3 | 7.50E−01 | 3 | 2.21 | 6.30E−01 | 0 |
| 4 | 3.75E−01 | 3 | 1.99 | 3.15E−01 | 0 |
| 5 | 1.88E−01 | 3 | 2.12 | 1.57E−01 | 0 |
| 6 | 9.38E−02 | 3 | 0.00 | 7.87E−02 | stuck |
| 7 | 4.69E−02 | 3 | 2.26 | 3.93E−02 | 0 |
| 8 | 2.34E−02 | 3 | 2.20 | 1.97E−02 | 0 |
| 9 | 1.17E−02 | 3 | 2.06 | 9.84E−03 | stuck |
| 10 | 5.86E−03 | 3 | 2.03 | 4.92E−03 | stuck |

In conclusion, the MRD of the Bnt-F is 1.97E−02 g/m² at 2.52E+00 g/m² PCD under 10% wt strand moisture, with 2 g additional water spraying and no additional heat treatment conditions. This MRD is more than a hundred folds lower than the one observed in Exp 69.

Experiment 71. J178 (Additive: 2.8% Aqueous Bnt-F Suspension+2022 Jun. 28 0.03% Na₂CO₃)

The objective of this experiment is to see the release property of Bnt-F with some added Na₂CO₃ for continuous process.

The sample was prepared by mixing Bnt-F with Na₂CO₃ in 100:1 ratio of Bnt-solid/sodium-carbonate-solid. The suspension was prepared by mixing the 600 ml sample with a Polytron PT 3100 turbine at 18,000 rpm for 3 minutes. The pH of the stock suspension was 9.39. The stock suspension was then diluted with RO water to 2.76% Bnt-F. The aspen strands were prepared by increasing the moisture to 10% and were treated with HM Rubinate 1840 Standard Cure pMDI. The SS plate was cleaned by the “regular cleaning method”. In this test, 75% panels were built. About 2.34E+00 g/m² of preconditioning was applied to the 220° C. temperature plate. The additive was sprayed onto the 220° C. temperature plate. Then the plate was placed on top of the platen, and the press cycle began with the automatic press to obtain the MRD value.

In this experiment, the MRD of the bentonite was 7.31E−02 g/m². This figure is about thirty folds lower than the value obtained in Exp 69, in which only Bnt-F was applied, suggesting that the release performance improved with the addition of Na₂CO₃. It should be noted that the PCD was lower in this experiment than in Exp 69, which indicates the 30 folds improvement is an underestimation because, at a lower PCD, the MRD tends to be higher. Also, we did not spay any additional water on the mat either in this experiment or in Exp 69.

The first press showed a sticking, and the reason is unknown.

TABLE 71
Experiment 71 Release Result.

| | | | Total Active | Wt. | applica- | Re- |
|---|---|---|---|---|---|---|
| | | | Concen- | Addi- | tion | leasing |
| Press | % | % | tration | tive | dose | force |
| # | Bnt-F | Na₂CO₃ | (%) | (g) | (g/m²) | (N) |
| PC | 2.97E+00 | 2.97E−02 | 3.00E+00 | 3 | 2.52E+00 | — |
| 1 | 2.97E+00 | 2.97E−02 | 3.00E+00 | 3 | 2.52E+00 | stuck |
| 2 | 1.49E+00 | 1.49E−02 | 1.50E+00 | 3 | 1.26E+00 | 0 |
| 3 | 7.43E−01 | 7.43E−03 | 7.50E−01 | 3 | 6.29E−01 | 0 |
| 4 | 3.71E−01 | 3.71E−03 | 3.75E−01 | 3 | 3.15E−01 | 0 |
| 5 | 1.86E−01 | 1.86E−03 | 1.87E−01 | 3 | 1.57E−01 | 0 |
| 6 | 9.28E−02 | 9.28E−04 | 9.37E−02 | 3 | 7.87E−02 | 0 |
| 7 | 4.64E−02 | 4.64E−04 | 4.69E−02 | 3 | 3.93E−02 | stuck |
| 8 | 2.32E−02 | 2.32E−04 | 2.34E−02 | 3 | 1.97E−02 | 0 |
| 9 | 1.16E−02 | 1.16E−04 | 1.17E−02 | 3 | 9.84E−03 | stuck |
| 10 | 5.80E−03 | 5.80E−05 | 5.86E−03 | 3 | 4.92E−03 | stuck |

In conclusion, when the Bnt-solid/sodium-carbonate-solid ratio is 100:1, the MRD of the Bnt-F and sodium-carbonate mixture is 7.87E−02 g/m² at 2.52E+00 g/m² PCD under 10% wt strand moisture, with no additional water spraying and no additional heat treatment conditions. This MDF figure is about thirty folds lower than the value obtained in Exp 69, in which the sodium-carbonate was absent.

Experiment 72. J181 (Additive: 3.0% Aq. Bnt-F Suspension+0.03% 2022-07-05 Na₂HPO₄)

The objective of this experiment is to see the release property of BNT-F with Na₂HPO₄ for the continuous process.

The weight ratio of Bnt-F to anhydrous Na₂HPO₄ was 100:1. The suspension was prepared by mixing the 600 ml sample with a Polytron PT 3100 turbine at 18,000 rpm for 3 minutes. The concentration of BNT-F in the stock solution was 3.84%. The pH of the stock suspension was 8.84. The stock suspension was then diluted with RO water to 2.97% BNT-F. The aspen strands were prepared by increasing the moisture to 10% and were treated with HM Rubinate 1840 Standard Cure pMDI. The SS plate was cleaned by the “regular cleaning method”. In this test, 75% panels were built. About 2.52E+00 g/m² of preconditioning was applied to the 220° C. temperature plate. The additive was sprayed onto the 220° C. temperature plate. Then the plate was placed onto the top of the platen, and the press cycle began with the automatic press to obtain the MRD value.

In this experiment, the MRD of the bentonite was 9.84E−03 g/m². This MRD is much lower than we measured in Exp 69. In this latter, only BNT-F was applied to the plate. It should be noted that both the PCD was lower than in Exp 69. This result suggests that the release performance has improved with the addition of Na₂HPO₄ in the absence of water spraying.

TABLE 72
Experiment 72 Release Result.

| | | | Total Active | Wt. | application | Releasing |
|---|---|---|---|---|---|---|
| Press | | | Concentration | Additive | dose | force |
| # | % Bnt-F | % Na₂HPO₄ | (%) | (g) | (g/m²) | (N) |
| PC | 2.97E+00 | 2.97E−02 | 3.00E+00 | 3 | 2.52E+00 | N/A |
| 1 | 2.97E+00 | 2.97E−02 | 3.00E+00 | 3 | 2.52E+00 | 0 |
| 2 | 1.49E+00 | 1.49E−02 | 1.50E+00 | 3 | 1.26E+00 | 0 |
| 3 | 7.43E−01 | 7.43E−03 | 7.50E−01 | 3 | 6.29E−01 | 0 |
| 4 | 3.71E−01 | 3.71E−03 | 3.75E−01 | 3 | 3.15E−01 | stuck |
| 5 | 1.86E−01 | 1.86E−03 | 1.87E−01 | 3 | 1.57E−01 | 0 |
| 6 | 9.28E−02 | 9.28E−04 | 9.37E−02 | 3 | 7.87E−02 | 0 |
| 7 | 4.64E−02 | 4.64E−04 | 4.69E−02 | 3 | 3.93E−02 | 0 |
| 8 | 2.32E−02 | 2.32E−04 | 2.34E−02 | 3 | 1.97E−02 | 0 |
| 9 | 1.16E−02 | 1.16E−04 | 1.17E−02 | 3 | 9.84E−03 | 0 |
| 10 | 5.80E−03 | 5.80E−05 | 5.86E−03 | 3 | 4.92E−03 | stuck |
| 11 | 2.90E−03 | 2.90E−05 | 2.93E−03 | 3 | 2.46E−03 | stuck |

In conclusion, when the Bnt-solid/Na₂HPO₄-solid ratio is 100:1, the MRD of the Bnt-F/Na₂HPO₄ mixture is 9.84E−03 g/m² at 2.52E+00 g/m² PCD under 10% wt strand moisture, with no additional water spraying and no additional heat treatment conditions. This MDF figure is about thirty folds lower than the value obtained for BNT-F in Exp 69, in which the disodium-hydrogen-phosphate was absent.

Experiment 73. (Additive: Aqueous Sodium Hydroxide Solution 41 mM/L 2021 Sep. 16))

We verified experimentally that sodium hydroxide (NaOH) solution could be utilized as a releasing agent in the continuous process. The release depends on the solution's pH; at a high enough pH, i.e., pH=12.44 or pH=11.58, a release could be observed, as seen in the table below.

| | Conc. | | | |
|---|---|---|---|---|
| | NaOH | Amount | m.Wood | |
| pH | (M/Liter) | applied | (g) | Observation |
| 12.44 | 0.041 | 3 g | 110.52 | Easy release. The plate is clean, |
| | | | | and the wood has a waxy layer |
| | | | | formed on its surface |
| 11.58 | 10.016 | 3 g | 110.12 | Easy release. The plate is clean, |
| | | | | and the wood has a waxy layer |
| | | | | on its surface. |
| 11 | 0.0029 | 3 g | 110.73 | Hard stuck. We had to hammer |
| | | | | the panel out of the plate. |
| | | | | Several picks on the SS plate |
| | | | | were observed. |
| 10 | 0.00033 | 3 g | 110.90 | Extremely stuck. We had to |
| | | | | hammer the panel out of the |
| | | | | plate. Several large picks on the |
| | | | | SS plate were observed. |

Unfortunately, we cannot use such high pH solutions in industrial panel production because their spray causes mucus irritation in the throat and would not be allowed by the WHMIS.

Hence, we invented the following approach. We spray sodium or potassium bicarbonate solution, i.e., NaHCO₃, and KHCO₃, respectively, as releasing agents on the SS metal belt instead of NaOH solution. The additives' solutions' pHs are close to neutral; therefore, they do not irritate. For instance, a 2 M/Liter KHCO₃ solutions pH is 7.84 at 25° C. temperature, while a 0.9 M/Liter NaHCO₃ solutions pH is 7.66 at 25° C. temperature. Under the high-temperature condition of the press, these bicarbonates thermally decompose and turn to the corresponding carbonates while releasing carbon dioxide. The pHs of these alkali carbonates are within the above-discussed releasing pH range. It is because they form a highly concentrated or saturated solution under the press conditions after they were deposited on the hot SS belt by spraying (during the continuous process) or being contacted with the hot mild steel plate when sprayed on the wood surface (during the multi-opening process). For instance, a 2 M/Liter KHCO₃ solution's pH is 11.75 at 25° C. temperature, while a 2 M/Liter Na2CO₃ solution's pH is 11.43 at 25° C. temperature. Consequently, they support the panel release.

What is more, the released carbon dioxide has two additional benefits:
(i) It increases the fluid pressure in the press, leading to a decreased wood-fibre/metal contact pressure at a fixed total pressure of the press, which lowers the chance of fibre sticking to the metal.
(ii) The released carbon dioxide suppresses both the pMDI/water and the pMDI/iron-oxide reactions because both of these said reactions also release carbon dioxide. Hence, in the vicinity of the metal/wood interface, where the sodium or potassium carbonates are produced while releasing carbon dioxide, the pMDI has reduced chemical activity, lowering the chance of fibre sticking to the metal.

We tested the application of concentrated NaHCO3 solution with bentonite suspension and observed releases in a wide concentration range.

We expect the bicarbonates to maintain their beneficial effects on release when applied in other releasing formulations too. For instance, they are expected to be beneficial in the presence of surfactants, especially in alkali salts of aliphatic carboxylates, including ethoxylated carboxylates and alkali salts of aliphatic organophosphates including ethoxylated organophosphates.

Therefore, we claim the application of sodium, potassium, lithium, or ammonium bicarbonates solutions as releasing agents. These releasing agent solutions can also be used in formulations. These said formulations could contain either (i) the mixtures of the said bicarbonates, (ii) phyllosilicates, (iii) surfactants, (iv) alkali salts of aliphatic carboxylates including ethoxylated carboxylates, (v) alkali salts of aliphatic organophosphates including ethoxylated organophosphates, or some combination of cases i, ii, iii, iv, and v. The said formulations can also contain bentonites, montmorillonites, or phyllosilicates.

Experiment 74. (Aq. Bnt-F Suspension Loaded with Different 2022 Jul. 5 Amount of Na₂HPO₄)

This experiment aims to identify the optimum bentonite-to-Na₂HPO₄ ratio for the release. First, we prepared three different stock solutions from the original bentonite stock by adding an increasing amount of Na₂HPO₄. Then, the releasing experiments were performed to determine the MRD for the original stock solution and the solutions dosed with Na₂HPO₄. We used RO water for diluting. Hence, the bentonite-to-

Na₂HPO₄ ratios were kept constant during each MRD series of MRD testing. The outcomes are represented in FIG. 12, in which one could realize the beneficial effect of a low amount of Na₂HPO₄ on the release. Hence, we concluded that the 1/100 weight ratio of Na₂HPO₄-to-bentonite is close to the optimum release performance. Therefore, one should prepare bentonite releasing suspension at this ratio. In FIG. 12, we also report the moisture content of the wood because it influences the release performance when it changes significantly. Because no correlation could be recognized between the slightly different moistures and the MRDs, we conclude that the observed MRD minimum is caused by the varying Na₂HPO₄-to-bentonite radio.

### Appendix B. Observations on Corrosion Properties

### Objective

Document corrosion test results when bentonite-containing formulations are tested as mold-releasing agents in the wood panel manufacturing process.

### Methods

Utilize the following procedures disclosed in the Methods section of this report: Bentonite cleaning procedure, Bentonite concentration measurement procedure, Wood strands preparation procedure, and Building wood panels—full mat.

The order of procedure to run one test follows the order of the list below:
1. Bentonite cleaning procedure
2. Bentonite concentration measurement procedure
3. Wood strands preparation procedure
4. Corrosion coupons preparation procedure
5. Building wood panels—full mat
6. Corrosion manual pressing procedure
7. Coupon cleaning procedure
8. Calculation of corrosion rate procedure
9. Blank measurement

### Corrosion Coupons Preparation Procedure

The polished 1018 carbon steel coupon (part 31-31044) was used for the multi-opening corrosion test. To prepare the coupons, the weights of two coupons were measured to the accuracy of 0.0001 g. The weight measurement was repeated three times, and the average of three measurements was recorded.

### Corrosion Manual Pressing Procedure

Using moisture controlled (10%), waxed (0.8%), and pMDI (3%) treated strands, a full mat was made following the “building wood panels procedure.” First, the top SS plate was placed on the platen, set at a temperature of 220° C. Then, approximately 13 g of the additive was sprayed on the top of the full mat using plastic spray bottles. Next, two coupons were placed on top of the wet surface on the full mat, and an additional 7 g was sprayed only on the coupons. Then, the pre-heated SS plate was placed center-wise on top of the additive-treated full-mat. Next, this sandwich-like setup was moved into the heated press. The press was then cranked to the pound-force of 12500 lbs which was calculated to be approximately 500 psi**.

The press cycle time is constant regardless of what pMDI is used in the corrosion test. Once it reached 12500 lbs, a three-minute timer began. The pressure was held for 70 seconds. When the timer went off, the timer started counting upward while beeping. When the timer was 24 seconds over, the pressure was slowly released to zero by 31 seconds. Once the timer was 38 seconds over, the timer was turned off, and the press was fully opened to remove the sandwich-like setup.

The top plate was then removed using a spatula, and it was placed on the heated press. Using the spatula, the coupons were popped out. If any wood was stuck to the coupons, they were carefully scraped off using the spatula without scratching the metal coupons.

Approximately 13 g of additive was re-sprayed on the same wood panel that already had been pressed. Then the same coupons were flipped and placed into their original space on the wet full-mat. About 7 g of additive was re-sprayed on the coupons. Then, the pre-heated SS plate was placed center-wise on top of the additive-treated full-mat. This sandwich-like setup was moved into the heated press. The press was cranked to the pound-force of 12500 lbs, and the press cycle mentioned above was repeated. This re-spray step was repeated five times.

The whole pressing procedure was repeated four more times. Therefore, a total of five wood panels were made, and each panel was pressed six times (i.e., a total of 30 presses in one corrosion experiment).

Note: The pound-force, 12500 lbs, was converted to psi by dividing by the area of compression, which is 5 in×5 in =25 in². Therefore, the pressure is 12500 lbs/25 in²=500 psi. This pressure is similar to the pressure applied in the wood manufacturing mill, which is 493.13 lbs. Hence, it was determined that the pound-force of 12500 lbs used in the press procedure is a good pressure that reflects the real application in the mill.

### Coupon Cleaning Procedure

First, the 30% Y3 solution was pre-heated in a 70° C. water bath. After 10 minutes, the Y3 solution was placed into the Aquasonic bath (model 75T of VWR Scientific Products, its power rate is 3 Amps) filled with hot water. The coupons that had been pressed 30 times then they were submerged in Y3 for 12 minutes. The coupons were removed every 2 minutes and wiped. The timer was paused whenever the coupons were taken out of the Y3 solution. When the coupons were placed back in the Y3 solution, the timer was resumed. After 12 minutes, the coupons were rinsed with hot tap water. Then, 33% Y4 solution was placed in the sonic bath. The coupons were submerged in the Y4 solution for 2 minutes. After 2 minutes, they were removed and rinsed in hot tap water. Then the coupons were neutralized by submerging them into a Y6 solution for 1 minute. The coupons were rinsed in hot tap water again and were dried immediately with paper towels. Then they were placed in an acetone bath for 1 minute and immediately dried.

### Calculation of Corrosion Rate Procedure

After cleaning the coupons, they were re-weighted using an analytical balance with a precision of 0.0001 g. They were weighted three times, and the average was calculated. The corrosion formula is

$$MPY = K \times \frac{W - B}{A \times T \times D}$$

Where,
K=MPY constant=3.45E+06
W=Mass loss of test coupons in g
B=Mass loss of blank coupon in g
A=Areas of coupons in cm2=22.17738 cm²
T=Time of exposure in hours=1.75 hours
D=density of coupons in g/cm3=7.86 g/cm³

The formula can be simplifed to MPY=11310 g⁻¹×(W-B). Then the corrosion MPY (mils per year) value is reported. (ASTM, 2003; “Standard practice for preparing, cleaning, and evaluating corrosion test specimens.” Annual book of ASTM standards, Vol. 03.02, ASTM, West Conshohocken, Pa., Standard G1-03, 17-25.)

### Blank Measurement

The blank is measured by determining the loss of the coupon mass that occurred during the cleaning of the coupons. The weight of the new coupon is measured using the analytical balance to the accuracy of 0.0001 g. At the end of the corrosion pressing, the “cleaning procedure” mentioned above is followed with two test coupons and a blank coupon. Once the cleaning procedure is complete, the weight of the blank coupon is measured using the same analytical balance.

### Results

### Experiment Corr-01. J56 (Additive: 3% Y2) 2022 Feb. 15

The objective of this experiment is to measure the corrosion of Y2 using mild steel coupons.

The 3% Y2 additive was made by taking a dilution from a 35% active stock solution with RO water. The pH of the additive was 8.50. The testing sequence followed the order disclosed in Methods. The coupons' codes were F474 and F475, and the average spray mass was found to be 19.2 g per press.

The calculated MPY value of the additive was 556.43 MPY. The MPY value was unexpectedly high; hence the corrosion of the water was also done (Exp 02). Water is known to be corrosive toward mild steel metal. Therefore, applying a high amount of additives having high water content might have resulted in a higher than expected corrosion rate.

### Experiment Corr-02. J57 (Additive: RO Water) 2022 Feb. 16

The objective of this experiment is to measure the corrosion of RO water alone on mild steel coupons.

The testing sequence followed the order disclosed in Methods. The codes of the coupons used were F469 and F470, and the average spray weight was 20.2 g per press. The calculated MPY value of the additive was 331.86 MPY.

### Experiment Corr-03. J58 (Additive: 3% Bnt-E) 2022 Feb. 17

The objective of this experiment is to measure the corrosion of Bnt-E alone on mild steel coupons.

The 3% Bentonite sample was prepared by concentrating it with the rotavapor, and the concentration was measured. Then, they were diluted to 3% using RO water. The pH of the additive was 8.84. The testing sequence followed the order disclosed in Methods. The codes of the coupons used were F467 and F471, and the average spray weight was 20.8 g per press.

The calculated MPY value of the additive was 237.39 MPY.

Experiment Corr-04. J59 (Additive: 3% Bnt-E Diluted with 10 mM 2022 Feb. 22 SHMP)

This experiment aims to measure the corrosion of a bentonite sample in a 10 mM SHMP solution on mild steel coupons.

The bentonite sample was prepared by concentrating it with rotavapor, and the concentration was measured. Then the sample was further diluted to 3% using 10 mM SHMP solution. Based on the calculation, the SHMP powder added is 0.13%. Therefore, the additive was an aqueous mixture containing 3% Bnt-E and 0.13% SHMP. The pH of the additive was 7.86. The testing sequence followed the order disclosed in Methods. The coupons' codes were F472 and F473, and the average spray weight was 20.1 g per press.

The calculated MPY value of the 142 additive was 306.22 MPY.

Experiment Corr-05. J61 (Additive: 2.8% Bnt-E+0.2% Na₂HPO₄) 2022 Feb. 24

The objective of this experiment is to measure the corrosion of bentonite with Na₂HPO₄ on mild steel coupons.

The bentonite sample was prepared by concentrating it with rotavapor, and the concentration of bentonite was measured. Then, 1.5 g Na₂HPO₄ the powder was added to the 3.83% Bnt-E, and it was further diluted to achieve 3% overall. The weight composition of the additive was 2.8% Bnt-E and 0.2% Na₂HPO₄. The pH of the additive was 8.11. The testing sequence followed the order disclosed in Methods. The codes of the coupons used were F466 and F468, and the average spray weight was 20.1 g per press. The calculated MPY value of the additive was 231.36 MPY.

Experiment Corr-06. J62 (Additive: 2.8% Bnt-E+0.2% 2022 Feb. 23 Na₃PO₄(H₂O)₁₂)

The objective of this experiment is to measure the corrosion of bentonite with Na₃PO₄(H₂O)₁₂ on mild steel coupons.

The bentonite sample was prepared by concentrating it with rotavapor, and the concentration of bentonite was measured. Then, 1.5 g Na₃PO₄(H₂O)₁₂ the powder was added to the 3.83% Bnt-E, and it was further diluted to achieve 3% overall. The weight composition of the additive was 2.8% Bnt-E and 0.2% Na₃PO₄(H₂O)₁₂. The pH of the additive was 10.01. The testing sequence followed the order disclosed in Methods. The codes of the coupons used were F464 and F465, and the average spray weight was 20.1 g per press.

The calculated MPY value of the additive was 298.49 MPY.

TABLE 1
Result Overview

| | | Average | |
|---|---|---|---|
| | | amount | Corrosion |
| Experi- | | sprayed per | Rate |
| ment | Additive | press | [MPY] |
| 1 | 3% Y2 | 19.2 | 556.43 |
| 2 | RO water | 20.2 | 331.86 |
| 3 | 3% Bnt -E | 20.8 | 237.39 |
| 4 | 3% Bnt - E dilution done with | 20.1 | 306.22 |
| | 10 mM SHMP | | |
| 5 | 2.8% Bnt - E and 0.2% Na₂HPO₄ | 20.1 | 231.36 |
| 6 | 2.8% Bnt-E and 0.2% | 20.1 | 298.49 |
| | Na₃PO₄(H₂O)₁₂ | | |

### Appendix C. Qualitative Observations on Viscosity Properties

### Objective

We must remove the contaminants and coarse fractions from the bentonite suspensions by sedimentation to be able to utilize them as releasing agents. To develop a reliable manufacturing process for high concertation bentonite suspensions, we need some viscosity reducing additives because the extremely high viscosity of concentrated bentonite suspensions limits the sedimentation rates. Hence we tested several additives as viscosity reducing and separation enhancing agents. The qualitative viscosity assessment was done by observing the impact of various additives on bentonite suspension viscosity and the mica-contaminant separation in bentonite suspension stored in 500 mL Erlenmeyer flasks.

### Sample Preparation

### 1. Bentonite Preparation

All bentonite samples used in this quantitative viscosity assessment were prepared from the initially received bentonite feedstock without any pre-treatment step. The pre-measured amount of Bnt-D powder was slowly added to a calculated amount of RO water stirred intensively with an overhead mechanical stirrer. Once all the powder was added, the stirrer speed was increased, and the stirring was continued for another 30-60 minutes.

### 2. Solid Additive Preparation

The additive stock solution was prepared by adding additives in powder form into the RO water and stirring for 10 minutes with an overhead mechanical stirrer. The stock solution was then mixed with bentonite suspension to achieve the highest concentration suspension using the mechanical stirrer for 30 minutes. Then the stock solution of the additive was further diluted with RO water and mixed with bentonite suspensions. The additives in the solid form include SHMP, Na₂CO₃, and NaH₂PO₄

### 3. Liquid Additive Preparation

The additives were prepared by diluting with RO water to desired concentrations. The concentration of the active in stock solution was considered when making dilutions. The additives in the liquid form include PS-5, B-HCS and AEPE. The initial concentration of the PS-5 sample was 20.3%. The initial active concentration of the B-HCS sample was 50.0%, and the initial active concentration of AEPE was 100%. The diluted sample was then mixed with bentonite suspension to achieve the desired concentration by using the mechanical stirrer for 30 minutes.

In the case of AEPE, first NaOH was added to AEPE to increase its pH to 8.5-9.5. Then, the pH-adjusted AEPE was diluted with RO water. It should be noted that the total concentration of AEPE-containing additive does not include NaOH added during pH adjustment.

### Results

### Baseline: Bnt-D at Different Concentrations

| [Bnt-D] | pH |
|---|---|
| 7% | 9.0 |
| 9% | 9.0 |
| 12% | 8.8 |

The sedimentation of heavier (mica) particles was not observed for all three bnt-D samples. There were differences in viscosity qualitatively. The 12% suspension was the thickest sample, showing hindered flow, whereas the 7% suspension was the thinnest sample out of all three suspensions. During the observation/comparison period, no separated water layer was observed on the top of the untreated bentonite (blank) suspensions.

### 1. 7% Bnt-D+SHMP

| Sample | | | Clean water separated | Bnt to SHMP |
|---|---|---|---|---|
| code | [Additive] | pH | on the top (cm) | ratio |
| J11-1 | 4.0% | 7.2 | 2.0 | 1.75 |
| J11-2 | 2.0% | 7.9 | 0.6 | 3.50 |
| J11-3 | 1.0% | 8.1 | 5.5 | 7.00 |
| J11-4 | 0.2% | 7.8 | 0.4 | 35.0 |

The effective sedimentation of heavier (mica) particles was observed within 24 hours. About a week later, a clean water layer was observed on top of all suspensions supporting the effectiveness of SHMP as a sedimenting agent. Additionally, the suspension was less viscous than the 7% Bnt reference, but it was tested again at a higher Bnt to SHMP ratio to obtain more obvious qualitative results (see 6).

2. 7% Bnt-D+Na₂CO₃

| Sample | | | Clean water separated | Bnt to Na₂CO₃ |
|---|---|---|---|---|
| code | [Additive] | pH | on the top (cm) | ratio |
| J12-1 | 4.0% | 10.7 | 4.7 | 1.75 |
| J12-2 | 2.0% | 10.7 | 2.6 | 3.50 |
| J12-3 | 1.0% | 10.6 | 1.7 | 7.00 |
| J12-4 | 0.2% | 9.9 | 0.3 | 35.0 |

The effective sedimentation of heavier particles was observed within 24 hours. In 24 hours, a clean water layer was also observed on top of all suspensions supporting the effectiveness of Na₂CO₃ as a sedimenting agent. The water separation was the most evident in the highest concentration of Na₂CO₃ containing suspension. It suggests that the concentration of Na₂CO₃ could affect the sedimentation efficiency. When the viscosity of each sample was compared before the water separation, the J12-1 was the least viscous sample, whereas J12-4 was the most viscous sample. J12-4 showed similar viscosity to the 7% reference bentonite. After the water separation, the bentonite layer became more viscous due to the water reduced water content in the suspension. The viscosity assessment was redone at a higher Bnt to Na₂CO₃ ratio (see 8).

### 3. 7% Bnt-D+PS-5

| Sample | | | Clean water separated | Bnt to PS-5 |
|---|---|---|---|---|
| code | [Additive] | pH | on the top (cm) | ratio |
| J13-1 | 4.0% | 8.9 | 1.6 | 1.75 |
| J13-2 | 2.0% | 9.0 | 0.5 | 3.50 |
| J13-3 | 1.0% | 9.0 | 0.4 | 7.00 |
| J13-4 | 0.2% | 9.1 | 0.2 | 35.0 |

The separation of the heavier particles was less evident compared to Bnt+SHMP and Bnt+Na₂CO₃ suspensions. The water layer separation occurred after 4 days, and the water separated on the top showed the smallest readings compared to Bnt+SHMP and Bnt+Na₂CO₃ suspensions. The highest concentration of PS-5 showed the most separation of the water layer on top of the suspension, suggesting that the concentration could affect the sedimentation efficiency. The viscosity difference among the samples at different concentrations of PS-5 was not evident. Also, the viscosity change was not apparent between all PS-5 containing suspensions and the 7% reference Bnt. Therefore, PS-5 is not a suitable viscosity reducing agent or sedimenting agent. The viscosity assessment was redone at a higher Bnt to Na₂CO₃ ratio (see 7).

### 4. 9% Bnt-D+AEPE

| Sample | | | Clean water separated | Bnt to AEPE |
|---|---|---|---|---|
| code | [Additive] | pH | on the top (cm) | ratio |
| J21-1 | 2.0% | 9.6 | — | 4.50 |
| J21-2 | 1.0% | 9.5 | — | 9.00 |
| J21-3 | 0.5% | 9.2 | — | 18.0 |
| J21-4 | 0.1% | 9.2 | — | 90.0 |

There was effective sedimentation observed in J21-1; however, the sedimentation was not evident in J21-3 and J21-4. There was no water separation on the top of the suspensions in all AEPE containing suspensions. When the viscosity differences among the samples were compared, the J21-1 was less viscous than 9% reference bentonite, while J21-4 showed about the same viscosity as the reference sample. Overall, AEPE is neither an excellent sedimenting agent nor a good viscosity agent.

### 5. 9% Bnt-D+B-HCS Surfactant

| Sample | | | Clean water separated | Bnt to B-HCS |
|---|---|---|---|---|
| code | [Additive] | pH | on the top (cm) | ratio |
| J22-1 | 2.0% | 9.0 | — | 4.50 |
| J22-2 | 1.0% | 8.9 | — | 9.00 |
| J22-3 | 0.5% | 9.0 | — | 18.0 |
| J22-4 | 0.1% | 8.9 | — | 90.0 |

Almost no sedimentation occurred in the samples, and no water was separated from the suspension. Comparing the viscosity of the samples to the 9% reference sample, all of the suspensions of Bnt-D with B-HCS were more viscous than the 9% reference samples. J22-1 was clumping, while J22-4 didn't show any clumping. This suggests that a higher concentration of B-HCS surfactant might affect the suspension negatively (i.e., thicker sample).

### 6. 12% Bnt-D+SHMP

| Sample | | | Clean water separated | Bnt to SHMP |
|---|---|---|---|---|
| code | [Additive] | pH | on the top (cm) | ratio |
| J16-1 | 2.0% | 8.0 | 0.4 | 6.00 |
| J16-2 | 1.0% | 7.5 | 0.2 | 12.0 |
| J16-3 | 0.5% | 7.4 | — | 24.0 |
| J16-4 | 0.1% | 8.1 | — | 120 |

The sedimentation of mica or heavier particles was evident in all samples. Compared to 7% Bnt-D+SHMP (see 2), the water separation was observed only on J16-1 and J16-2. This is due to a higher Bnt-D amount with less SHMP, increasing the bnt to SHMP ratio. There was a significant change in viscosity compared to the 12% reference sample. All four samples were less viscous than 12% bentonite. Hence, SHMP is a good viscosity-reducing agent and sedimenting agent. Comparing these four samples, 12% Bnt with 0.5% SHMP (Bnt to SHMP ratio=24) could be a good choice as there were effective sedimentation, no water separation on the top of the suspension, and low viscosity.

### 7. 12% Bnt-D+PS-5

| Sample | | | Clean water separated | Bnt to PS-5 |
|---|---|---|---|---|
| code | [Additive] | pH | on the top (cm) | ratio |
| J17-1 | 2.0% | 8.8 | 0.1 | 6.00 |
| J17-2 | 1.0% | 8.8 | — | 12.0 |
| J17-3 | 0.5% | 8.8 | — | 24.0 |
| J17-4 | 0.1% | 8.8 | — | 120 |

The sedimentation of heavier particles was ineffective as no darker mica particles were observed at the bottom of the flask. The water layer also was not separated from the top of the suspensions. The viscosity reduction was not evident compared to the 12% reference samples. The J17-1 was clumping, indicating that high concentrations of PS-5 could increase the viscosity. Suspension clumping was not observed in the 03 experiment, possibly due to the low bnt to PS-5 ratio.

8. 12% Bnt-D+Na₂CO₃

| Sample | | | Clean water separated | Bnt to Na₂CO₃ |
|---|---|---|---|---|
| code | [Additive] | pH | on the top (cm) | ratio |
| J18-1 | 2.0% | 10.6 | 0.6 | 6.00 |
| J18-2 | 1.0% | 10.5 | 0.2 | 12.0 |
| J18-3 | 0.5% | 10.3 | — | 24.0 |
| J18-4 | 0.1% | 9.2 | — | 120 |

The separation was observed, but it was not effective compared to SHMP. Some white precipitation was observed at the bottom of the Erlenmeyer flask. The precipitation was not formed in 7% Bnt with Na₂CO₃ suspensions (See 02). Water separation occurred within 24 hours and was observed on two samples, J18-1 and J18-2. Also, the samples were more viscous than the 12% reference sample, which contradicts the result in experiment 02. J18-1 was flowing a bit but a big clump formed as well.

### 9. 12% Bnt-D+1% SHMP+1% Na₂C03

| | | | | Bnt to SHMP or |
|---|---|---|---|---|
| Sample | | | Clean water separated | Bnt to Na₂CO₃ |
| code | Additive] | pH | on the top (cm) | ratio |
| J19 | 2.0% | 10.3 | — | 12 |

There was an effective mica separating, and no water separation was observed. They were less viscous than the 12% reference sample, 1% SHMP with 12% bnt (see 6, J16-2), and 1% Na₂CO₃ with 12% bnt (see 8, J18-2). The sample was slightly more viscous than 2% SHMP with 12% bnt sample (J16-1). However, mixing 1% SHMP and 1% Na₂CO₃ and 12% Bnt leads to good sedimentation without water separation, no precipitates, and reduced viscosity.

10. 12% Bnt-D+NaH₂PO₄

| Sample | | | Clean water separated | Bnt to NaH₂PO₄ |
|---|---|---|---|---|
| code | [Additive] | pH | on the top (cm) | ratio |
| J26-1 | 2.0% | 5.6 | 0.1 | 6.00 |
| J26-2 | 1.0% | 6.0 | 0.1 | 12.0 |
| J26-3 | 0.5% | 6.4 | — | 24.0 |
| J26-4 | 0.1% | 7.4 | — | 120 |

There was less sedimentation than SHMP (see 6), but it showed better sedimentation of heavier particles compared to PS-5 (see 7) and Na₂CO₃ (see 8). All the samples were much less viscous than the 12% reference sample; however, J26-4 shows similar viscosity as the 7% bnt reference.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

The examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. An external release agent for lignocellulosic composite panels or wood panels comprising a suspension of one or more synthetic or natural clays wherein the suspension medium can be either aqueous or nonaqueous and wherein wood strands, wood chips, wood fibers, or wood powder or their mixtures are utilized as raw materials for panel production.

2. The release agent of claim 1, wherein the bonding agent of the lignocellulosic composite panels contains an isocyanate derivative or a polymeric methylene diphenol diisocyanate (pMDI) resin or their combinations.

3. The release agent of claim 1, wherein the suspension is aqueous.

4. The release agent of claim 1, wherein the natural clay is talcum.

5. The release agent of claim 1, wherein the synthetic clay is laponite containing a minimum of 80% wt alkali metal, ammonium, or hydrogen laponite or their combination and wherein the alkali metal, ammonium, or hydrogen term refers to the exchangeable cation or counter ion or interlayer cation.

6. The release agent of claim 1, wherein synthetic or natural clay is a 2:1 type of clay wherein two tetrahedral sheets sandwich one octahedral sheet to form a unit cell.

7. The release agent of claim 1, wherein the natural clay belongs to the smectite clay class.

8. The release agent of claim 7, wherein the clay dispersing agent is either alkali metal orthophosphate, alkali metal pyrophosphate, alkali metal trimetaphosphate, alkali metal triphosphate, alkali metal tetraphosphate, alkali metal hexametaphosphate, alkali metal polyphosphate, alkali metal carbonate, or a combination thereof, and wherein in these phosphates or carbonates zero, one, or more alkali metal ion is replaced by a hydrogen ion or ions.

9. The release agent of claim 8, wherein the smectite comprises 60 wt % or more of alkali metal, ammonium, or hydrogen smectite or their combination and wherein the alkali metal, ammonium, or hydrogen term refer to the exchangeable cation or counter ion or interlayer cation.

10. The release agent of claim 9, wherein the smectite comprises 80 wt % or more of alkali metal, ammonium, or hydrogen smectite or their combination and wherein the alkali metal, ammonium, or hydrogen term refer to the exchangeable cation or counter ion or interlayer cation.

11. The release agent of claim 10, wherein smectite comprises 90 wt % or more of alkali metal, ammonium, or hydrogen smectite or their combination and wherein the alkali metal, ammonium, or hydrogen term refer to the exchangeable cation or counter ion or interlayer cation

12. The release agent of claim 11, wherein the clay dispersing agent is either alkali metal orthophosphate, alkali metal pyrophosphate, alkali metal trimetaphosphate, alkali metal triphosphate, alkali metal tetraphosphate, alkali metal hexametaphosphate, alkali metal polyphosphate, alkali metal carbonate, or their combination and wherein in these phosphates or carbonates zero, one, or more alkali metal ion is replaced by a hydrogen ion or ions.

13. The release agent of claim 11, wherein the clay dispersing agent is disodium hydrogen phosphate and the clay-to-disodium-hydrogen-phosphate ratio is higher than 50:1 wt.

14. The release agent of claim 13, wherein the clay-to-disodium-hydrogen-phosphate ratio is higher clay dispersing agent is higher than 90:1 wt.

15. The release agent of claim 14, wherein the clay-to-disodium-hydrogen-phosphate ratio is higher clay dispersing agent is higher than 100:1 wt.

16. The release agent of claim 15, wherein the natural clay is montmorillonite, bentonite, saponite, attapulgite or a combination thereof.

17. The release agent of claim 16, wherein the clay dispersing agent is either alkali metal orthophosphate, alkali metal pyrophosphate, alkali metal trimetaphosphate, alkali metal triphosphate, alkali metal tetraphosphate, alkali metal hexametaphosphate, alkali metal polyphosphate, alkali metal carbonate or their combination and wherein in these phosphates or carbonates zero, one, or more alkali metal ion is replaced by a hydrogen ion or ions.

18. The release agent of claim 17, wherein the clay comprises 60% wt or more of alkali metal, ammonium, or hydrogen montmorillonite, bentonite, saponite, attapulgite or their combination, wherein the alkali metal, ammonium, or hydrogen term refer to the exchangeable cation or counter ion or interlayer cation.

19. The release agent of claim 18, wherein the clay comprises 80% wt or more of alkali metal, ammonium, or hydrogen montmorillonite, bentonite, saponite, attapulgite or their combination, wherein the alkali metal, ammonium, or hydrogen term refer to the exchangeable cation or counter ion or interlayer cation.

20. The release agent of claim 19, wherein the clay comprises 90% wt or more of alkali metal, ammonium, or hydrogen montmorillonite, bentonite, saponite, attapulgite or their combination, wherein the alkali metal, ammonium, or hydrogen term refer to the exchangeable cation or counter ion or interlayer cation.

21. The release agent of claim 20, wherein the clay dispersing agent is either alkali metal orthophosphate, alkali metal pyrophosphate, alkali metal trimetaphosphate, alkali metal triphosphate, alkali metal tetraphosphate, alkali metal hexametaphosphate, alkali metal polyphosphate, alkali metal carbonate, or their combination and wherein in these phosphates or carbonates zero, one, or more alkali metal ion is replaced by a hydrogen ion or ions.

22. The release agent of claim 21, wherein the clay dispersing agent is disodium hydrogen phosphate, and the clay-to-disodium-hydrogen-phosphate ratio is 50:1 by weight or more.

23. The release agent of claim 22, wherein the clay dispersing agent is disodium hydrogen phosphate, and the clay-to-disodium-hydrogen-phosphate ratio is 90:1 by weight or more.

24. The release agent of claim 23, wherein the clay dispersing agent is disodium hydrogen phosphate, and the clay-to-disodium-hydrogen-phosphate ratio is 100:1 by weight or more.

25. The release agent of claim 24, wherein at least 85 wt % of the natural clay particles have a hydrodynamic diameter of less than 15 micrometers.

26. The release agent of claim 25, wherein at least 95 wt % of the natural clay particles have a hydrodynamic diameter of less than 15 micrometers.

27. The release agent of claim 26, wherein at least 99 wt % of the natural clay particles have a hydrodynamic diameter of less than 15 micrometers.

28. The release agent of claim 27, wherein non-clay (gaunge) minerals are present at a weight percent of less than 6%.

29. The release agent of claim 28, wherein the non-clay (gaunge) minerals are present at a weight percent of less than 1%.

30. The release agent of claim 29, wherein the non-clay (gaunge) minerals are present at a weight percent of less than 1%.

31. The release agent of claim 30, wherein the non-clay (gaunge) minerals are present at a weight percent of less than 0.1%.

32. The release agent of claim 30, wherein the non-clay (gaunge) minerals are present at a weight percent of less than 0.05%.

33. The release agent of claim 32, wherein the non-clay (gaunge) minerals comprise one or more of calcite, feldspar, quartz, opal, and mica.

34. The release agent of claim 33, further comprising anionic and/or non-ionic surfactants.

35. The release agent of claim 34, wherein at least one of the anionic surfactants is selected from the following groups:
a) an ethoxylated or propoxylated phosphate ester or a salt thereof having a formula wherein, R, R1 and R2 are independently selected from the group consisting of H, and C6-alkyl chain having an average of 1-20 moles of ethoxylation or propoxylation with the proviso that at least one of R, R1 and R2 is H and the other one or two of R, R1 and R2 is a C6-C30 alkyl or alkenyl chain having an average of 1-20 moles of ethoxylation or propoxylation;
b) a phosphate ester or a salt thereof having a formula wherein, R3, R4 and R5 are independently selected from the group consisting of H, and C6-C20 alkyl or alkenyl chain, with the proviso that at least one of R3, R4 and R5 is H and the other one or two of R3, R4 and R5 is a C6-C20 alkyl chain;
c) a non-ethoxylated carboxylic acid or a salt thereof having a C6-C30 alky or alkenyl chain;
d) an ethoxylated or propoxylated carboxylic acid or a salt thereof having an average of 1-40 moles of ethoxylation or propoxylation and a C6-C22 alkyl chain; and
e) an organic anionic surfactant comprising sulfur.

36. The release agent of claim 35, wherein the phosphate ester of group a) is a Poly(oxy-1,2-ethanediyl).alpha.-hydro-.omega.-hydroxy-monoC6-C12-alkyl ether.

37. The release agent of claim 36, wherein the phosphate ester of group b) is a mixture of C8 and C10 alkyl phosphate esters.

38. The release agent of claim 37, wherein the anionic surfactant comprising sulfur comprises at least one sulphonate functional group or an alkaline metal salt sulphonate and at least one C6-C24 carbon chain, wherein the at least one C6-C24 carbon chain is aliphatic or aromatic, linear, branched, saturated, unsaturated, ethoxylated, propoxylated, or combinations thereof.

39. The release agent of claim 38, wherein the anionic surfactant is a petroleum sulphonate or derivative thereof, an alpha olefin sulphonate or derivative thereof, a sultaine derivative, a disulfonate, or a combination thereof.

40. The release agent of claim 39, wherein the release agent composition comprises:
one or more of the phosphate esters selected from a), and one or more of the phosphate esters selected from b);
one or more of the phosphate esters selected from b) and one or more of the ethoxylated or propoxylated carboxylic acids or salts selected from (d);
one or more of the phosphate esters selected from b) and one or more of the surfactants selected from (e);
one or more of the phosphate esters selected from b), one or more of the ethoxylated or propoxylated carboxylic acid or a salt selected from (d), and one or more of the anionic surfactants selected from (e); or
one or more of more of the phosphate esters selected from b) and one or more of the anionic surfactants selected from (e).

41. The release agent of claim 40, wherein the ratio of the phosphate ester selected from a) to the phosphate ester selected from b) is from about 1:6 to about 6:1.

42. The release agent of claim 41, wherein the ratio of the phosphate ester selected from a) to the ratio of the phosphate ester selected from b) is from about 1:4 to about 4:1.

43. The release agent of claim 42, wherein the ratio of the phosphate ester selected from a) to the phosphate ester selected from b) is from about 1:1 to about 3:1.
